(19) United States
(12) Patent Application Publication
(10) Pub. No.: US 2025/0131407 A1
(43) Pub. Date: Apr. 24, 2025

(54) SYSTEMS AND METHODS FOR FUEL DISPENSING

(71) Applicant: Mudflap, Inc., Palo Alto, CA (US)

(72) Inventors: Sharon Yapp, Campbell, CA (US); Vineet Thanedar, Oakland, CA (US)

(21) Appl. No.: 18/490,898

(22) Filed: Oct. 20, 2023

(51) Int. Cl. G06Q 20/32

(52) U.S. Cl. CPC G06Q 20/322

(57) ABSTRACT

Fuel dispensing can be performed by receiving a user input indicative of a fuel code via a graphical user interface (GUI) of a fueling system. The fuel code is provided to a fuel exchange system and relayed to a remote server using an application programming interface (API). A validation data object for validating the fuel code is received from the remote server via the API. In response to the validation data object, the fueling system automatically transition from an inactive state to an active state to dispense fuel to a user entity. Fuel event data is generated based on the dispensing of fuel and provided to the fuel exchange system. The fuel exchange system generates a fuel exchange payload based on the fuel event data and provides the fuel exchange data payload to the remote server for execution of an exchange value using the user entity's instrument of exchange.

### BACKGROUND

Obtaining fuel (e.g., vehicle fuel, such as diesel fuel for long-haul truckers) from a fueling station has historically required the fuel recipient to be present at fueling station to initiate a desired exchange of fuel. Computing systems located at the fueling station historically have not been remotely accessible to truckers, drivers, and/or other fuel recipients, and therefore those fuel recipients have been unable to provide information necessary for a fuel exchange unless and until the fuel recipient has physically reached the fueling station. Even at fueling stations where information, such as identifiers, keys, and other sensitive information necessary to conduct a fuel exchange can be provided directly to a fuel pump, the provision of that information can decrease the efficiency of a fuel stop for truckers and other fuel recipients. Therefore, a need exists for improved special purpose computing devices and/or software or firmware for increasing the efficiency of fuel stops for drivers by providing additional options for drivers and other fuel recipients to initiate a least a portion of a fuel exchange remotely. Through applied effort and ingenuity, various technical problems associated with historical fuel exchange processing have been solved through embodiments as discussed herein.

### BRIEF SUMMARY

Various embodiments are directed to a system, method, and computer program product for initiating and authorizing fuel-related exchanges. Various embodiments receive a user input indicative of a fuel code from a graphical user interface (GUI) on a fueling system, receive a validation data object reflecting validation of the fuel code the fuel code from a remote computing environment and, in response to the validation data object, transition the fueling system from an inactive state to an active state. Some embodiments receive from the fueling system fuel event data associated with the fueling system in the active state and indicative of a fuel volume. Some embodiments generate and provide to the remote computing environment a fuel exchange payload indicative of a fuel exchange amount based on the fuel volume, the identifier of the fuel entity associated with the fuel exchange system, and the fuel code. In one or more embodiments, by use of the fuel code, the present systems and methods overcome security challenges of previous approaches that expose sensitive information of a user's instrument of exchange to a fuel exchange system. Additionally, the system, method, and computer program product of the present disclosure may perform fuel exchanges in which modifications to fuel exchange values or other metrics may be associated with and redeemed respective to an identity of a user entity without exposing identifying information of the user entity to the associated fuel exchange system.

Various embodiments are directed to a system for fuel dispensing. In certain embodiments, the system comprises at least one memory and one or more processors in communication with the at least one memory, wherein the one or more processors are configured to: (A) receive user input via a graphical user interface of a fueling system configured to dispense fuel, wherein the fueling system is in communication with a fuel exchange system via a network; (B) determine the user input comprises a fuel code, wherein the fuel code is generated by a remote computing environment that (i) stores a record of the fuel code with an identifier of the fuel exchange system within a listing of records of valid fuel codes and (ii) provides the fuel code to a user computing entity for presentation via a user interface of the user computing entity; (C) in response to determining the user input comprises the fuel code: (i) tag the user input with metadata designating the fuel code; and (ii) transmit the fuel code and the metadata to a fuel exchange system using the network, wherein the fuel exchange system transmits the fuel code to the remote computing environment using an application programming interface (API) upon receipt of the fuel code from the fueling system; (D) receive, from the fuel exchange system, a validation data object, wherein: (i) the validation data object is generated by the remote computing environment at least in part based on a comparison of the fuel code to the listing of records of valid fuel codes; and (ii) the fuel exchange system receives the validation data object from the remote computing environment via the API and transmits the validation data object to the fueling system via the network; (E) in response to receiving the validation data object, automatically transition the fueling system from an inactive state to an active state to enable fuel dispensing from the fueling system; (F) dispense fuel from a handle of the fuel system in the active state; (G) generate fuel event data based at least in part on the dispensing of the fuel to identify a fuel volume; and (H) transmit the fuel event data to the fuel exchange system using the network, wherein the fuel event data causes the fuel exchange system to: (i) generate, based on the fuel event data, a fuel exchange payload comprising data identifying a fuel exchange amount, the identifier of the fuel entity associated with the fuel exchange system, and the fuel code; and (ii) transmit, using the API, the fuel exchange payload to the remote computing environment to execute a transaction for the user.

In some embodiments, the one or more processors are further configured to, in response to determining the user input comprises the fuel code, disabling information entry at the fueling system to prevent users from providing alternative payment information to the fueling system. In some embodiments, the fuel event data further comprises data identifying a fuel type. In some embodiments, the fuel code causes the remote computing environment to provide a transaction request comprising the fuel exchange payload to a third-party processing service to execute a transaction. In some embodiments, the one or more processors are further configured to provide a fuel exchange report to the user using a printing device of the fueling system. In some embodiments, the one or more processors are further configured to, in response to determining the user input comprises the fuel code, disable at least a portion of user input devices of the fueling system. In some embodiments, the validation data object identifies at least one limit on a fueling transaction and the one or more processors are further configured to transition the fueling system to the inactive state upon satisfying the at least one limit. In some embodiments, the remote computing environment transmits an input instruction to the user computing entity based on the identifier of the fuel entity, wherein the input instruction indicates to input the fuel code using the GUI on the fueling system.

Certain embodiments are directed to a method for fuel dispensing. In various embodiments, the method comprises: (A) receiving user input via a graphical user interface of a fueling system configured to dispense fuel, wherein the fueling system is in communication with a fuel exchange system via a network; (B) determining the user input comprises a fuel code, wherein the fuel code is generated by a remote computing environment that (i) stores a record of the fuel code with an identifier of the fuel exchange system within a listing of records of valid fuel codes and (ii) provides the fuel code to a user computing entity for presentation via a user interface of the user computing entity; (C) in response to determining the user input comprises the fuel code: (i) tagging the user input with metadata designating the fuel code; and (ii) transmitting the fuel code and the metadata to a fuel exchange system using the network, wherein the fuel exchange system transmits the fuel code to the remote computing environment using an application programming interface (API) upon receipt of the fuel code from the fueling system; (D) receiving, from the fuel exchange system, a validation data object, wherein: (i) the validation data object is generated by the remote computing environment at least in part based on a comparison of the fuel code to the listing of records of valid fuel codes; and (ii) the fuel exchange system receives the validation data object from the remote computing environment via the API and transmits the validation data object to the fueling system via the network; (E) in response to receiving the validation data object, automatically transitioning the fueling system from an inactive state to an active state to enable fuel dispensing from the fueling system; (F) dispensing fuel from a handle of the fuel system in the active state; (G) generating fuel event data based at least in part on the dispensing of the fuel to identify a fuel volume; and (H) transmitting the fuel event data to the fuel exchange system using the network, wherein the fuel event data causes the fuel exchange system to: (i) generate, based on the fuel event data, a fuel exchange payload comprising data identifying a fuel exchange amount, the identifier of the fuel entity associated with the fuel exchange system, and the fuel code; and (ii) transmit, using the API, the fuel exchange payload to the remote computing environment to execute a transaction for the user. In some embodiments, the method further comprises, in response to determining the user input comprises the fuel code, disabling information entry at the fueling system to prevent users from providing alternative payment information to the fueling system. In some embodiments, the fuel event data further comprises data identifying a fuel type. In some embodiments, the fuel code causes the remote computing environment to provide a transaction request comprising the fuel exchange payload to a third-party processing service to execute a transaction. In some embodiments, the method further comprises providing a fuel exchange report to the user using a printing device of the fueling system. In some embodiments, the method further comprises, in response to determining the user input comprises the fuel code, disabling at least a portion of user input devices of the fueling system. In some embodiments, the validation data object identifies at least one limit on a fueling transaction; and the method further comprises transitioning the fueling system to the inactive state upon satisfying the at least one limit. In some embodiments, the remote computing environment transmits an input instruction to the user computing entity based on the identifier of the fuel entity, wherein the input instruction indicates to input the fuel code using the GUI on the fueling system.

Certain embodiments are directed to a computer program product comprising a non-transitory computer readable medium having computer program instructions stored therein, the computer program instructions, when executed by a processor, cause the processor to: (A) receive user input via a graphical user interface of a fueling system configured to dispense fuel, wherein the fueling system is in communication with a fuel exchange system via a network; (B) determine the user input comprises a fuel code, wherein the fuel code is generated by a remote computing environment that (i) stores a record of the fuel code with an identifier of the fuel exchange system within a listing of records of valid fuel codes and (ii) provides the fuel code to a user computing entity for presentation via a user interface of the user computing entity; (C) in response to determining the user input comprises the fuel code: (i) tag the user input with metadata designating the fuel code; and (ii) transmit the fuel code and the metadata to a fuel exchange system using the network, wherein the fuel exchange system transmits the fuel code to the remote computing environment using an application programming interface (API) upon receipt of the fuel code from the fueling system; (D) receive, from the fuel exchange system, a validation data object, wherein: (i) the validation data object is generated by the remote computing environment at least in part based on a comparison of the fuel code to the listing of records of valid fuel codes; and (ii) the fuel exchange system receives the validation data object from the remote computing environment via the API and transmits the validation data object to the fueling system via the network; (E) in response to receiving the validation data object, automatically transition the fueling system from an inactive state to an active state to enable fuel dispensing from the fueling system; (F) dispense fuel from a handle of the fuel system in the active state; (G) generate fuel event data based at least in part on the dispensing of the fuel to identify a fuel volume; and (H) transmit the fuel event data to the fuel exchange system using the network, wherein the fuel event data causes the fuel exchange system to: (i) generate, based on the fuel event data, a fuel exchange payload comprising data identifying a fuel exchange amount, the identifier of the fuel entity associated with the fuel exchange system, and the fuel code; and (ii) transmit, using the API, the fuel exchange payload to the remote computing environment to execute a transaction for the user.

In some embodiments, the computer program instructions, when executed by the processor, further cause the processor to, in response to determining the user input comprises the fuel code, disabling information entry at the fueling system to prevent users from providing alternative payment information to the fueling system. In some embodiments, the fuel event data further comprises data identifying a fuel type. In some embodiments, the fuel code causes the remote computing environment to provide a transaction request comprising the fuel exchange payload to a third-party processing service to execute a transaction. In some embodiments, the computer program instructions, when executed by the processor, further cause the processor to provide a fuel exchange report to the user using a printing device of the fueling system. In some embodiments, the computer program instructions, when executed by the processor, further cause the processor to, in response to determining the user input comprises the fuel code, disable at least a portion of user input devices of the fueling system. In some embodiments, the validation data object identifies at least one limit on a fueling transaction and the computer program instructions, when executed by the processor, further cause the processor to transition the fueling system to the inactive state upon satisfying the at least one limit. In some embodiments, the remote computing environment transmits an input instruction to the user computing entity based on the identifier of the fuel entity, wherein the input instruction indicates to input the fuel code using the GUI on the fueling system.

### BRIEF DESCRIPTION OF THE SEVERAL VIEWS OF THE DRAWINGS

Reference will now be made to the accompanying drawings, which are not necessarily drawn to scale, and wherein:

FIG. 1 illustrates a network environment encompassing a plurality of computing entities and systems for initiation and authorization of fuel exchanges;

FIG. 2 schematically illustrates features of a remote server according to certain embodiments;

FIG. 3 schematically illustrates features of a fuel exchange system according to certain embodiments;

FIG. 4 provides an example data flow among a plurality of computing entities and systems for authorizing a fuel exchange according to certain embodiments;

FIG. 5 provides an example flowchart of an example process for authorizing a fuel exchange according to certain embodiments;

FIG. 6 provides an example data architecture according to certain embodiments;

FIG. 7 provides an example flowchart of an example process for validating a fuel code according to certain embodiments;

FIG. 8 provides an example graphical user interface for receiving a user input indicative of a fuel code at a fueling system according to certain embodiments;

FIG. 9 provides an example graphical user interface for providing a fuel code to a fuel exchange system according to certain embodiments;

FIG. 10 schematically illustrates features of a fueling system according to certain embodiments; and

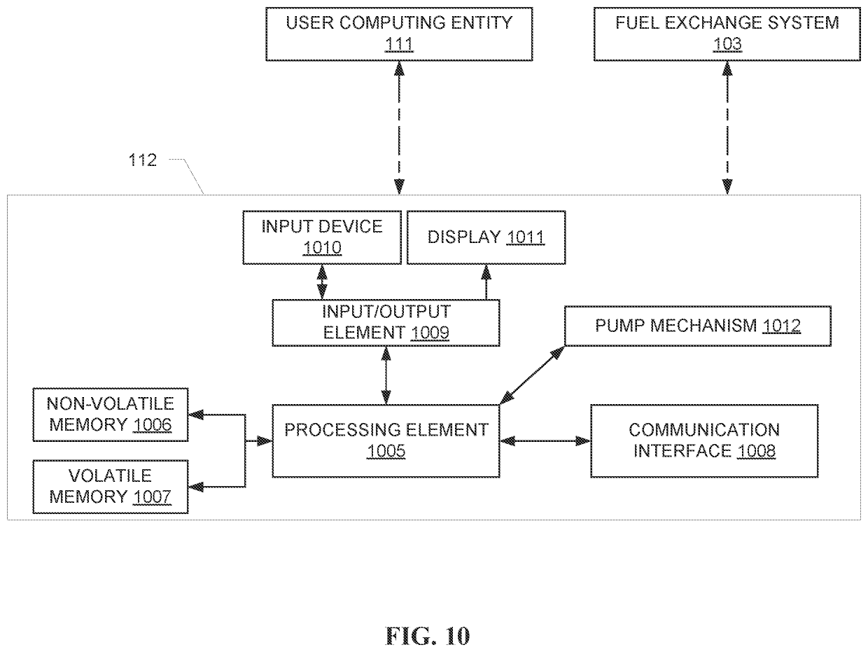

FIG. 11 provides an example illustration of a fueling system according to certain embodiments.

### DETAILED DESCRIPTION

The present disclosure more fully describes various embodiments with reference to the accompanying drawings. It should be understood that some, but not all embodiments are shown and described herein. Indeed, the embodiments may take many different forms, and accordingly this disclosure should not be construed as limited to the embodiments set forth herein. Rather, these embodiments are provided so that this disclosure will satisfy applicable legal requirements. Like numbers refer to like elements throughout.

Various embodiments are directed to systems and methods for fuel exchange and dispensing. In some embodiments, the system includes a fuel exchange system configured to transmit and receive fuel exchange data to and from a remote computing environment via one or more application programming interfaces (APIs) and at least one fueling system for dispensing fuel for a customer upon receipt of data communications indicating that a fuel exchange transaction is approved (e.g., from the fuel exchange system). In some embodiments, the remote computing environment is configured to communicate with one or more user computing entities, such as a computing device (e.g., a smartphone, laptop, or other portable computing device) of a user. In various embodiments, the remote computing environment generates and provides to the user computing entity a fuel code. For example, in response to receiving a request from a user computing entity to obtain a fuel code, the remote computing environment may generate a fuel code and provide the fuel code to the user computing entity. In some embodiments, the fuel code is a single-use redeemable, revokable token by which a fuel exchange may be initiated and processed on behalf of the user computing entity. The fueling system of certain embodiments comprises a user interface (e.g., a touch screen display) through which a user can enter a fuel code. As the fueling system receives the fuel code, the fueling system, together with the fuel exchange system in communication with the remote computing environment, determines that the fuel code is an acceptable form of payment, such that other payment information is unnecessary to complete the transaction. The fueling system (e.g., together with the fuel exchange system) determines whether the fuel code is valid, and then the fuel system begins dispensing fuel for a fueling transaction. The fuel exchange system can then receive data indicative of the fueling transaction and communicates the data to the remote computing environment to communicate with financial services entities to complete the transaction on behalf of the user/customer. In some embodiments, the fuel code is generated in association with an identifier for a fuel entity, where the fuel entity is associated with a fueling location and a fueling system at which a fuel event may occur. In some embodiments, the remote computing environment determines and associates the fuel code with the identifier for the fuel entity based at least in part on an input from a user computing entity that requests generation and receipt of the fuel code.

The remote computing environment associates the fuel code with data for a user (e.g., corresponding to the user computing entity). The data may comprise data identifying an instrument of exchange for the user (e.g., a credit card, a financial services account with a financial services entity, and/or the like). In some embodiments, the remote computing environment initiates exchanges of value for fuel exchanges by communicating with one or more financial services entities in response to receiving and validating a user input indicative of the fuel code.

The use of fuel codes with a fueling system as discussed herein enables the fueling system to receive authorization to dispense fuel for a user without requiring potentially information operative for initiating exchanges of value using a user's entity's instrument of exchange. The fuel code may be used by the fuel exchange system to obtain authorization for a fuel exchange by receiving the fuel code via a user input to a graphical user interface (GUI) of a fueling system and providing the fuel code to the remote computing environment. In some embodiments, the fuel exchange system also generates and provides metadata to the remote computing environment, such as a receipt timestamp of the user input at the GUI of the fueling system, an identifier for the fueling system, one or more product identifiers (e.g., for a fuel type, vehicle service, vehicle part, and/or the like). In some embodiments, such techniques may overcome deficiencies in previous fuel exchange processing solutions that undesirably expose sensitive information to a fuel exchange system and/or operator thereof.

As used herein, “fuel exchange” refers to an exchange of value between a fuel entity and a user entity for a fuel event. For example, a fuel exchange may include a transaction for purchase of a particular amount of fuel (e.g., diesel fuel) from a fuel entity to be provided to a fuel recipient, such as a vehicle driver, a long-haul trucker, and/or other fuel recipient, where the particular amount of fuel is associated with a fuel event comprising depositing the diesel fuel into a vehicle of a user entity. A fuel exchange may be associated with an identifier, referred to as a fuel exchange identifier, and metadata. Non-limiting examples of the metadata include timestamps, geolocation data, fuel type, fuel volume, fuel exchange ratio, identifiers for an associated fuel entity, user entity, or user computing entity, and/or the like. A value associated with a fuel exchange is referred to herein as a fuel exchange amount.

As used herein, “fuel event” refers to an instance in which an amount of fuel from a fuel entity is deposited into a vehicle or other container, of a user entity, or otherwise where an amount of fuel is sequestered from or reserved by the fuel entity on behalf of the user entity. In one example, a fuel event includes a vehicle of a user entity receiving an amount of diesel fuel from a fueling station that is associated with a fuel entity. In another example, a fuel event includes a user entity, or agent of a fuel entity, depositing an amount of fuel into a fuel container. In another example, a fuel event includes allocating an amount fuel to a user entity so as to reserve the amount fuel for use or collection by the user entity. A fuel event and/or fuel exchange may occur at a physical establishment associated with a fuel entity, such as a fuel depot, filling station, gas station, and/or the like. Additionally, or alternatively, a fuel event may occur at a first location and a fuel exchange may be initiated at a second location, which may be a physical location or a virtual location. A fuel event may be associated with one or more identifiers, referred to as fuel event identifiers, and metadata. Non-limiting examples of the metadata include timestamps, geolocation data associated with a location of the fuel event, fuel type, fuel exchange amount, fuel exchange ratio, identifiers for an associated fuel entity, user entity, or user computing entity, and/or the like.

It should be understood that fuel types are not limited to diesel fuels. As used herein, fuels involved in a fuel event may encompass the non-limiting examples of diesel, biodiesel, unleaded gasoline, leaded gasoline, off-road rated diesel, off-road rated gasoline, ethanol, kerosene, propane, liquid hydrogen, fuel oil, and/or the like. For certain fuel stations capable of metering electricity as a fuel to be provided to a vehicle (or other electricity storage device), the embodiments discussed herein can be utilized for fuel exchange transactions for providing electrical power for storage in a vehicle or other storage device.

As used herein, “fuel entity” refers to a provider of fuel. For example, a fuel entity may be an owner and/or operator of a gas station. In another example, a fuel entity may be a wholesale supplier of fuel. In still another example, a fuel entity may be a third-party fuel broker. A fuel entity may be associated with one or more fueling locations at which fuel exchanges are initiated and/or fuel is provided to a user entity. A fuel entity may be associated with one or more identifiers, referred to as entity identifiers and metadata. Non-limiting examples of the metadata include a location of the fuel entity, or fueling location associated therewith, data indicative of one or more instruments of exchange of a fuel entity (e.g., financial account numbers, routing numbers, etc.), legal name of a fuel entity, retail licensure data associated with the fuel entity, and/or the like.

As used herein, “user entity” (or “fuel recipient”) refers to any entity that enters into an exchange of value with a fuel entity to obtain fuel. In one example, a user entity may be an individual that obtains fuel for their vehicle from a filling station (e.g., the filling station being associated with a particular fuel entity). In another example, a user entity may be a business or other organization that obtains or reserves fuel from a fuel depot or fuel supply network associated with a fuel entity. In some embodiments, a user entity is associated with a user computing entity. In various embodiments, the user computing entity includes any computing device configured to communicate with the remote computing environment. For example, the user computing entity may be a computing device configured to transmit fuel code request to and receive fuel codes from the remote computing environment.

As used herein, “fuel code” refers to a redeemable, revokable token by which a fuel exchange may be initiated and processed on behalf of a user entity and a fuel exchange system of a fuel entity that receives an input indicative of the fuel code. In various embodiments, the fuel code is a numeric or alphanumeric string generated by one or more embodiments of a remote computing environment described herein. In some embodiments, the fuel code includes a numeric or alphanumeric string of a predetermined format, such as a particular length and/or character combination(s), by which a fuel exchange system may identify the string as a fuel code based at least in part on a third-party storage instruction installed at the fuel exchange system. The fuel code may be a single-use fuel code that cannot be redeemed more than once. Moreover, the fuel code may be valid for a set duration (e.g., 1 day, 3 days, 2 hours, and/or the like), as defined within data stored in the remote computing environment for the fuel code. Further, in some embodiments, the fuel code may be valid when a user computing entity is at or within a predetermined proximity of a fueling location associated with the fuel exchange system and/or fuel system 112. In various embodiments, the fuel code 106 is stored in association with a first identifier for a particular user entity (e.g., such as a user account 104 that includes processing information for an instrument of exchange of the particular user entity) and a second identifier for a particular fuel entity, where the fuel code 106 may be used to authorize and, thereby, initiate and potentially modify, a fuel exchange between the user entity and the fuel entity. The first identifier may comprise one or more identifiers for user entities, user computing entities, fuel entities, fuel exchange systems, fuel systems, fuel—or other vehicle-related products, fuel exchanges, fuel events, and/or the like. In some embodiments, the fuel exchange data includes data associated with authorizing fuel exchanges including fueling locations, fuel exchange ratios, and associations with the first identifiers and fuel codes.

In some embodiments, the system, method, and computer program product of the present disclosure utilizes a fuel code to obtain authorization for a fuel exchange between a user entity and a fuel entity without exposing sensitive information of the user entity to the fuel entity. For example, the remote computing environment may generate the fuel code in response to receiving a request from a user computing entity, where the request indicates the fuel code will be utilized for a fuel exchange at a particular fueling location and/or in association with a particular fuel entity. In some embodiments, a fuel code is associated with a stored record for an instrument of exchange associated with a user entity. For example, a fuel code may be associated with credit card processing data for a credit card account of a user entity, including card number, expiration date, card verification value, virtual card information, and/or the like. The remote computing environment may store the record for the instrument of exchange and use the stored record to initiate exchanges of value in response to receiving and validating a fuel exchange authorization data object indicative of the corresponding fuel code. The remote computing environment may provide the fuel code to the user entity's user computing entity.

In some embodiments, the remote computing environment provides an instruction to the user computing entity that indicates a manner by which the fuel code may be utilized to initiate a fuel exchange (e.g., including initiating a fuel event) at the fueling location. In some embodiments, the remote computing environment generates the instruction based on an identifier for the fuel entity, which may be included in or determined by the remote computing environment based on the request to generate the fuel code. For example, based on fuel exchange data stored in association with the fuel entity identifier, the remote computing environment may determine that a fueling system associated with the fuel entity (e.g., located at a fueling location of the fuel entity) is configured to receive user input indicative of the fuel code via a graphical user interface (GUI) provided at the fueling system. The remote computing environment may generate an instruction based on the determination such that the user entity is instructed to input the fuel code at the GUI of the fueling system. In various embodiments, by using fuel codes to facilitate remote initiation of fuel events and by enabling fuel codes to be received into a fuel exchange system via an input to a GUI of a fueling system, the present techniques overcome technical challenges for increasing efficiency of fuel exchanges. For example, where previous approaches may require a user entity park and disembark a vehicle and present a payment instrument to a fueling station's attendant to begin fueling, the present techniques may by-pass such interactions and enable the user entity to remotely initiate fueling by requesting and receiving a fuel code that is operative for initiating fueling at the fueling station, which may reduce time required to complete fueling.

### Computer Program Products, Methods, and Computing Entities

Embodiments of the present techniques for fuel exchange authorization and optimization may be implemented in various ways, including as computer program products that comprise articles of manufacture. Such computer program products may include one or more software components including, for example, software objects, methods, data structures, and/or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution). The terms software, computer program product, and similar words may be used herein interchangeably.

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile memory).

In one embodiment, a non-volatile computer-readable storage medium may include a floppy disk, flexible disk, hard disk, solid-state storage (SSS) (e.g., a solid state drive (SSD), solid state card (SSC), or solid state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-recordable (CD-R), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present techniques for fuel exchange authorization and optimization may also be implemented as methods, apparatus, systems, computing devices, computing entities, and/or the like. As such, embodiments of the present techniques for fuel exchange authorization and optimization may take the form of an apparatus, system, computing device, computing entity, and/or the like executing instructions stored on a computer-readable storage medium to perform certain steps or operations. Thus, embodiments of the present techniques for fuel exchange authorization and optimization may also take the form of an entirely hardware embodiment, an entirely computer program product embodiment, and/or an embodiment that comprises combination of computer program products and hardware performing certain steps or operations.

Embodiments of the present techniques for fuel exchange authorization and optimization are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

### Exemplary System Architecture

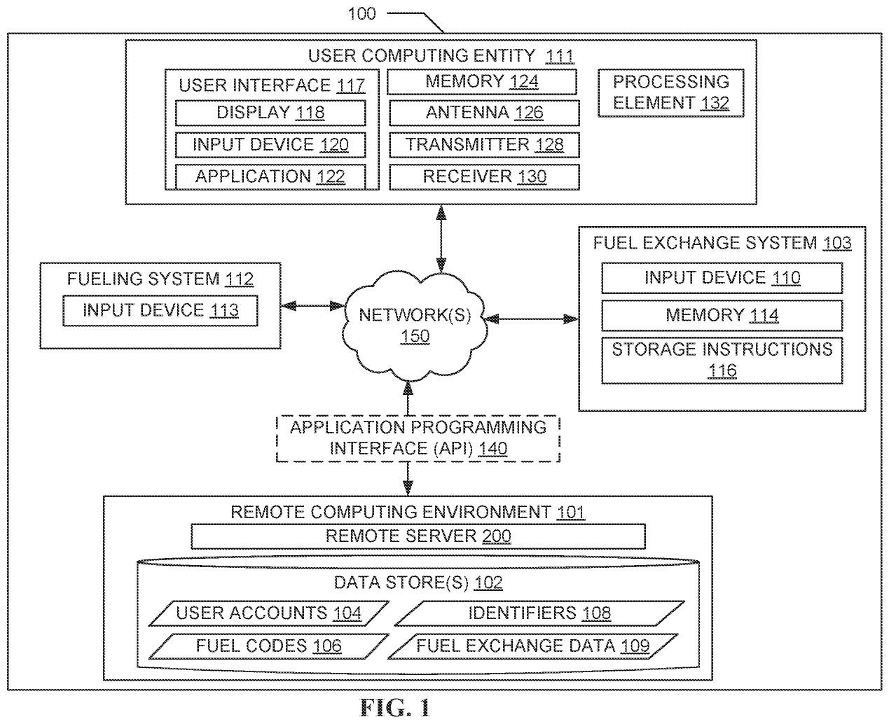

FIG. 1 provides an illustration of an exemplary computer-based network environment for fuel exchange authorization and optimization. As shown in FIG. 1, embodiments may include a network environment 100 including a remote computing environment 101, one or more fuel exchange systems 103, one or more user computing entities 111, and one or more fueling systems 112. The network environment 100 may include one or more networks 150 enabling communication among elements of the network environment 100. For example, a first network 150 may enable communication between a fuel exchange system 103 and a fueling system 112, a second network 150 may enable communication between the remote computing environment 101 and a user computing entity 111, and a third network 150 may enable communication between the remote computing environment 101 and the fuel exchange system 103. In some embodiments, the network environment 100 includes one or more application programming interfaces (APIs) 140 that enable communication, via one or more networks 150, between the remote computing environment 101 and a fuel exchange system 103, between the remote computing environment 101 and a user computing entity 111, and/or between the fuel exchange system 103 and a fueling system 112. In one example, using an API 140, a fuel exchange system 103 may provide a fuel exchange authorization data object indicative of a fuel code to the remote computing environment 101. In another example, using an API 140, the fuel exchange system 103 receives data comprising a fuel code 106 from the fueling system 112 (wherein the fuel code is provided as a numeric or alphanumeric character string together with metadata identifying the character string as a fuel code), wherein the fuel code is provided as a user input to a user interface of the fueling system 112, where the user input identifies a fuel code 106 and is received via a graphical user interface (GUI) of the fueling system 112. In another example, using the API 140, a fuel exchange system 103 may receive a validation of a fuel exchange authorization data object generated by the remote computing environment 101. In another example, using the API 140, a fuel exchange system 103 may provide a fuel exchange payload to the remote computing environment 101. In still another example, using the API 140, a fuel exchange system 103 may receive or collect fuel event data from a fueling system 112, such as a fuel volume, product identifier for a fuel type, and/or the like.

In various embodiments, the remote computing environment 101 includes one or more remote servers 200 configured to perform various functions and operations to authorize and optimize fuel exchanges. The elements of the remote computing environment 101 may be provided via a plurality of computing devices that may be arranged, for example, in one or more server banks or computer banks or other arrangements. Such computing devices can be located in a single installation or may be distributed among many different geographical locations. For example, the remote computing environment 101 can include a plurality of computing devices that together may include a hosted computing resource, a grid computing resource, and/or any other distributed computing arrangement. In some cases, the remote computing environment 101 can correspond to an elastic computing resource where the allotted capacity of processing, network, storage, or other computing-related resources may vary over time.

In various embodiments, the remote computing environment 101 includes one or more data stores 102 configured to store various data that is accessible to the remote server 200 and/or the user computing entity 111 and is used by the network environment 100 to execute various processes and functions discussed herein. The data store 102 can be representative of a plurality of data stores 102 as can be appreciated. The data store 102 can store data such as, but not limited to, user accounts 104, fuel codes 106, identifiers 108, and fuel exchange data 109. In some embodiments, user accounts 104, fuel codes 106, identifiers 108, and fuel exchange data 109 (or subsets thereof) are stored in a memory of the user computing entity 111.

In some embodiments, each user account 104 is associated with a different user entity and/or corresponding user computing entity 111. In some embodiments, the user account 104 includes user credentials for verifying an identity of a user entity or user computing entity 111. Non-limiting examples of user credentials include username, password, biometric information (e.g., facial image, fingerprint scan, voice signature, and/or the like), cryptographic keys (e.g., public-private key pairs), legal name, age, birth date, internet protocol (IP) address, media access control (MAC) address, international mobile equipment identifier (IMEI) number, and/or the like. The user account 104 may include other data associated with a user entity, such as a home address, driver's license number, commercial driver's license (CDL) number, employment status (e.g., independent contractor, self-employed, employee of a particular business, etc.), and/or contact information (e.g., phone number, email address, mailing address, social media accounts, and/or the like). In some embodiments, the user account 104 includes data associated with one or more vehicles owned or operated by a user entity, such as a vehicle registration number, license plate number, vehicle manufacturer, vehicle model, vehicle manufacture year, vehicle service record, vehicle emissions record, and/or the like. In some embodiments, the user account 104 includes data associated with historical fuel events. For example, the user account 104 may include historical fuel exchange amounts, historical fuel exchange ratios, historical fueling locations, historical fuel volumes, and/or the like. In some embodiments, a fuel exchange ratio refers to a cost per unit volume or unit mass for purchasing fuel. For example, a fuel exchange ratio may include a pre—or post-tax dollar purchasing price per gallon of fuel (e.g., or other suitable currency and/or volume unit). In some embodiments, the user account 104, or a subset thereof, is stored in an encrypted format. For example, personally identifiable information (PII) associated with a user entity, or an associated vehicle, may be encrypted such that access thereto requires a dual-authentication process, authentication of a public-private key pair, and/or other security measure.

In some embodiments, the fuel exchange system 103 includes a combination of hardware and software configured to initiate an exchange of value for fuel (e.g., diesel oil, biodiesel, unleaded gasoline, leaded gasoline, off-road rated diesel, off-road rated gasoline, fuel oil, kerosene, propane, jet fuel, boat fuel, ethanol, electricity, liquid hydrogen, and/or the like). For example, the fuel exchange system 103 may be a point-of-sale (POS) system configured to initiate fuel exchanges and exchanges of value for the fuel exchanges. Additionally, in some embodiments, the fuel exchange system is configured to initiate an exchange of value for additional fuel—or vehicle-related goods and services, such as fuel additives, motor oil, windshield washer fluid, anti-freeze solution, vehicle components, vehicle maintenance, weighing services, and/or the like.

In some embodiments, the fuel exchange system 103 includes one or more input devices 110 configured to receive user inputs. The input device 110 include a keypad (hard or soft), a touch display, voice/speech or motion interfaces, or other input device. In embodiments including a keypad, the keypad can include (or cause display of) the conventional numeric (0-9) and related keys (#, *), and other keys used for operating the fuel exchange system 103 and may include a full set of alphabetic keys or set of keys that may be activated to provide a full set of alphanumeric keys.

In some embodiments, the fuel exchange system 103 includes or is configured to communicate with and control one or more fueling systems 112. In some embodiments, the fuel exchange system 103 transitions the fueling system 112 from an inactive state in which fueling is prevented to an active state during which a fuel event may occur. In one example, the fuel exchange system 103 automatically transitions a fueling system 112 to an active state in response to receiving, from the remote computing environment 101, a validation of a fuel code (e.g., where the validation of the fuel code validates a user input for the fuel code that was provided to and received from the fueling system 112).

In some embodiments, the fueling system 112 is a system configured to control access to fuel. For example, the fueling system 112 may be a device, such as a fuel pump, that dispenses fuel to a user entity, a vehicle, and/or a fuel container. In one example, the fueling system 112 may be device that enables and disables a fuel pump handle that controls access to fuel from a fuel pump reservoir. In another example, the fueling system 112 may be a device, such as an adjustable valve, that enables and disables access to a fuel pump reservoir. In another example, the fueling system 112 may include a locking mechanism that enables and disables access to a fuel storage receptacle and/or retrieval of a fuel container. In another example, the fueling system 112 may be a system that reserves or saves an allotment of fuel for collection by a user entity, such as for a wholesale fuel exchange between a fuel supplier and fuel vendor. In some embodiments,

In some embodiments, the fueling system 112 is configurable between an inactive state and an active state. In some embodiments, when configured to the inactive state, the fueling system 112 is incapable of providing access to fuel, such as by disabling an ability of a user entity to dispense fuel. In one example, the fueling system 112 is a fuel pump and, in the inactive state, the fuel pump is rendered inoperable for dispensing fuel. In another example, the fueling system 112 is a storage receptacle comprising a locking mechanism and, in the inactive state, the locking mechanism is enabled to prevent opening of the storage receptacle and/or extraction of a fuel container from the storage receptacle. In some embodiments, when configured to the active state, the fueling system 112 allows a user entity to dispense fuel or retrieve fuel from a storage receptacle. For example, the fueling system 112 is a fuel pump and, in the active state, the fuel pump is operable for dispensing fuel. In another example, the fueling system 112 is a storage receptacle comprising a locking mechanism and, in the active state, the locking mechanism is disabled to permit opening of the storage receptacle and/or retrieval of a fuel container from the storage receptacle.

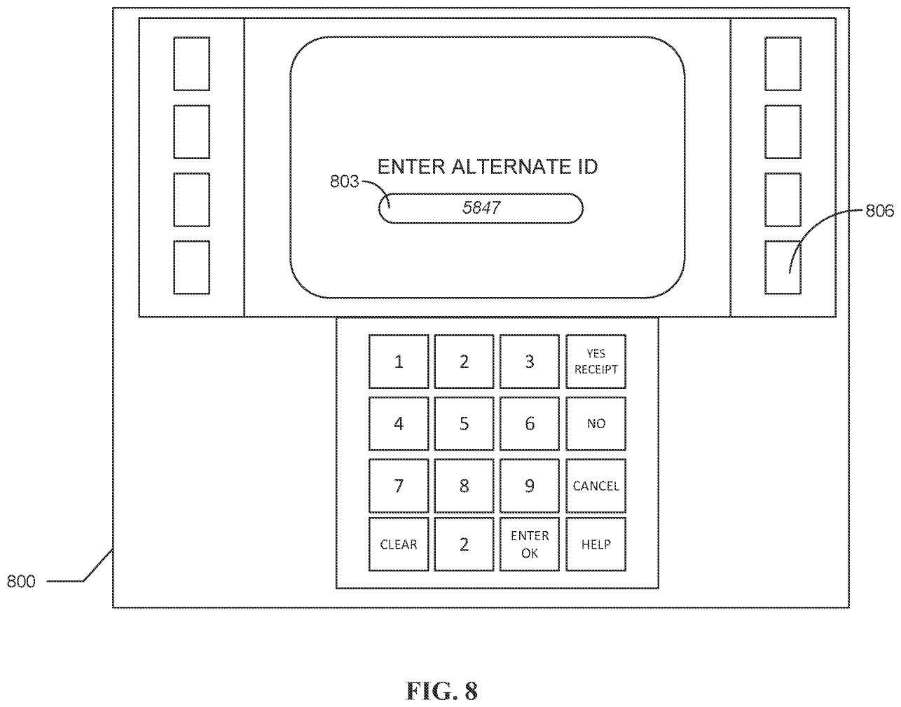

In some embodiments, the fueling system 112 includes one or more input devices 113 configured to receive user inputs. The input device 113 include a keypad (hard or soft), a touch display, voice/speech or motion interfaces, or other input device. In embodiments including a keypad, the keypad can include (or cause display of) the conventional numeric (0-9) and related keys (#, *), and other keys used for operating the fueling system 112 and may include a full set of alphabetic keys or set of keys that may be activated to provide a full set of alphanumeric keys. In some embodiments, the input device 113 includes a graphical user interface (GUI) rendered on a display of the fueling system 112 or on a computing device in configured to communicate with the fueling system 112 via wired or wireless communication, such as via a network 150. For example, the fueling system 112 includes a GUI 800 as shown in FIG. 8 and described herein. In some embodiments, the fueling system 112 receives, via the input device 113, user input indicative of a fuel code 106.

In some embodiments, the fueling system 112 includes a processor configured to process user input and determine whether the user input indicates a fuel code 106. In some embodiments, the processor is configured to generate fuel event data, such as an input receipt time stamp, fuel start timestamp, fuel end timestamp, fuel volume, and/or the like. In some embodiments, the processor is configured to receive a start code for transitioning the fueling system 112 to an activate state and an end code for transitioning the fueling system 112 to an inactive state. In some embodiments, the fueling system 112 includes memory configured to temporarily store a user input, fuel event data, and/or the like. In some embodiments, the fueling system 112 includes a network interface by which the fueling system 112 communicates with the fuel exchange system 103.

In some embodiments, the fueling system 112 stores in memory a script that, when executed by the processor, causes the fueling system 112 to generate and render a graphical user interface by which a user input indicative of a fuel code may be received. In some embodiments, when executed, the script modifies originally programmed functionality of the fueling system 112 such that a fuel code 106 may be provided to a user input field of the GUI that is traditionally configured for receiving payment instrument data or a user entity identifier (e.g., customer account number and/or the like). In some embodiments, when executed, the script causes the fueling system 112 to process user inputs such that the fueling system 112 may recognize that a format of a user input corresponds to a format for receiving and processing fuel codes. In some embodiments, the script causes the fueling system 112 to tag the user input with metadata that indicates the user input includes a fuel code. In some embodiments, the script causes the fueling system 112 to generate fuel event data, such as a fuel volume and/or metadata (e.g., input receipt timestamp, fuel start time stamp, product identifiers, etc.,) and provide the fuel event data to the fuel exchange system 103.

In various embodiments, the remote computing environment 101 provides a validation data object reflective of a validation of a fuel code 106 to the fuel exchange system 103. In some embodiments, the fuel exchange system 103 relays the validation data object to the fueling system 112, which may automatically transition from the inactive state to the active state in response to receipt of the validation data object. For example, the remote computing environment 101 may receive and validate a fuel exchange authorization data object indicative of a fuel code 106 (e.g., by comparing the indicated fuel code 106 to a stored fuel code 106). The remote computing environment 101 may provide a validation data object reflective of a validation of the indicated fuel code 106 to the fuel exchange system 103 (e.g., using an API 140). The fueling system 112 may receive the validation data object from the fuel exchange system 103 via a local network 150. In response to receiving the validation data object, the fueling system 112 may transition to an active state in which a user entity may begin dispensing fuel (e.g., via the handle, and in accordance with whether the handle is in a configuration to open a release valve).

In some embodiments, the fuel exchange system 103 stores and runs executable computer instructions (e.g., point-of sale (POS) software, fueling system control program, and/or the like). In some embodiments, by executing the computer instructions, the fuel exchange system controls activation and deactivation of a fueling system 112 by transitioning the fueling system 112 between an inactive state and an active state. In one example, the computer instructions include POS software that, when run by the fuel exchange system 103, allow the fuel exchange system 103 to activate and deactivate one or more fuel systems at a fueling location based on a fuel exchange. In some embodiments, the computer instructions, when executed, enable the fuel exchange system 103 to transition the fueling system 112 between inactive and active states based on one or more aspects of a fuel exchange. The aspects of the fuel exchange may include a validation of a fuel code, a rejection of a fuel code, a preauthorization limit (e.g., a maximum value of the fuel exchange), a maximum fuel volume, when to allow fueling with or without a maximum fuel volume or preauthorization limit, and/or the like. As described herein, such aspects of a fuel exchange may be determined by the remote computing environment 101 and provided to the fuel exchange system 103 via a network 150 and one or more APIs 140.

In some embodiments, the fuel exchange system 103 stores data related to fuel exchanges and fuel events in a format such that the data is accessible to additional elements of the network environment 100 including the remote computing environment 101, user computing entity 111, and/or fueling system 112. In some embodiments, the storing of the fuel exchange—and/or fuel-related data in such a format includes transforming the data into a data exchange format. For example, the fuel exchange system 103 may generate and store in memory 114 fuel-exchange related data in a Javascript Object Notation (JSON) file format, a comma-separated value (CSV) file format, an extensible markup language (XML) file format, and/or the like. In some embodiments the fuel exchange system 103 stores data in an original format as defined by legacy software installed on the fuel exchange system 103. In some embodiments, the fuel exchange system 103 temporarily stores data in a secondary format, where secondary format may render the data providable or accessible to the remote computing environment 101.

In some embodiments, the fuel exchange system 103 stores in memory 114 data that is part of an in-progress or completed fuel exchange in a format such that the data may be read or requested from the memory 114 by the remote computing environment 101 using one or more APIs 140. In one example, the fuel exchange-related data may include a fuel code 106, or user input indicative thereof. In another example, the fuel exchange-related data may include information associated with an instrument of exchange including a preauthorization limit for the fuel exchange, a current or total fuel exchange amount based on a volume of fuel provided to a user entity, an approved or transacted fuel exchange amount, a remainder fuel exchange amount (e.g., instances of partial approval or rejection of a fuel exchange payload by an administrator of a user's instrument of exchange), and/or the like. It should be understood that the fuel exchange system 103 need not receive complete access to data comprising payment information for the user, and the information associated with the instrument of exchange may be limited to data necessary for the fuel exchange system 103 to complete a transaction (e.g., using the previously mentioned transaction amount limits, for example). In another example, the fuel exchange-related data may include allowances or restrictions on goods or services that may be purchased in addition to the fuel being provided to the user entity, such as purchase eligible or ineligible stock keeping units (SKUs), etc.,).

In another example, the fuel exchange-related data may include goods or services registered (e.g., “rung up”) by the fuel exchange system 103 in association with an in-progress fuel exchange. In another example, the fuel exchange-related data includes a type of fuel being provided to the user entity, such as diesel oil, biodiesel, unleaded gasoline, leaded gasoline, off-road rated diesel, off-road rated gasoline, fuel oil, kerosene, propane, jet fuel, boat fuel, ethanol, electricity, liquid hydrogen, fuel octane level, and/or the like. In still another example, the fuel exchange-related data may include identifying information for a fueling system 112 (e.g., a fuel pump number and/or the like) by which fuel is provide to the user entity. In various embodiments, the fuel exchange-related data includes fuel event data, such as a current volume of fuel provided during an in-progress fuel exchange, maximum fuel volume for the fuel exchange, total fuel volume provided for a completed fuel event or fuel exchange, and/or the like. In some embodiments, the fuel exchange system 103 updates and stores the fuel exchange-related data in substantially real-time such that the fuel exchange-related data may be accessed by additional software, systems, or services in substantially real-time throughout and after the associated fuel exchange.

In some embodiments, the fuel exchange system 103 stores and runs software that enables automatic compilation and retrieval of fuel exchange-related data for in-progress and completed fuel exchanges. For example, the fuel exchange system 103 may store and run a software program that defines script and/or queries for generating data objects indicative or inclusive of fuel exchange-related data, including fuel exchange authorization data objects and fuel exchange payloads as described herein. In various embodiments, the software modifies the format of user input data stored by fuel exchange system 103 such that user input data may be recognized as a valid input of exchange instrument data (e.g., though being previously unrecognizable as valid exchange instrument data according to existing and legacy software installed on the fuel exchange system 103).

In some embodiments, the software enables the fuel exchange system 103 to determine that a user input received at a fueling system 112 (e.g., via a GUI or other input device) comprises data in a format associated with fuel codes 106. As just one example, the data received from the fueling system 112 comprises metadata identifying the fuel code as a fuel code that does not require additional payment information to complete a transaction. In such embodiments, the fueling system 112 may be configured to determine that the format of the received user input reflects a fuel code. In other embodiments, the fueling system 112 may be configured to, with the fuel exchange system 103, determine whether a received user input is a fuel code, and may then tag the fuel code with appropriate metadata before transmitting the fuel code (and metadata) to the fuel exchange system 103. In some embodiments, the software enables the fuel exchange system 103 to store an inputted fuel code 106 in a format such that the fuel code 106 may be recognized by the remote computing environment 101 in an API-facilitated communication of the user input from the fuel exchange system 103 to the remote computing environment 101. For example, the fuel exchange system 103 may receive the user input for the fuel code 106 from the fueling system 112 in a first format, such as a format native to software installed at the fueling system 112 for receiving payment instrument data or customer account identifiers. The fuel exchange system 103 may determine the user input matches a format for the fuel code 106. In response, the fuel exchange system 103 may reformat the user input into an original format for storage at the fuel exchange system 103. Additionally, or alternatively, the fuel exchange system 103 may reformat the user input into an additional format by which the user input may be provided to or retrieved by the remote computing environment 101 via an API 140. The software may cause the fuel exchange system 103 to perform reformatting by concatenating one or more characters, truncating one or more characters, replacing one or more characters of, and/or adding one or more characters to the data being reformatted (e.g., a user input, fuel code, fuel exchange authorization data object, and/or fuel exchange payload, and/or the like). In other embodiments, the API 140 may be configured such that the fuel code is provided to the remote computing environment in an appropriate format usable by the remote computing environment, without requiring pre-transmission formatting processes performed by the fuel exchange system 103.

In some embodiments, the software causes the fuel exchange system 103 to communicate with one or more external computing systems (e.g., remote computing environment 101 and/or user computing entity 111), such as via one or more APIs 140, based on the modified format of the user input. The software may cause the fuel exchange system 103 to temporarily store the user input and provide the user input and additional fuel exchange-related data to the external computing systems via one or more APIs 140. In some embodiments, such software may include or be embodied as a storage instruction 116 installed on and executed by the fuel exchange system 103.

In some embodiments, the fuel exchange system 103 is configured to perform various steps/operations of fuel exchange authorization techniques described herein. In some embodiments, the fuel exchange system 103 receives a fuel code 106 from a fueling system 112. In some embodiments, the fuel exchange system 103 temporarily stores the fuel code 106 in memory 114 according to one or more storage instructions 116. In some embodiments, the storage instruction 116, when executed by the fuel exchange system 103, causes the fuel exchange system 103 to process fuel code 106 matches a predetermined format associated with fuel codes 106. In some embodiments, the fuel exchange system 103 receives the storage instruction 116 from a third-party computing entity via a network 150 or via receipt of and communication with a memory device including the storage instruction 116. In some embodiments, the fuel exchange system 103 generates a fuel exchange authorization object indicative of the fuel code and provides the fuel exchange authorization object to the remote computing environment 101 using a network 150 and an API 140.

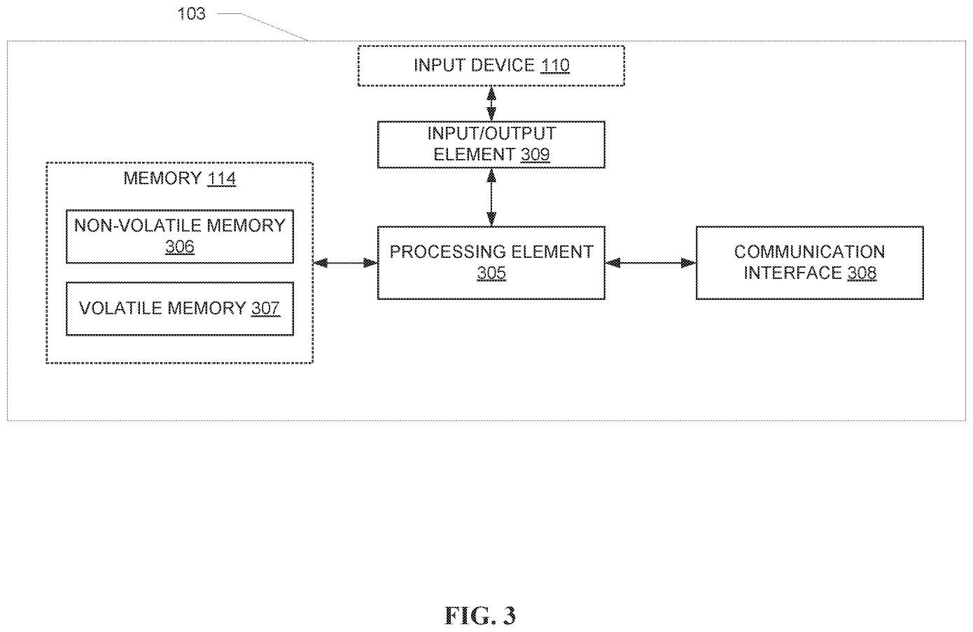

In some embodiments, the fuel exchange system 103 receives a validation data object reflecting validation of a fuel code 106 indicated by a user input and a fuel exchange authorization data object provided to the remote computing environment 101. In some embodiments, in response to receiving the validation data object reflecting validation of the fuel code, the fuel exchange system 103 activates a fueling system 112, such as by transmitting a fuel start code that transitions the fueling system 112 from an activate state to an inactive state. In some embodiments, the fuel exchange system 103 generates or receives from the fueling system 112 fuel event data, such as a fuel volume, fuel exchange amount, and/or fueling start and stop time. In some embodiments, the fuel exchange system generates a fuel exchange payload based on the fuel event data. The fuel exchange payload may indicate the fuel exchange amount and additional fuel event data or fuel exchange data as further described herein. Further description of exemplary functions and actions provided and performed by the fuel exchange system 103 are described herein with reference to FIGS. 3, 4, and 6.

In some embodiments, the fuel exchange system 103 includes memory 114 configured to store various data that is accessible to the fuel exchange system 103 to execute various processes and functions discussed herein. In some embodiments, the memory 114 includes one or more storage instructions 116. In some embodiments, the memory 114 temporarily stores a fuel code, a fuel exchange authorization data object, fuel exchange payload, and/or a fuel exchange outcome, such as when the data is modified from an original format according to one or more scripts. In some embodiments, the memory 114 stores, for a lengthier period or until manual or other software-defined deletion, a fuel code, a fuel exchange authorization data object, fuel exchange payload, and/or a fuel exchange outcome in an original format.

In some embodiments, the fuel exchange system 103 includes one or more storage instructions 116 that define one or more scripts executable by the fuel exchange system 103, or a storage computing system in communication therewith, to recognize metadata as indicating that a user input includes a fuel code. In some embodiments, the remote computing environment 101 includes storage instructions 116 that define other scripts for recognizing and reformatting fuel codes, fuel exchange authorization data objects, fuel exchange payloads, and/or fuel exchange outcomes (e.g., received from or provided to the remote computing environment 101 or fueling system 112). In some embodiments, a script defined by a storage instruction 116 reformats fuel codes, fuel exchange authorization data objects, and/or fuel exchange payloads by concatenating one or more characters, truncating one or more characters, replacing one or more characters of, and/or adding one or more characters to, the fuel code, fuel exchange authorization data object, and/or fuel exchange payload.

Each of these components, entities, devices, systems, and similar words used herein interchangeably may be in direct or indirect communication with, for example, one another over the same or different wired or wireless networks. Additionally, while FIG. 1 illustrates the various system entities as separate, standalone entities, the various embodiments are not limited to this particular architecture.

### Exemplary User Computing Entity

A user entity may interact with a user computing entity 111 via a user interface thereon, and/or the user entity may interact with a user computing entity 111 to obtain information/data regarding a user account 104, one or more fuel codes 106, one or more identifiers 108, fuel exchange data 109, and/or an instrument of exchange associated with a user entity. As will be recognized, an instrument of exchange associated with a user entity, user account 104, and/or user computing entity 111 may be any of a number of different instrument types, including a credit instrument, debit instrument, cryptographic asset wallet, bank-administrated financial account, non-bank-administered financial account, and/or the like.

A credit instrument may include a credit card associated with a credit account administered by a financial institution or other credit-providing entity that can provide payments on behalf of a user entity, and to which the user entity is obligated to reimburse for such payments. A debit instrument may include a debit card associated with a user entity's checking account, savings account, or other deposit account and by which payments may be made on behalf of the user entity via transfer of assets out of the corresponding deposit account using the debit instrument to verify the transfer. A bank-administered financial account may include a bank-administered checking account, savings account, money market account (MMA), certificate of deposit account (CD), and/or the like, that holds financial assets of a user entity and by which payments may be made on behalf of the user via electronic funds transfer (EFT), such as via an automated clearing house (ACH). A non-bank-administered financial account may be a financial account associated with a non-banking entity that holds financial assets on behalf of a user entity and by which payments may be made on behalf of the user entity via transfer of the financial assets via a payment platform. Non-limiting examples of a non-bank-administered financial account include digital wallets (e.g., PayPal, Venmo, Zelle, and/or the like), accounts on stock or commodity trading platforms, accounts on person-to-person or business-to-business lending platforms, and/or the like. A cryptographic asset wallet may include a device, physical medium, program, or service that stores public and/or private keys for authorizing transfers of cryptographic assets (e.g., Bitcoin, Ethereum, Tether, and/or the like) via a distributed ledger service, such as a blockchain protocol or smart contract (e.g., Bitcoin protocol, Ethereum network, TRON network, etc.).

In some embodiments, the user computing entity 111 includes one or more components that are functionally similar to those of the remote server 200. As noted previously, the terms device, system, computing entity, entity, server, and/or similar words used herein interchangeably may refer to at least, for example, one or more computers, computing entities, mobile phones, tablets, phablets, watches, glasses, ear pieces, wristbands, wearable items/devices, fobs, other internet-of-things (IoT) devices, and/or the like, and/or any combination of devices or entities adapted to perform the functions, operations, and/or processes described herein. In some embodiments, the user computing entity 111 includes one or more displays 118, one or more input devices 120, an application 122, and memory 124. In some embodiments, the user computing entity 111 includes an antenna 126, a transmitter 128 (e.g., radio), a receiver 130 (e.g., radio), and a processing element 132 (e.g., CPLDs, microprocessors, multi-core processors, cloud processors, coprocessing entities, ASIPs, microcontrollers, and/or controllers) that provides signals to and receives signals from the transmitter 128 and receiver 130, respectively.

In one embodiment, the signals provided to and received from the transmitter 128 and the receiver 130, respectively, may include signaling information/data in accordance with air interface standards of applicable wireless systems. In this regard, the user computing entity 111 may be capable of operating with one or more air interface standards, communication protocols, modulation types, and access types. More particularly, the user computing entity 111 may operate in accordance with any of a number of wireless communication standards and protocols, such as those described above with regard to the remote server 200 or fuel exchange system 103. In a particular embodiment, the user computing entity 111 may operate in accordance with multiple wireless communication standards and protocols, such as UMTS, CDMA2000, 1×RTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the user computing entity 111 may operate in accordance with multiple wired communication standards and protocols, such as those described above with regard to the remote server 200, fuel exchange system 103, and/or fueling system 112 via a network 150.

Via these communication standards and protocols, the user computing entity 111 can communicate with various other entities using concepts such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). In one embodiment, the user computing entity 111 can also download changes, add-ons, and updates, for instance, to its firmware, software (e.g., including executable instructions, applications, program modules), and operating system.

According to one embodiment, the user computing entity 111 may include location determining aspects, devices, modules, functionalities, and/or similar words used herein interchangeably. For example, the user computing entity 111 may include outdoor positioning aspects, such as a location module adapted to acquire, for example, latitude, longitude, altitude, geocode, course, direction, heading, speed, universal time (UTC), date, and/or various other information/data. In one embodiment, the location module can acquire data, sometimes known as ephemeris data, by identifying the number of satellites in view and the relative positions of those satellites (e.g., using global positioning systems (GPS)). In one embodiment, the satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This information/data can be collected using a variety of coordinate systems, such as the DecimalDegrees (DD); Degrees, Minutes, Seconds (DMS); Universal Transverse Mercator (UTM); Universal Polar Stereographic (UPS) coordinate systems; and/or the like. Alternatively, the location information/data can be determined by triangulating a position of the user computing entity 111 in connection with a variety of other systems, including cellular towers, Wi-Fi access points, and/or the like. Similarly, the user computing entity 111 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops) and/or the like. For instance, such technologies may include the iBeacons, Gimbal proximity beacons, Bluetooth Low Energy (BLE) transmitters, Bluetooth Smart, Wi-Fi Direct transmitters, NFC transmitters, and/or the like. These indoor positioning aspects can be used in a variety of settings to determine the location of someone or something to within inches or centimeters.

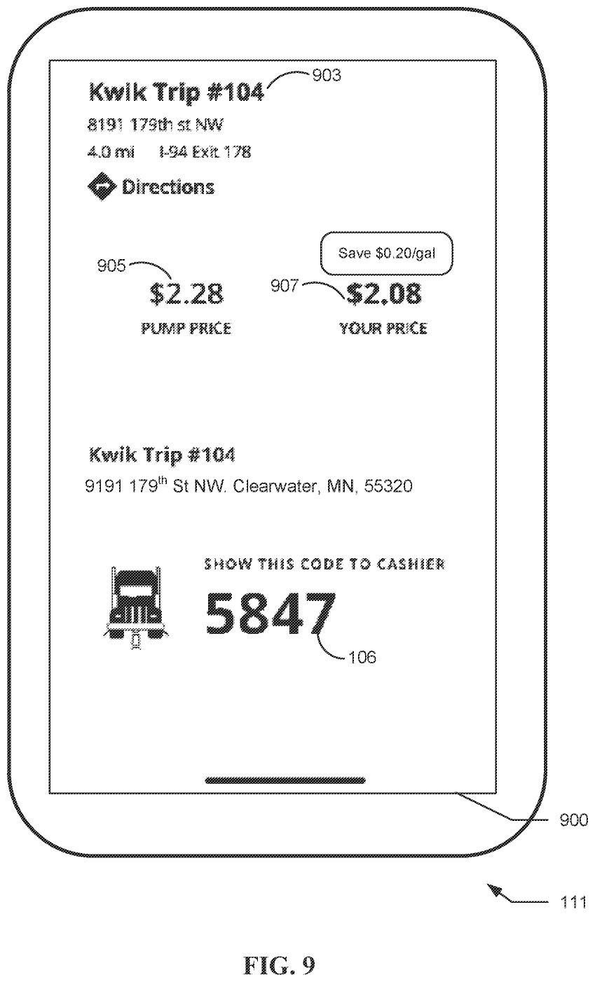

In some embodiments, the user computing entity 111 includes an application 122 that accesses services and functions of the remote computing environment 101. For example, the user computing entity 111 may communicate with the computing environment 101 using the application 122. In some embodiments, the application 122 transmits request for generation and receipt of fuel codes 106 to the remote computing environment 101. For example, the application 122 causes the user computing entity 111 to generate a graphical user interface by which a user entity may provide a user input for requesting generation and receipt of a fuel code 106 for a fueling location associated with a fuel entity. In response to the user computing entity 111 receiving the user input, the application 122 may generate and transmit to the remote computing environment 101 a fuel code request including the fueling location, an identifier for the fuel entity, a timestamp of the user input, a location of the user computing entity 111, and/or a current fuel exchange ratio associated with the fueling location and/or fuel entity. In some embodiments, the application 122 receives a fuel code 106 from the computing environment 101 and stores the fuel code 106 in memory 124 of the user computing entity 111. In some embodiments, the application 122 accesses a network address, such as a webpage, at which a fuel code 106 may be downloaded or obtained and rendered on a display 118 of the user computing entity 111. In some embodiments, the application 122 causes the user computing entity 111 to generate and render graphical user interfaces for requesting a fuel code 106, displaying a location of the user computing entity 111, displaying a location of one or more fueling locations, displaying a fuel exchange ratio for one or more fueling locations, accessing and displaying information associated with a user account 104, accessing and displaying historical fuel exchange data 109, and/or the like. An example graphical user interface that may be generated by the application 122 and rendered on the user computing entity 111 is depicted by the graphical user interface 900 shown in FIG. 9 and described herein.

In one example, the application 122 communicates with the remote computing environment 101 to receive geolocation data indicative of a location of one or more fueling locations. The application 122 may cause the user computing entity 111 to generate and render a graphical user interface including a map on which the locations of the one or more fueling locations are rendered. In another example, the application 122 communicates with the remote computing environment 101 to receive a current fuel exchange ratio for one or more fueling locations. The current fuel exchange ratio may be a discounted price per volume fuel price available to user entities by providing a fuel code 106 to the fuel exchange system 103 associated with the fueling location.

In some embodiments, the application 122 interfaces with other software or applications installed or running on the user computing entity 111. Such software may include geolocation software, Internet browsing software, image capture software, user authentication software, and software that manages or provides access to information associated with a user entity's instrument of exchange (e.g., credit cards, debit cards, banking accounts, cryptographic asset wallets, and other payment instruments). In one example, the application 122 interfaces with a navigation application to determine and provide a location of the user computing entity 111 to the remote computing environment 101 and/or generate a graphical user interface including a virtual map that displays the location and one or more fueling locations. In another example, the application 122 interfaces with a payment instrument management application to obtain and provide to the remote computing environment 101 various data associated with the user entity's instrument of exchange (e.g., credit card number, expiration data, card verification value, and/or the like).

In one embodiment, the user computing entity 111 may also comprise a user interface 117 (that can include a display 118 coupled to a processing element 132), which may include user input interface (coupled to a processing element 132). For example, the user interface 117 may be an application 122, browser, user interface, interface, and/or similar words used herein interchangeably executing on and/or accessible via the user computing entity 111 to interact with and/or cause display of information/data from the remote server 200, as described herein. The user input interface can comprise any of input devices 120 allowing the user computing entity 111 to receive data, such as a keypad (hard or soft), a touch display, voice/speech or motion interfaces, or other input device. In embodiments including a keypad, the keypad can include (or cause display of) the conventional numeric (0-9) and related keys (#, *), and other keys used for operating the user computing entity 111 and may include a full set of alphabetic keys or set of keys that may be activated to provide a full set of alphanumeric keys. In addition to providing input, the user input interface can be used, for example, to activate or deactivate certain functions, such as screen savers and/or sleep modes.

In certain embodiments, the user interface (e.g., the display 118) may be configured for displaying fuel codes that may be provided or presented to a fuel exchange system 103 to initiate and enable authorization of a fuel exchange. For example, the user interface of the user computing entity 111 may be utilized to display a QR code, a bar code, an image, and/or the like that is machine-readable and indicative of a fuel code. Similarly, the user computing entity 111 may be configured for storing fuel codes 106 thereon, and transmitting inputs indicative of fuel codes 106 via any of a variety of wireless data transmission protocols (e.g., Bluetooth, Wi-Fi, NFC, and/or the like) to the fuel exchange system 103.

In some embodiments, the user computing entity 111 includes memory 124, which can be embedded and/or may be removable. For example, the non-volatile memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The memory 124 may include volatile memory and/or non-volatile memory. The memory 124 can store databases, database instances, database management systems, data, applications, programs, program modules, scripts, source code, object code, byte code, compiled code, interpreted code, machine code, executable instructions, and/or the like to implement the functions of the user computing entity 111. The memory 124 can store fuel codes 106, data associated with a user account 104, identifiers 108, and/or fuel exchange data 109. As indicated, this may include an application 122 that is resident on the user computing entity 111 or accessible through a browser or other user interface for communicating with the remote server 200, fuel exchange system 103, and/or various other computing entities.

As will be recognized, the user computing entity 111 may include one or more components or functionality that are the same or similar to those of the remote server 200, as described in greater detail below. As will be recognized, these architectures and descriptions are provided for exemplary purposes only and are not limiting to the various embodiments.

### Exemplary Networks

In one embodiment, any two or more of the illustrative components of the architecture of FIG. 1 may be configured to communicate with one another via respective communicative couplings to one or more networks 150. The networks 150 may include, but are not limited to, any one or a combination of different types of suitable communications networks such as, for example, cable networks, public networks (e.g., the Internet), private networks (e.g., frame-relay networks), wireless networks, cellular networks, telephone networks (e.g., a public switched telephone network), or any other suitable private and/or public networks. Further, the networks 150 may have any suitable communication range associated therewith and may include, for example, global networks (e.g., the Internet), metropolitan area networks (MANs), wide area networks (WANs), local area networks (LANs), or personal area networks. In addition, the networks 150 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, satellite communication mediums, or any combination thereof, as well as a variety of network devices and computing platforms provided by network providers or other entities.

Transmissions over networks 150 may be “in the clear” or may leverage one of more of a variety of industry-standard or third-party security technologies implemented in any of the OSI layers used. If encryption is used, it may be symmetric or asymmetric (or implement a combination of the two, as in SSL/TLS, where the initial handshake uses asymmetric encryption in the exchange of symmetric keys, and subsequent transactions use symmetric encryption based on the previously exchanged symmetric keys). As will be recognized, process interaction over a network may be synchronous or asynchronous: synchronous-processes are coupled and include web services (e.g., SOAP), which may in turn leverage http(s); and various other remote procedure call (RPC), middleware protocols, industry-standard exchange formats (e.g., XML or JSON), and integration architectures (e.g., REST) and/or asynchronous-processes are decoupled and mechanisms include message queues and file transfers.

### Exemplary Remote Server

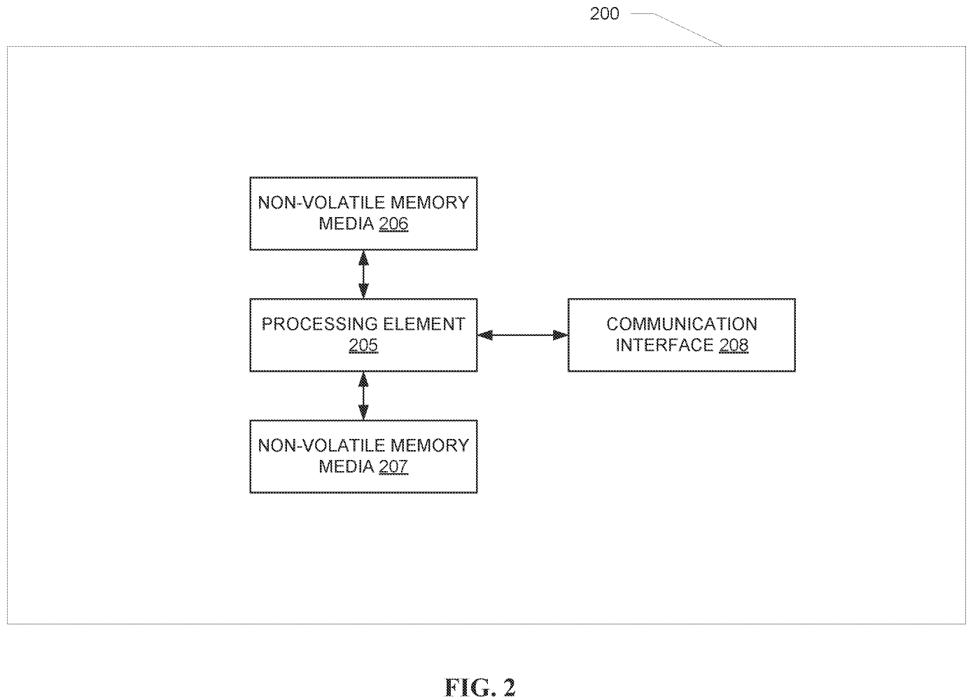

FIG. 2 provides a schematic of a remote server 200 according to one embodiment of the present techniques for fuel exchange authorization and optimization. In one embodiment, the remote server 200 may be in network communication with one or more user computing entities 111, one or more fuel exchange systems 103, one or more computing systems associated with administrating and/or issuing an instrument of exchange, and/or the like. In certain embodiments, the remote server 200 may be operable in association with other computing devices and/or platforms (e.g., operable via third parties, such as banking institutions' online banking platforms) to accomplish certain functions (e.g., user authentication) to retrieve certain data, and/or the like. In general, the terms computing entity, computer, entity, device, system, server, machine, and/or similar words used herein interchangeably may refer to, for example, one or more computers, computing entities, desktop computers, mobile phones, tablets, phablets, notebooks, laptops, distributed systems, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, controlling, remotely controlling, dispensing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

In one embodiment, the remote server 200 may include or be in communication with one or more processing elements 205 (also referred to as processors, processing circuitry, processing device, and/or similar terms used herein interchangeably) that communicate with other elements within the remote server 200 via a bus, for example. In certain embodiments, the processing element may access various data to perform functions of the remote server 200, such as user accounts (e.g., user (login) ID, password (or other authentication credential(s), user name, user registration status, and/or the like), fuel codes, identifiers, fuel exchange data, and/or the like. As will be understood, the processing element 205 may be embodied in a number of different ways. For example, the processing element 205 may be embodied as one or more complex programmable logic devices (CPLDs), “cloud” processors, microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like. As will therefore be understood, the processing element 205 may be configured for a particular use or configured to execute instructions stored in volatile or non-volatile memory or otherwise accessible to the processing element 205. As such, whether configured by hardware or computer program products, or by a combination thereof, the processing element 205 may be capable of performing steps or operations according to embodiments of the present techniques for fuel exchange authorization and optimization when configured accordingly.

In one embodiment, the remote server 200 may further include or be in communication with non-volatile memory 206 (also referred to as non-volatile storage, memory, memory storage, memory circuitry and/or similar terms used herein interchangeably), which may include or be embodied as one or more data stores 102. In one embodiment, the non-volatile storage or memory may include one or more non-volatile storage or memory media 206, including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. As will be recognized, the non-volatile storage or memory media 206 may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or information/data that is stored in a computer-readable storage medium using one or more database models, such as a hierarchical database model, network model, relational model, entity-relationship model, object model, document model, semantic model, graph model, and/or the like.

In one embodiment, the remote server 200 may further include or be in communication with volatile memory 207 (also referred to as volatile storage, memory, memory storage, memory circuitry and/or similar terms used herein interchangeably), which may include or be embodied as one or more data stores 102. In one embodiment, the volatile storage or memory may also include one or more volatile storage or memory media 207, including but not limited to RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 205. Thus, the databases, database instances, database management systems, data, applications, programs, program modules, scripts, source code, object code, byte code, compiled code, interpreted code, machine code, executable instructions, and/or the like may be used to control certain aspects of the operation of the remote server 200 with the assistance of the processing element 205 and operating system.

As indicated, in one embodiment, the remote server 200 may also include one or more communications elements/interfaces 208 for communicating with various computing entities, such as by communicating data, content, information, and/or similar terms used herein interchangeably that can be transmitted, received, operated on, processed, displayed, stored, and/or the like. For instance, the remote server 200 may communicate with one or more networks 150, one or more user computing entities 111, one or more fuel exchange systems 103, one or more computing systems associated with administration or issuance of an instrument of an exchange (e.g., banking institutions, credit and/or debit card networks, cryptographic asset environments, such as blockchains, etc.,), and/or the like.

In certain embodiments, the remote server 200 may be configured to authorize fuel exchanges based at least in part on receipt and processing of data as described herein. For example, the remote server 200 may generate, store, and provide a fuel code to a user computing entity 111. The remote server 200 may receive fuel exchange authorization data objects indicative of a fuel code. The remote server 200 may validate the received fuel code against stored fuel codes, where the validation data object reflecting validation of the fuel code may be provided to a fuel exchange system. The remote server 200 may receive a fuel exchange payload generated by the fuel exchange system respective to a fuel event, where the fuel exchange payload indicates a fuel exchange amount. The remote server 200 may authorize and initiate an exchange of value for the fuel exchange amount using a user entity's instrument of exchange. Thus, the remote server may enable authorization and initiation of fuel exchanges without exposing sensitive information for the instrument of exchange to the fuel exchange system (e.g., also eliminating a need for a user entity to present such information to an operator of the fuel exchange system).

As indicated, in one embodiment, the remote server 200 may also include one or more communications interfaces 208 for communicating with various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the remote server 200 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol. The remote server 200 may use such protocols and standards to communicate using Border Gateway Protocol (BGP), Dynamic Host Configuration Protocol (DHCP), Domain Name System (DNS), File Transfer Protocol (FTP), Hypertext Transfer Protocol (HTTP), HTTP over TLS/SSL/Secure, Internet Message Access Protocol (IMAP), Network Time Protocol (NTP), Simple Mail Transfer Protocol (SMTP), Telnet, Transport Layer Security (TLS), Secure Sockets Layer (SSL), Internet Protocol (IP), Transmission Control Protocol (TCP), User Datagram Protocol (UDP), Datagram Congestion Control Protocol (DCCP), Stream Control Transmission Protocol (SCTP), HyperText Markup Language (HTML), and/or the like.

Although not shown, the remote server 200 may include or be in communication with one or more input elements, such as a keyboard input, a mouse input, a touch screen/display input, motion input, movement input, audio input, pointing device input, joystick input, keypad input, and/or the like. In one embodiment, the remote server 200 may also include or be in communication with one or more output elements (not shown), such as audio output, video output, screen/display output, motion output, movement output, and/or the like.

As will be appreciated, one or more of the components of the remote server 200 may be located remotely from other remote server 200 components, such as in a distributed system. Furthermore, one or more of the components may be combined and additional components performing functions described herein may be included in the remote server 200. Thus, the remote server 200 can be adapted to accommodate a variety of needs and circumstances. As will be recognized, these architectures and descriptions are provided for exemplary purposes only and are not limiting to the various embodiments.

### Exemplary Fuel Exchange System

FIG. 3 provides a schematic of a fuel exchange system 103 according to one embodiment of the present techniques for fuel exchange authorization and optimization. In one embodiment, the fuel exchange system 103 may be in network communication with the remote computing environment 101 (e.g., such as by network communication with one or more remote servers 200), one or more user computing entities 111, one or more computing systems associated with administrating and/or issuing an instrument of exchange, and/or the like. In certain embodiments, the fuel exchange system 103 may be operable in association with other computing devices and/or platforms (e.g., operable via third parties, such as banking institutions' online banking platforms) to accomplish certain functions (e.g., receiving user input, generating and providing fuel exchange authorization data objects and fuel exchange payloads, receiving validations of fuel codes, etc.,) to retrieve or provide certain data, and/or the like.

In various embodiments, the fuel exchange system 103 includes or embodies one or more computers, computing entities, desktop computers, mobile phones, tablets, phablets, notebooks, laptops, distributed systems, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, controlling, remotely controlling, dispensing, displaying, storing, determining, creating/generating, monitoring, evaluating, comparing, and/or similar terms used herein interchangeably. For example, the fuel exchange system 103 may receive user inputs indicative of fuel codes and other fuel exchange-related or fuel event-related data, such as an identifier for a fueling system 112 by which fuel may be provided to a user entity, a fuel volume, an identifier for a product, such as a type of fuel, timestamps for receipt of user inputs at a fueling system 112, timestamps for start and end of fuel events, and/or the like. As another example, the fuel exchange system 103 may control a fueling system 112, such as by automatically transitioning a fueling system 112 between inactive and active states based on data received from a remote computing environment via an API. In another example, the fuel exchange system 103 processes a user input based on a storage instruction and determines that the user input includes a format corresponding to a fuel code payment type. In another example, in response to recognizing a user input as indicative of a fuel code, the fuel exchange system 103 transforms the user input into a data format by which the user input may be transmitted to or collected by a remote computing environment using one or more APIs. In one embodiment, these functions, operations, and/or processes can be performed on data, content, information, and/or similar terms used herein interchangeably.

In one embodiment, the fuel exchange system 103 may include or be in communication with one or more processing elements 305 (also referred to as processors, processing circuitry, processing device, and/or similar terms used herein interchangeably) that communicate with other elements within the fuel exchange system 103 via a bus, for example. In certain embodiments, the processing element 305 may access or receive data associated with performing functions described herein, such as user inputs, fuel codes, validations or rejections of fuel codes, fuel exchange-related data (e.g., fuel exchange ratios, fuel volumes, fuel volume limits, fuel types, and other fuel event data), and/or the like. As will be understood, the processing element 305 may be embodied in a number of different ways. For example, the processing element 305 may be embodied as one or more complex programmable logic devices (CPLDs), “cloud” processors, microprocessors, multi-core processors, coprocessing entities, application-specific instruction-set processors (ASIPs), microcontrollers, and/or controllers. Further, the processing element 305 may be embodied as one or more other processing devices or circuitry. The term circuitry may refer to an entirely hardware embodiment or a combination of hardware and computer program products. Thus, the processing element 305 may be embodied as integrated circuits, application specific integrated circuits (ASICs), field programmable gate arrays (FPGAs), programmable logic arrays (PLAs), hardware accelerators, other circuitry, and/or the like. As will therefore be understood, the processing element 305 may be configured for a particular use or configured to execute instructions stored in memory 114 (e.g., in volatile or non-volatile memory) or otherwise accessible to the processing element 305. As such, whether configured by hardware or computer program products, or by a combination thereof, the processing element 305 may be capable of performing steps or operations according to embodiments of the present techniques for fuel exchange authorization and optimization when configured accordingly. In various, functions of the processing element 305, and/or other elements of the fuel exchange system 103, are modified according to storage instructions. Such storage instructions, when executed by the processing element 305, may enable the fuel exchange system 103 to recognize user input for fuel codes and, in response, provide the user input (e.g., or reformatted version thereof) to a remote computing environment 101 for validation and completion of an exchange of value (e.g., following activation of a fueling system and a fuel event in instances of successful fuel code validation). When executed by the processing element 305, the storage instructions may also cause the fuel exchange system 103 to transform such user input, and potentially other fuel exchange-related data, into a format by which the user input may be provided to or collected by an external computing system, such as via one or more APIs.

In one embodiment, the fuel exchange system 103 may further include or be in communication with non-volatile memory 306 (also referred to as non-volatile storage, memory, memory storage, memory circuitry and/or similar terms used herein interchangeably), which may include or be embodied as memory 114. In one embodiment, the non-volatile storage or memory may include one or more non-volatile storage or memory media 306, including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. As will be recognized, the non-volatile storage or memory media 306 may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or information/data that is stored in a computer-readable storage medium using one or more database models, such as a hierarchical database model, network model, relational model, entity-relationship model, object model, document model, semantic model, graph model, and/or the like. In some embodiments, the non-volatile memory 306 stores storage instructions 116 that cause the processing element 305 to modify a format of user input data stored at the fuel exchange system 103 to enable performance of functions described herein for remotely initiating and executing fuel exchanges based on user inputs indicative of fuel codes.

In one embodiment, the fuel exchange system 103 may further include or be in communication with volatile memory 307 (also referred to as volatile storage, memory, memory storage, memory circuitry and/or similar terms used herein interchangeably), which may include or be embodied as one or more data stores 102. In one embodiment, the volatile storage or memory may also include one or more volatile storage or memory media 307, including but not limited to RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 305. Thus, the databases, database instances, database management systems, data, applications, programs, program modules, scripts, source code, object code, byte code, compiled code, interpreted code, machine code, executable instructions, and/or the like may be used to control certain aspects of the operation of the fuel exchange system 103 with the assistance of the processing element 305 and operating system. In some embodiments, the volatile memory 307 temporarily stores user inputs according to a storage instruction 116. For example, in response to the processing element 305 recognizing a user input as indicating a fuel code (e.g., via execution of the storage instruction 116), the volatile memory 307 temporarily stores the user input according to the storage instruction 116.

As indicated, in one embodiment, the fuel exchange system 103 may also include one or more communications elements/interfaces 308 for communicating with various computing entities, such as by communicating data, content, information, and/or similar terms used herein interchangeably that can be transmitted, received, operated on, processed, displayed, stored, and/or the like. For instance, the fuel exchange system 103 may communicate with one or more networks 150, one or more user computing entities 111, a remote computing environment 101, one or more fueling systems 112, one or more computing systems associated with administration or issuance of an instrument of an exchange (e.g., banking institutions, credit and/or debit card networks, cryptographic asset environments, such as blockchains, etc.,), and/or the like.

In some embodiments, the fuel exchange system 103 includes one or more input/output elements 309 that receive an indication of a user input and, in some embodiments, provide an output or input to one or more computing devices. In some embodiments, the input/output element 309 embodies or communicates with the input device 110. For example, the input/output element 309 provides output to and receives input from one or more computing devices (e.g., user computing entities 111, input devices 110, and/or the like). In some embodiments, the input/output element 309 provides user inputs to the processing element 305. The input/output element 309 may comprise one or more software interface(s) and in some embodiments includes a display that comprises the interface(s) rendered as a web user interface, an application user interface, a user device, a backend system, or the like. In some embodiments, the input/output element 309 also includes a keyboard, a mouse, a joystick, a touch screen, touch areas, soft keys a microphone, a speaker, and/or other input/output mechanisms.

In certain embodiments, using the processing element 305, memory 114, communication interface 308, and input/output element 309, the fuel exchange system 103 may be configured to obtain authorization for fuel exchanges based at least in part on receipt and processing of data as described herein. For example, the fuel exchange system 103 may receive a fuel code (e.g., together with metadata identifying the fuel code), and transform the fuel code into a format by which a remote computing environment 101 may recognize the fuel code. However, it should be understood that in certain embodiments, no reformatting of the fuel code is necessary before transmitting the fuel code to the remote computing environment 101. The fuel exchange system 103 may receive a validation data object reflecting validation of the fuel code from the remote computing environment 101 using one or more APIs. The validation data object, or additional received data, may indicate a fuel exchange ratio by which a fuel exchange amount (e.g., cost) for the fuel exchange may be determined. The validation data object reflecting validation of the fuel code may cause the fuel exchange system 103 to automatically transition a fueling system from an inactive state to an active state (e.g., potentially based additional fuel exchange data received, such as a fuel volume limit, preauthorization limit, and/or the like). The fuel exchange system 103 may receive fuel event data from the fueling system 112, including a fuel volume. The fuel exchange system may generate a fuel exchange amount based on the fuel volume and a fuel exchange ratio. The fuel exchange system 103 may generate a fuel exchange payload indicative of the fuel exchange amount (e.g., and other data, such as a fuel volume, product identifier(s), and/or the like) and provide the fuel exchange payload to the remote computing environment 101 using one or more APIs. The fuel exchange system 103 may receive an outcome of the fuel exchange amount from the remote computing environment 101 via the one or more APIs.

As indicated, in one embodiment, the fuel exchange system 103 may also include one or more communications interfaces 308 for communicating with various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the fuel exchange system 103 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol. The fuel exchange system 103 may use such protocols and standards to communicate using Border Gateway Protocol (BGP), Dynamic Host Configuration Protocol (DHCP), Domain Name System (DNS), File Transfer Protocol (FTP), Hypertext Transfer Protocol (HTTP), HTTP over TLS/SSL/Secure, Internet Message Access Protocol (IMAP), Network Time Protocol (NTP), Simple Mail Transfer Protocol (SMTP), Telnet, Transport Layer Security (TLS), Secure Sockets Layer (SSL), Internet Protocol (IP), Transmission Control Protocol (TCP), User Datagram Protocol (UDP), Datagram Congestion Control Protocol (DCCP), Stream Control Transmission Protocol (SCTP), HyperText Markup Language (HTML), and/or the like.

As will be appreciated, one or more of the components of the fuel exchange system 103 may be located remotely from other fuel exchange system 103 components, such as in a distributed system. Furthermore, one or more of the components may be combined and additional components performing functions described herein may be included in the fuel exchange system 103. Thus, the fuel exchange system 103 can be adapted to accommodate a variety of needs and circumstances. As will be recognized, these architectures and descriptions are provided for exemplary purposes only and are not limiting to the various embodiments.

### Technical Challenges

As previously indicated, obtaining fuel (e.g., vehicle fuel, such as diesel fuel for long-haul truckers) from a fueling station has historically required that a party obtaining the fuel be present at fueling station to initiate a desired exchange of fuel by providing payment instrument data, such as a credit card, debit card, and/or the like. The requirement of physical party presence and furnishing of a payment instrument at the fueling station to initiate fuel exchanges may decrease efficiency of transporting goods due to increased time required to complete a fuel stop. Existing fueling systems lack the capability to interface with and be controlled by a remote computing environment and replacement of such fueling systems may be cost prohibitive due to such activities creating undesirable disruptions to fueling services and the reliance of existing fueling systems on legacy computing infrastructure and software that are no longer maintained or updated. As a result, technical challenges of providing remote access functionality at fueling stations may require specially configured computing solutions that work within and accommodate for limitations of legacy fuel exchange systems. However, due in part to abundant diversity in software schemas and hardware configurations, effective solutions must be backwards compatible with a wide variety of fuel exchange systems.

In addition, previous approaches to initiating and transacting fuel exchanges typically include a customer providing payment instrument data to a fueling system and/or fuel exchange system. The provision of sensitive financial information to the fueling system or fuel exchange system may introduce a risk of the sensitive financial information becoming exposed, such as may occur via payment instrument skimming devices, breach of fueling system storage, illicit recording of payment instrument data by employees, and/or the like. For example, a customer may scan or swipe a payment card at a register modified with a skimming device that records payment instrument data. As another example, a surveillance system may capture images of a customer's payment card by which payment instrument data may be extracted. As a result of the requirement to provide payment instrument data, previous approaches to initiating fuel events and fuel transactions may undesirably increase a risk of data breaches, fraud, and other security concerns.

Lastly, even in embodiments where a portion of a fuel exchange transaction can be initiated remotely, the nature of fuel dispensing as a process requires at least some portion of the process to be performed “in-person” at a fueling system to physically dispense fuel into a vehicle or other container. Therefore, the introduction of a “remote” element to this inherently in-person process has a risk of introducing additional friction-elements to the user experience that may prevent users/customers from using the remote aspect of the process. Therefore, a technical challenge exists to sufficiently link the remotely performed portions of a fuel exchange transaction with the in-person portion of the process for physically dispensing fuel into a vehicle/container, while avoiding the risks of exposing portions of the process to risks of fraud.

### Technical Solutions

Inventors in the present disclosure have developed technical solutions enabling remote fuel exchange initiation at fuel exchange systems, which overcome the above technical challenges and, thereby, improve the performance of fuel exchange systems. As described herein, such technical solutions include processes for linking remotely performed process steps (e.g., when a user generates a fuel code to lock-in a desired price) and in-person process steps (e.g., when the same user dispenses fuel from a fueling system) by enabling the fueling system to accept fuel codes and to determine that those fuel codes are sufficient to authorize a fuel distribution transaction without receipt of additional payment information. The fueling system is configured to both identify the fueling code as a fueling code that may be utilized with the process discussed herein, and to work with other computing entities to ensure that the fuel code is valid before activating the flow of fuel through the handle to the user. This process may be performed without exposing the user entity's sensitive payment information to the fueling station, fueling system, or associated fuel entity. For example, a customer may provide a fuel code to a graphical user interface and/or other specially-configured input device of a fueling system. The fueling system may receive, via the GUI, user input data indicative of the fuel code. The fuel code may be provided to a fuel exchange system associated with the fueling system. The fuel exchange system may then provide the fuel code to a remote server configured to receive or retrieve (e.g., scrape) fuel exchange data from the fuel exchange system in response to detecting or receiving the fuel code indicated by the user input.

The remote computing environment may receive the user input data and match the user input data to a stored record for validation. For example, the remote computing environment may compare and match a fuel code indicated by the user input data to a stored fuel code. The remote computing environment may provide a validation data object reflecting validation of the user input data to the fuel exchange system without the fuel exchange system receiving and providing payment instrument data to a transaction processing service.

Furthermore, the remote computing system may interface with the customer via the customer's computing device (user entity device) to obtain and store traditional payment instrument data by which payment for a fuel exchange may be obtained. Following a fuel event and validation of the user input data, the remote computing system may receive a fuel exchange payload generated by the fuel exchange system (e.g., instead of the fuel exchange system providing a transaction payload to a traditional payment instrument administrator). The remote computing system may supplement the fuel exchange payload with the traditional payment instrument data of the customer and communicate with a corresponding payment instrument administrator and/or transaction processing network to complete payment for the fuel exchange. The remote computing system may also receive inputs from the customer's computing device that indicate products or services associated with the fuel exchange, thereby enabling the remote computing system to distinguish between and indicate, to a payment instrument administrator, different types of products and services associated with the fuel exchange. By supplementing the fuel exchange data with additional product and service information as received or determined from user inputs, the remote computing environment may enable recognition and differentiation of products, even where the fuel exchange system does not output data indicating different types of products and services involved in a fuel exchange.

### Example Operation

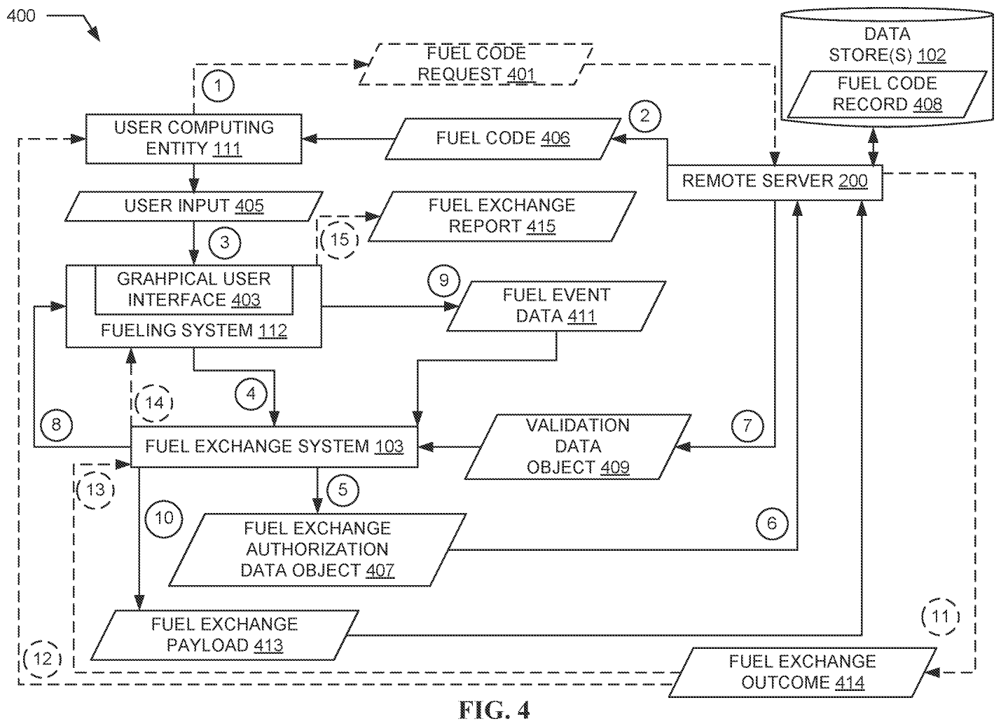

FIG. 4 provides an example data flow 400 for authorizing a fuel exchange and initiating fuel dispersion according to certain embodiments. In various embodiments, a sequence of the data flow 400 is indicated in FIG. 4 by numerical indicia 1-15. In some embodiments, one or more operations of the data flow 400 are combined or omitted.

In some embodiments, a remote server 200 receives from a user computing entity 111 a fuel code request 401 (see indicium 1). The fuel code request 401 may be generated and provided to the remote server 200 in response to the user computing entity 111 receiving a user input provided to an executable software application on the user computing entity 111. In a particular example, the fuel code request 401 is generated and provided to the remote server 200 in response to an application 122 (e.g., installed on or accessed by the user computing entity 111) receiving a user input to a graphical user interface. The fuel code request 401 may include an identifier associated with the user computing entity 111, a user entity, and/or a user account at a data store 102 accessible to the remote server 200. The fuel code request 401 may include an identifier associated with a fuel entity, fueling location, and/or fuel exchange system at which a user entity desires to initiate a fuel exchange.

In some embodiments, in response to the fuel code request 401, the remote server 200 generates a fuel code 406 and a fuel code record 408 including data that identifies the fuel code 406. The remote server 200 may store the fuel code record 408 at the data store 102 in association with an identifier for the fuel entity, fueling location, and/or fuel exchange system. Additionally, or alternatively, the remote server 200 may store the fuel code record 408 in association with an identifier for the user computing entity 111, a corresponding user entity, and/or a user account. In some embodiments, the remote server 200 associates the fuel code record 408 with one or more validation rules, such as a predetermined activation interval, a preauthorized fuel exchange amount, an indication that the fuel code is a single-use fuel-code or a predetermined proximity value respective to a fueling location. In some embodiments, the remote server 200 stores, in association with the fuel code record 408, data identifying a fuel exchange discount, such as a discrete value of or percentage-based reduction to a fuel exchange ratio by which a fuel amount may be generated. To implement certain of these validation rules, such as implementing the requirement that fuel codes are single-use fuel codes, the remote server 200 may (either periodically, or upon detecting a trigger event, such as an attempted redemption of a fuel code) compare one or more outstanding, unredeemed fuel codes against a list of redeemed fuel codes. For those fuel codes that have been redeemed, data stored in association with those fuel codes may be updated to indicate that the code has been redeemed.

Each fuel code may be unique, such that no two fuel codes are identical. In practice, fuel codes may periodically be recycled, such as after all fuel codes of a designated length of numeric or alphanumeric characters have been generated. In such embodiments, data reflecting all redeemed fuel codes may be archived for later access or deleted entirely, such that the remote server 200 can recycle the used fuel codes without changing the operations discussed herein. The remote server 200 may store, at the data store 102, a listing of records of valid fuel codes (e.g., fuel codes that have not been redeemed and, in some embodiments, have not been redeemed for a period within an activation interval).

In some embodiments, the remote server 200 provides (e.g., transmits) the fuel code fuel code 406, to the user computing entity 111 (see indicium 2). The user computing entity 111 may store the fuel code 406 in memory. The user computing entity 111 may generate and render on a display a fuel code interface that includes the fuel code 406 such that the user entity may observe the fuel code 406 and provide a corresponding user input. In some embodiments, the remote server 200 provides, to the user computing entity 111, an input instruction that instructs the user entity how to utilize the fuel code 406 to initiate dispensing of fuel at the fueling system 112. The remote server 200 may generate the fuel instruction based on one or more identifiers associated with the fuel code 406 and/or fuel code record 408, such as an identifier for a fueling entity or a fueling location. In one example, based on the identifier of the fuel entity associated with the fuel code 406, the remote server 200 generates an input instruction that indicates to input the fuel code 406 using a graphical user interface (GUI) 403 on the fueling system 112. In another example, based on the identifier of the fuel entity associated with the fuel code 406, the remote server 200 generates an input instruction that indicates to input the fuel code 406 using by presenting scannable media (e.g., a barcode, QR code, and/or the like, rendered on the user computing entity 111) to a scanning device on the fueling system 112.

In some embodiments, the fueling system 112 receives a user input 405 at a graphical user interface (GUI) 403, the user input 405 including the fuel code 406 (see indicium 3). For example, the fueling system 112 may be a fuel pump that includes a touch display for initiating fuel events. The GUI 403 may be rendered on the touch display and a user entity may provide the user input 405 via touch inputs to the touch display or another input device. In some embodiments, the GUI 403 may include a user input field traditionally configured for receiving payment instrument data, a customer account number, and/or the like. For example, the fuel code 406 may be provided within a user input field of the GUI 403, which may be a legacy or existing user input field traditionally utilized for manually inputting a payment card number. The fueling system 112 may execute a script that modifies the user input field such that it may receive the user input 405 and such that the fueling system 112 recognizes the user input 405 as including the fuel code 406. In other embodiments, the fuel code may be entered into a GUI field specifically provided to receive a fuel code, such that receipt of the fuel code via the GUI field causes the fueling system to tag the fuel code with metadata identifying the input as a fuel code. In some embodiments, the fueling system 112 temporarily stores the user input 405 in memory (e.g., for a period sufficient for providing the user input 405 to the fuel exchange system 103, after which the stored user input 405 may be deleted). In some embodiments, prior to providing the fuel code to the fuel exchange system 103, the fueling system 112 reformats the fuel code from a first format to a second format while maintaining metadata with the fuel code to identify the fuel code, which may be an original format associated with legacy software installed at the fuel exchange system 103 or a format by which the fuel exchange system 103 may provide or make accessible the user input 405 to the remote server 200. fuel code 406 fuel code 406

Alternatively, the fueling system 112 receives the user input 405 via an image capture system configured to generate a capture of the user interface rendered on the user computing entity 111, from which the fuel code 406 may be extracted or determined at the fueling system 112 or fuel exchange system 103 (e.g., in response to the fueling system 112 providing the capture to the fuel exchange system 103). In another alternate embodiment, the fueling system 112 receives the fuel code 406 via a device that wirelessly reads or receives the fuel code 406 from a wireless communication element of the user computing entity 111. Where the user computing entity 111 is configured to provide the fuel code directly to the fueling system 112 (without user input provided to the fueling system 112), the user computing entity 111 may be configured to store the fuel code in multiple formats thereon. A first format may be a human-readable format to be displayed as a part of a graphical user interface, and a second format may be a machine-readable format that can be provided to the fueling system 112 (e.g., a barcode, QR code, or other format that can be wirelessly communicated/read from the user computing entity 111 to the fueling system 112).

In some embodiments, in response to determining the user input 405 includes the fuel code 406, the fueling system 112 updates a graphical user interface to display a message indicating that a transaction is processing and the fueling system does not accept entry of additional payment information. In some embodiments, the fueling system 112 disables one or more input devices for receiving payment information in response to determining the user input 405 includes the fuel code 406. For example, the fueling system 112 may include a chip-based payment card reader slot that locks a payment card into the reader slot. In response to determining the user input 405 includes the fuel code 406, the fueling system 112 may disable the locking mechanism of the reader slot such that the fueling system 112 cannot accept payment information provided via the chip-based payment card reader. In various embodiments, once the fuel code has been accepted, the fueling system 112 does not accept further payment information from the user, and input mechanisms of the fueling system (e.g., a card reader slot, a keypad, and/or the like) may be disabled such that users cannot provide payment information to the fueling system 112 after entry of a fuel code. However, it should be understood that the fueling system 112 may provide options for a user to cancel the current transaction, and to provide alternative payment details in a new transaction, prior to entry of a fuel code.

In some embodiments, the fueling system 112 provides the fuel code 406 and metadata identifying the fuel code to the fuel exchange system 103 (see indicium 4). The fueling system 112 may transmit the fuel code 406 and metadata to the fuel exchange system 103 without receiving additional payment information from the user. For example, upon determining the user input 405 comprises a fuel code, the fueling system 112 may update the GUI 403 to display a message indicating that a transaction is processing and the fueling system 112 does not accept entry of additional payment information. The fuel exchange system 103 may process the metadata and recognize the user input 405 as including the fuel code 406. The fuel exchange system 103 may temporarily store the fuel code 406 (and/or other input) in memory according to a storage instruction, such as a third-party storage instruction installed at the fuel exchange system 103. In some embodiments, the fuel exchange system 103 also stores metadata for the fuel code 406 including a receipt timestamp, which may correspond to a time at which the user input 405 was received via the GUI 403.

In some embodiments, the fuel exchange system 103 generates a fuel exchange authorization data object 407 based on the fuel code 406 (see indicium 5). The fuel exchange authorization data object 407 may include the fuel code 406 and potentially other data, such as a receipt timestamp of the user input 405 or an identifier for a fuel entity associated with the fuel exchange system 103. In some embodiments, the fuel exchange authorization data object 407 includes a fuel volume provided to or reserved for a user entity. For example, the fuel exchange authorization data object 407 may include a number of gallons of fuel dispensed by (or to be dispensed by) the fueling system 112. In some embodiments, the fuel exchange authorization data object 407 includes a timestamp corresponding to receipt of the user input 405 at the GUI 403, a time stamp corresponding to activation of the fueling system 112, or a timestamp corresponding to completion of fueling via the fueling system. For example, the fuel exchange authorization data object 407 may include a timestamp at which an input device of a fueling system received the user input 405 (e.g., the input device configured to generate and render the GUI 403 on a display connected to the fueling system).

In another example, the fuel exchange authorization data object 407 may include a timestamp at which a fueling system handle was removed or reinserted into a fueling system. In another example, the fuel exchange authorization data object 407 includes a timestamp at which the fuel exchange system 103 provided a fueling start code to the fueling system 112 and/or a timestamp at which the fuel exchange system 103 provided a fueling end code to the fueling system 112. In some embodiments, the fuel exchange authorization data object 407 includes an identifier for the fueling system 112. For example, the fuel exchange authorization data object 407 may include a fueling system number and/or the like.

In some embodiments, the fuel exchange authorization data object 407 includes data defining a location at which the user input 405 was received and/or at which the fueling system 112 associated with the fuel exchange is located. For example, the fuel exchange authorization data object 407 may include a physical address of a fueling station. In some embodiments, the fuel exchange authorization data object 407 includes a fuel exchange amount, which may be generated based on a fuel volume and a fuel exchange ratio. In one example, the fuel exchange ratio may be a fuel price that does not include a discount (e.g., which may be later applied by the remote server 200 as described herein), such as a current advertised fuel price. In some embodiments, the fuel exchange authorization data object 407 indicates whether the fuel exchange is authorized or in-process. For example, the fuel exchange authorization data object 407 may indicate that a fuel exchange has not been approved by a payment instrument administrator. In another example, the fuel exchange authorization data object 407 may indicate that the fuel exchange is preauthorized and may include a preauthorization limit. In some embodiments, the fuel exchange authorization data object 407 includes one or more product identifiers, such as a stock keeping unit (SKU), part number, product number, universal product code (UPC), standard case code (SCC) and/or the like. In one example, the fuel exchange authorization data object 407 includes an identifier for a type of fuel provided (or requested to be provided) for the fuel exchange, a first SKU for a fuel additive product, and a third SKU for an anti-freeze product.

In some embodiments, the fuel exchange system 103 (and/or the fueling system 112) provides metadata identifying the fuel code 406 as a fuel code prior to providing the fuel code 406 to the remote computing environment as a part of the fuel exchange authorization data object 407. In other embodiments, the fuel exchange system 103 generates the fuel exchange authorization data object 407 via existing (e.g., native or manufacturer-installed) point of sale software that outputs the fuel exchange authorization data object 407 in a data format usable by the fuel exchange system 103 according to existing software. For example, the fuel exchange system 103 may generate the fuel exchange authorization data object 407 in a format that corresponds to a format for fuel exchange initiated in response to receipt of traditional payment instrument data. In some embodiments, the fuel exchange system 103 stores the fuel exchange authorization data object 407 in memory such that the fuel exchange authorization data object 407 is accessible by other software programs. For example, the fuel exchange system 103 may store the fuel exchange authorization data object 407 in a tabular format, a graphical database format, and/or the like, such that the fuel exchange authorization data object 407 may be accessed by a script that recognizes the fuel exchange authorization data object 407 and/or fuel code 406 indicated by the fuel exchange authorization data object 407.

In some embodiments, the fuel exchange system 103 converts the fuel exchange authorization data object 407 into a data format that may be provided to or extracted by the remote server 200. In some embodiments, the fuel exchange system 103 reformats the fuel exchange authorization data object 407 by concatenating one or more characters, truncating one or more characters, replacing one or more characters of, and/or adding one or more characters to, the fuel exchange authorization data object 407. In some embodiments, the fuel exchange system 103 reformats all fuel transaction authorization data objects in an identical manner. In alternate embodiments, the fuel exchange system 103 reformats each fuel transaction authorization data object in a manner unique to each fuel code. In some embodiments, the fuel exchange system 103 generates a format by which to reformat the fuel exchange authorization data object 407 based on the fuel code 406. However, it should be understood that in other embodiments, the fuel exchange system 103 need not reformat the fuel exchange authorization data object 407 prior to communicating via an API to the remote computing environment.

In some embodiments, the fuel exchange system 103 temporarily stores the fuel exchange authorization data object 407 for a period sufficient to allow for reformatting of the fuel exchange authorization data object 407 and providing of the fuel exchange authorization data object 407 to the remote server 200 (e.g., detection and retrieval of the fuel exchange authorization data object 407 by the remote server 200). In some embodiments, following the period and/or providing of the fuel exchange authorization data object 407 to the remote server 200, the fuel exchange system 103 deletes the format-modified fuel exchange authorization data object 407 from memory such that the modified data does not interfere with existing operations of the original software (e.g., native point of sale software) running on the fuel exchange system 103. In one example, temporary storage and subsequent deletion of the differently formatted fuel exchange authorization data object 407 may prevent interference with native point-of-sale software that requires transaction data to be stored in an original data format. In some embodiments, the fuel exchange system 103 retains, in memory, the fuel exchange authorization data object 407 in an unmodified format.

In some embodiments, the fuel exchange system 103 provides the fuel exchange authorization data object 407 to the remote server 200 (see indicium 6). In other embodiments, the fuel exchange system 103 provides only the fuel code 406 and metadata, such as a receipt timestamp, to the remote server 200. For example, the fuel exchange system 103 may relay to the remote server 200 the user input 405 and the metadata that tags the user input 405 as including the fuel code 406 (e.g., and potentially indicates other information, such as a receipt timestamp, fuel entity identifier, and/or the like). The fuel exchange system 103 may provide the fuel exchange authorization data object 407 or user input 405 to the remote server 200 using an API configured to enable network-based communication between the fuel exchange system 103 and the remote server 200.

In some embodiments, the remote server 200 generates and provides to the fuel exchange system 103 a validation data object 409 reflecting validation of the fuel code (see indicium 7). The remote server 200 may provide the validation data object 409 to the fuel exchange system 103 using the API by which the fuel exchange authorization data object 407 was received, or another network interface. The validation data object 409 may indicate to the fuel exchange system 103 authorization to initiate a fuel event respective to a user entity associated with the user computing entity 111. The validation data object 409 may include or indicate additional data, such as a fuel exchange ratio or one or more limits, such as a maximum fuel volume, and/or preauthorized fuel exchange amount. The validation data object 409 may indicate a fueling system identifier for the fueling system 112 or element thereof, such as a particular fuel pump for dispensing fuel or fuel storage element. For example, the validation data object 409 may indicate a fuel pump number.

In some embodiments, the remote server 200 obtains the fuel code 406 from the fuel exchange authorization data object 407 and compares the fuel code 406 to one or more fuel codes stored at the data store 102, including the fuel code record 408. For example, the remote server 200 compares the fuel code 406 to a listing of records of valid fuel codes, including the fuel code record 408. The remote server 200 may query the data store 102 based on the fuel code 406 and, in response, receive a result including a match between the fuel code record 408 (e.g., which may be stored within a list of a plurality of valid fuel codes) and fuel code 406. Additionally, or alternatively, the remote server 200 may query the data store 102 based on the identifier for the fuel entity (e.g., when indicated by the fuel exchange authorization data object 407). Additionally, in some embodiments, the remote server 200 may compare the identifier for the fuel entity indicated by the fuel exchange authorization data object to the entity identifier stored in association with the fuel code record 408 at the data store 102. The remote server 200 may determine whether the indicated identifier matches the stored entity identifier, where a positive determination may confirm a threshold for validating the fuel code 406. Additionally, or alternatively, in some embodiments, the remote server 200 may determine whether a receipt timestamp of the user input 405 is within a predetermined activation interval (e.g., 1 hour, 12 hours, 1 day, or any suitable interval measured from a receipt time of the fuel code request 401), where a positive determination may confirm a threshold for validating the fuel code 406. Additionally, or alternatively, in some embodiments, the remote server 200 may determine a location of the user computing entity 111, such as by requesting and receiving geolocation data from the user computing entity 111. The remote server 200 may determine whether the location of the user computing entity 111 is within a predetermined proximity of a fueling location associated with the indicated identifier for the fuel entity, where a positive determination may confirm a threshold for validating the fuel code 406.

In some embodiments, the fueling system 112 receives the validation data object 409 reflecting validation of the fuel code (e.g., or data identifying or confirming receipt of the validation data object 409) from the fuel exchange system 103, such as via a local network (see indicium 8). In some embodiments, in response to the validation data object 409, the fueling system 112 automatically transitions from an inactive state to an active state in which fuel may be dispensed or retrieved from the fueling system 112. For example, in response to the validation data object 409, the fueling system 112 may disable a locking mechanism for a handle of a fuel pump such that the handle may be used to dispense fuel from the fuel pump. In another example, the fueling system 112 may activate a valve such that a handle of a fuel pump may receive and dispense fuel from a fuel reservoir. In another example, the fueling system 112 may complete a circuit including a plug and socket and a power source such that electric current may be conducted from the power supply to a vehicle via the plug and socket.

In some embodiments, the validation data object 409 identifies one or more limits on the fuel event and/or fuel transaction. For example, the validation data object 409 may include data that identifies a fuel volume limit, fuel exchange limit, fueling time limit, and/or the like. In some embodiments, based on the one or more limits, the fueling system 112 activates one or more counters or other measurement devices or sensors. For example, the fueling system 112 initiates a fuel volume or fuel rate counter. In another example, the fueling system 112 initiates a fuel exchange amount counter that tracks, in real-time, a value of a fuel exchange based on fuel dispensed from the fueling system 112 to a user entity. In another example, the fueling system 112 initiates a timer for tracking a duration of the fuel event. In another example, the validation data object 409 identifies a particular fuel type, such as via an identifier or metadata. The fueling system 112 may enable a handle of a fuel pump associated with the particular fuel type by transitioning the fuel pump to an active state for dispensing the particular fuel type (e.g., while potentially disabling or maintaining an inactive state of pump mechanisms associated with other fuel types). Such fuel type-specific activation may include the fueling system 112 enabling or disabling one or more valves or locking mechanisms for dispensing the particular fuel type while maintaining or disabling valves or other locking mechanisms for other fuel types. In some embodiments, once the fueling system 112 receives data indicating the fuel code 406 has been accepted (e.g., upon receipt of a validation data object 409 as discussed herein), the fueling system 112 updates the GUI 403 to indicate the fuel code 406 has been accepted and subsequently updates the GUI 403 to request the user entity to select a fuel type to begin fueling.

In some embodiments, in response to receiving the validation data object 409, the fuel exchange system 103 may initiate a fuel event by transitioning the fueling system 112 from an inactive state to an active state (see indicium 8). For example, the fuel exchange system 103 may transition a fueling system 112 from an inactive state to an active state such that fuel may be dispensed from the fueling system 112. In another example, the fuel exchange system 103, or an operator thereof, may allow a user entity to obtain a fuel container from a storage receptacle or reserve an amount of fuel for immediate or future retrieval by the user entity. In some embodiments, the fuel exchange system 103 transmits a fueling start signal to the fueling system 112, which causes the fueling system 112 to transition from an inactive state to an active state in which fuel may be obtained by a user entity. In some embodiments, the fuel exchange system 103 provides additional data to the fueling system 112 including a fuel type, a maximum fuel volume, and/or a maximum fuel exchange amount (e.g., which may be based on a preauthorization limit and/or the like).

In some embodiments, the activation of the fueling system 112 enables the fueling system 112 to access fuel from a fuel reservoir. For example, the transition to the active state may cause opening of a valve such that fuel may be dispensed from the fueling system 112. In some embodiments, the activation of the fueling system 112 causes the fueling system 112 to initiate a fuel volume counter, fuel discharge rate monitor, or other device or software program that measures a volume of fuel provided by the fueling system 112.

In some embodiments, the fueling system 112 generates and provides to the fuel exchange system 103 fuel event data 411, such as a product identifier for a fuel type (e.g., and potentially other products), a current fuel volume, a total fuel volume, a fueling start timestamp and/or fueling end timestamp, and/or the like (see indicium 9). In some embodiments, the fueling system 112 generates a start timestamp indicative of a start time of receiving the fuel start code or dispensing of fuel from the fuel system. In some embodiments, the fueling system 112 determines that a fuel event has ended and, in response, generates the fuel event data 411. For example, the fueling system 112 determines that a fueling system handle has been reinserted into a fueling system for a predetermined time period and, in response, determines that fueling has ended. In some embodiments, the fueling system 112 automatically transitions to the inactive state (e.g., to end dispensing of fuel) in response to determining that one or more limits are satisfied. For example, the fueling system 112 transitions to the inactive state in response to determining that particular volume of fuel has been provided to a user entity, that a value of fuel provided to the user entity meets a threshold fuel exchange amount, or that a container for receiving fuel has reached a maximum fill level. In some embodiments, the fueling system 112 terminates fueling in response to receiving a fuel end code or other signal from the fuel exchange system 103.

In some embodiments, in response to termination of fueling, the fueling system 112 identifies a fuel volume (e.g., a total fuel volume for the amount of fuel provided to the user entity) and/or a fuel exchange amount based on the fuel volume and a fuel exchange ratio. In some embodiments, the fuel exchange system 103 performs functions for monitoring a fuel event and generating the fuel event data 411 or a portion thereof. In some embodiments, the fuel exchange system 103 updates the original-formatted fuel exchange authorization data object 407 based on the fuel event data 411. In some embodiments, a fuel exchange payload is generated based on the fuel event data and/or updated fuel exchange authorization data object 407.

In some embodiments, the fuel exchange system 103 generates and provides to the remote server 200 a fuel exchange payload 413 (see indicium 10). The fuel exchange system 103 may provide the fuel exchange payload 413 to the remote server using the API described above or another network interface. The fuel exchange payload 413 may indicate or include a fuel exchange amount. In some embodiments, the fuel exchange system 103 generates the fuel exchange amount based on the fuel event data 411, such as a total fuel volume, and a fuel exchange ratio. The fuel exchange ratio may be an unmodified fuel exchange ratio, or a fuel exchange ratio modified by a discount, which may be received by the fuel exchange system 103 from the remote server 200 using the API.

In some embodiments, the fuel exchange payload 413 includes a fuel volume provided to a user entity. For example, the fuel exchange payload 413 may include a number of gallons of fuel dispensed by the fueling system 112 during the fuel event. In some embodiments, the fuel exchange payload 413 includes a timestamp corresponding to activation of the fueling system 112 and/or a timestamp corresponding to completion of fueling via the fueling system 112. For example, the fuel exchange payload 413 may include a timestamp at which a fueling system was activated in response to a user entity's manipulation of a fueling system handle and/or selection of a fuel type via a GUI 403 or other input device at the fueling system. The fuel exchange payload 413 may include a timestamp at which the fueling system handle was reinserted into the fueling system. In another example, the fuel exchange payload 413 includes a timestamp at which the fuel exchange system 103 provided a fueling start code to a fueling system 112 and/or a timestamp at which the fuel exchange system 103 provided a fueling end code to the fueling system 112. In some embodiments, the fuel exchange payload 413 includes an identifier for the fueling system 112. For example, the fuel exchange payload 413 may include a fueling system number and/or the like.

In some embodiments, the fuel exchange payload 413 includes data defining a location at which the user input 405 was received and/or a fueling system 112 associated with the fuel exchange is located. For example, the fuel exchange payload 413 may include a physical address of a fueling station. In some embodiments, the fuel exchange payload 413 includes a fuel exchange amount, which may be generated based on a fuel volume and a fuel exchange ratio. In one example, the fuel exchange ratio may be a fuel price that does not include a discount (e.g., which may be later applied by the remote server 200 as described herein), such as a current advertised fuel price. In some embodiments, the fuel exchange payload 413 indicates whether the fuel exchange is authorized or in-process. For example, the fuel exchange payload 413 may indicate that a fuel exchange has not been approved by a payment instrument administrator. In another example, the fuel exchange payload 413 may indicate that the fuel exchange is preauthorized and may include a preauthorization limit. In some embodiments, the fuel exchange payload 413 includes one or more product identifiers, such as a stock keeping unit (SKU), part number, product number, universal product code (UPC), standard case code (SCC) and/or the like.

In some embodiments, the fuel exchange system 103 generates the fuel exchange payload 413 via existing (e.g., native or manufacturer-installed) point of sale software that outputs the fuel exchange payload 413 in a data format usable by the fuel exchange system 103 according to existing software. For example, the fuel exchange system 103 may generate the fuel exchange payload 413 in a format that corresponds to a format for fuel exchange initiated in response to receipt of traditional payment instrument data. In some embodiments, the fuel exchange system 103 stores the fuel exchange payload 413 in memory such that the fuel exchange payload 413 is accessible by other software programs. For example, the fuel exchange system 103 may store the fuel exchange payload 413 in a tabular format, a graphical database format, and/or the like, such that the fuel exchange payload 413 may be accessed by a script that recognizes the fuel exchange payload 413 and/or fuel code 406 indicated by the fuel exchange payload 413.

fuel code 406 In some embodiments, the fuel exchange system 103 temporarily stores the fuel exchange payload 413 for a period sufficient to provide the fuel exchange payload 413 to the remote server 200. In some embodiments, following the period and/or providing of the fuel exchange payload 413 to the remote server 200, the fuel exchange system 103 deletes the fuel exchange payload 413 from memory.

In some embodiments, the remote server 200 processes an exchange of value for the fuel exchange using the fuel exchange payload 413 and data associated with a user entity's instrument of exchange (e.g., credit card, debit card, banking account, cryptographic asset wallet, etc.), which may be stored at the data store 102 in a user account and retrieved in response to the validation data object 409. The user account of the user entity may be associated with the fuel code 406 and/or fuel code record 408 such that the user entity's stored payment instrument data may be identified and retrieved based on the fuel code 406. The remote server 200 may communicate with an administrator or issuer of the instrument of exchange (e.g., a third party entity, such as a financial institution) to process an exchange of value in an amount corresponding to the fuel exchange amount (e.g., potentially including additional amounts such as a surcharge amount and/or service amount for the operator of the remote server 200.

In some embodiments, the remote server 200 generates an updated fuel exchange payload based on the fuel exchange payload 413. For example, the remote server 200 generates an updated fuel exchange amount based on an undiscounted fuel exchange amount indicated in the fuel exchange payload 413 and a discounted fuel exchange ratio generated by the remote server 200 when the fuel code record 408 was generated (e.g., the discounted fuel exchange ratio being stored in association with the fuel code record 408). In another example, the remote server 200 generates an updated fuel exchange amount based on an undiscounted fuel exchange ratio determined and stored at the time of generation of the fuel code record 408.

In some embodiments, the remote server 200 generates the updated fuel exchange amount based on a retail price of the fuel, which may be indicated by the fuel exchange payload 413 and/or determined and stored at the time of generation of the fuel code record 408. For example, the remote server 200 may determine an undiscounted retail price (e.g., fuel exchange ratio) of the fuel to be $5.00 per unit volume of fuel. The remote server 200 may apply a predetermined discount value to the undiscounted retail price to generate a discounted fuel exchange ratio of $4.50 per unit volume of fuel. The remote server 200 may generate a fuel exchange amount based on the discounted fuel exchange ratio and a fuel volume indicated in the fuel exchange payload 413.

In some embodiments, the remote server 200 generates the updated fuel exchange amount based on a wholesale exchange amount or ratio of the fuel, which may be indicated by the fuel exchange payload 413 and/or determined and stored at the time of generation of the fuel code record 408. For example, the remote server 200 may determine a wholesale price (e.g., fuel exchange ratio) of the fuel to be $2.50 per unit volume of fuel. The remote server 200 may apply a predetermined scaling value to the wholesale price to generate a scaled fuel exchange ratio of $3.00 per unit volume of fuel. The remote server 200 may generate a fuel exchange amount based on the scaled fuel exchange ratio and a fuel volume indicated in the fuel exchange payload 413. In some embodiments, the remote server 200 further modifies the fuel exchange amount to include a service fee.

In some embodiments, to request approval of the fuel exchange amount, the remote server 200 generates and transmits a transaction processing request to a transaction processing server. In some embodiments, the transaction processing request includes the fuel exchange amount and authorization data for the user entity's instrument of exchange, such as a credit card number, expiration date, card verification value, and/or the like, and additional information from the fuel exchange payload 413 and/or fuel exchange authorization data object 407 described herein. In some embodiments, the remote server 200 provides the fuel exchange payload 413 to the transaction processing server using the one or more APIs 140. In some embodiments, the remote server 200 receives an outcome of the fuel exchange from the transaction processing server via a network 150 and using one or more APIs 140. The transaction processing entity may communicate with a financial institution, such as a bank, or other administrator of a user entity's instrument of exchange to obtain authorization for and process an exchange of value for the fuel exchange amount.

In some embodiments, the remote server 200 generates and provides to the fuel exchange system 103 and/or user computing entity 111 a fuel exchange outcome 414 (see indicia 11-13). The remote server 200 may provide the fuel exchange outcome 414 to the fuel exchange system 103 using the API as described above, or another network interface. The fuel exchange outcome 414 may indicate whether the exchange of value in the fuel exchange amount was approved, partially approved, or denied. In some embodiments, if partially approved or denied, the fuel exchange outcome 414 may indicate one or more reasons, such as insufficient funds, preauthorization limit, suspected fraud, and/or the like.

In some embodiments, the fueling system 112 receives the fuel exchange outcome 414 from the fuel exchange system 103 (see indicium 14). In some embodiments, the fueling system 112 updates the GUI 403 based on the fuel exchange outcome 414, such as to indicate the fuel exchange outcome 414 (e.g., full approval, partial approval, denial, and/or the like). In some embodiments, the updated GUI 403 includes the undiscounted or discounted fuel exchange ratio or fuel exchange amount. In some embodiments, the updated GUI 403 includes the fuel volume.

In some embodiments, the fueling system 112 generates a fuel exchange report based on the fuel exchange outcome 414 and/or fuel event data 411 (see indicium 15). In other embodiments, the fuel exchange system 103 generates data identifying the fuel exchange report, and the fueling system 112 receives the fuel exchange report from the fuel exchange system 103. In some embodiments, the fuel exchange report includes data identifying the fuel exchange amount (e.g., discounted and/or undiscounted), a fuel volume, a fueling start time, a fueling end time, one or more product identifiers (e.g., for fuel type and potentially other products), an identifier for a fuel entity, an identifier for a fueling location associated with the fuel entity, an identifier for the fueling system 112 (e.g., a pump number, charging station number, and/or the like), a fuel exchange ratio (e.g., discounted or undiscounted), and/or the like. In some embodiments, the fueling system 112, or the fuel exchange system 103, provides the fuel exchange report to the user entity and/or user computing entity 111. For example, the fueling system 112 provides the fuel exchange report to the user entity by printing the fuel exchange report using a printing device of the fueling system 112. In another example, the fueling system 112 wirelessly transmits the fuel exchange report to the user computing entity 111 (e.g., or permits the user computing entity 111 to read the fuel exchange report from the fueling system 112). In another example, the fueling system 112 receives, from the fuel exchange system 103, a network address at which the fuel exchange report may be viewed or accessed. The fueling system 112 may generate (or receive) and update the GUI 403 to display scannable media for accessing the network address via the user computing entity 111.

In some embodiments, the fuel exchange outcome 414 causes the fuel exchange system 103 to activate a fueling system 112, such as in instances where the fuel exchange payload 413 is generated and processed prior to a fuel event. For example, the remote server 200 remotely activates a fueling system 112 by transmitting the fuel exchange outcome 414 to the fuel exchange system 103 using an API 140. As described above, the present techniques for fuel exchange authorization and optimization may utilize a fuel exchange system 103 as a tool or interface for remotely initiating fuel events at a fueling system 112 on behalf of a user entity and in a manner such that the user entity may experience reduced fueling times (e.g., improving efficiency of completing a fuel event) and/or recognize a reduced cost of obtaining fuel. Upon activation, the fueling system 112 transitions to an active state, allowing the user to dispense fuel using a handle having an integrated valve to allowing the handle to dispense fuel.

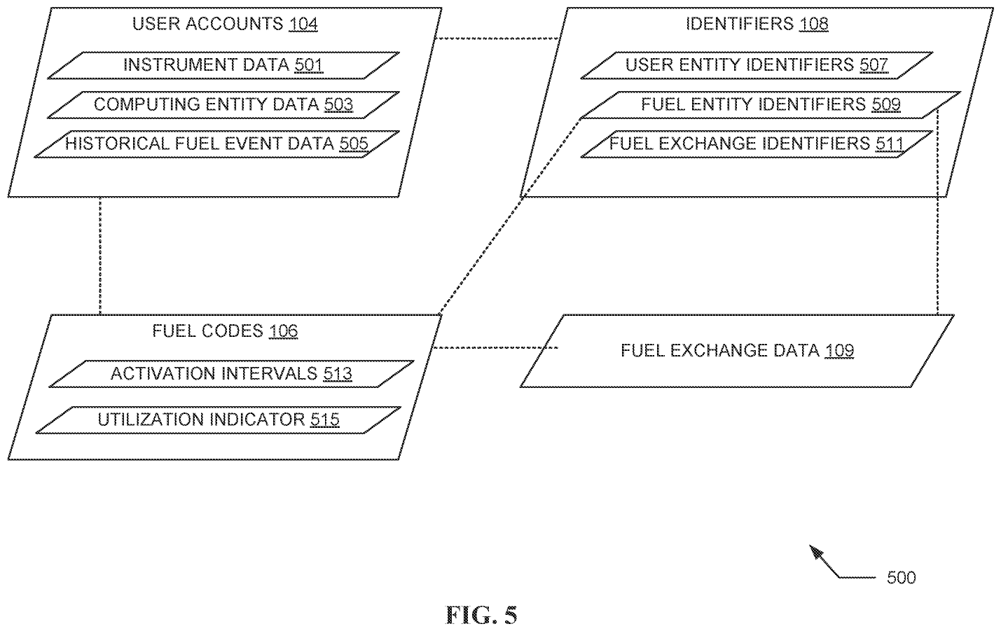

FIG. 5 provides an example data architecture according to certain embodiments. In some embodiments, the user account 104 includes instrument data 501 that identifies a user entity's instrument of exchange and data necessary for processing exchanges of value using the instrument of exchange. In some embodiments, the instrument data 501 includes an instrument identifier (e.g., card number, account number, wallet address, and/or the like), an instrument expiration date, a billing address, a user entity's legal name, an instrument verification (e.g., card verification value and/or the like), a preauthorization limit, a maximum fuel volume, and/or the like. In some embodiments, the user account 104 includes computing entity data 503 that identifies and/or enables communication with a user entity's user computing entity 111. In some embodiments, the computing entity data 503 includes a phone number, internet protocol (IP) address, media access control (MAC) address, international mobile equipment identifier (IMEI) number, and/or the like. In some embodiments, the user account 104 includes historical fuel event data 505 that defines historical fuel events and fuel exchanges associated with the user entity. In some embodiments, the historical fuel event data 505 includes historical fuel exchange amounts, historical fuel volumes, historical fuel locations, historical product codes, historical discounts or savings amounts generated by the computing environment 101 or application 122 based thereon, and/or the like. In some embodiments, the user account 104 includes associations between the user account 104 and one or more fuel codes 106. In some embodiments, the user account 104 includes associations between the user account 104 and one or more identifiers 108, such as a user entity identifier 507, one or more fuel entity identifiers 509, and/or one or more fuel exchange identifiers 511.

In some embodiments, the fuel codes 106 include active fuel codes that have not been utilized in a fuel exchange. In some embodiments, the fuel codes 106 include inactive fuel codes that have been previously utilized in a fuel exchange or are no longer able to be used based on expiration of an activation interval and/or other validation policy. In some embodiments, the fuel codes 106 include one or more activation intervals 513 that define a predetermined time interval within which a fuel code 106 may be used in a fuel exchange and after which a fuel code 106 may be rendered unusable for use in a fuel exchange. In some embodiments, the fuel codes 106 include utilization indicators 515 that indicate whether a fuel code 106 has been used in a fuel exchange and/or rendered unusable for use in a fuel exchange based on previous usage or a validation policy, such as expiration of an activation interval 513. In some embodiments, the fuel codes 106 include associations between one or more fuel codes 106 and a user account 104, a fuel entity identifier 509, a fueling location 517, a user entity identifier 507, and/or the like.

In some embodiments, the identifiers 108 include user entity identifiers 507 that indicate a particular user entity and/or user computing entity 111. In some embodiments, the identifiers 108 include fuel entity identifiers 509 that indicate a particular fuel entity, such as a fueling station or operator thereof. In some embodiments, the identifiers 108 include fuel exchange identifiers 511 that identify a current or historical fuel exchange (e.g., including data associated therewith, such as fuel event data, fuel exchange authorization data objects, fuel exchange payloads, fuel exchange outcomes, and/or the like). In some embodiments, the fuel exchange data 109 includes any data related to a current or historical fuel exchange. For example, the fuel exchange data 109 may include fuel event data, limits for a fuel exchange (e.g., volume limit, value limit, time limit, and/or the like), fuel exchange amounts, unmodified fuel exchange ratios (e.g., retail fuel exchange ratio, wholesale fuel exchange ratio, etc.,), modified fuel exchange ratios, fuel volumes, fueling start times, fueling end times, fueling system identifiers, fueling location identifiers, associations between fuel exchange data and a fuel code 106, user account 104, and/or one or more identifiers 108, and/or the like.

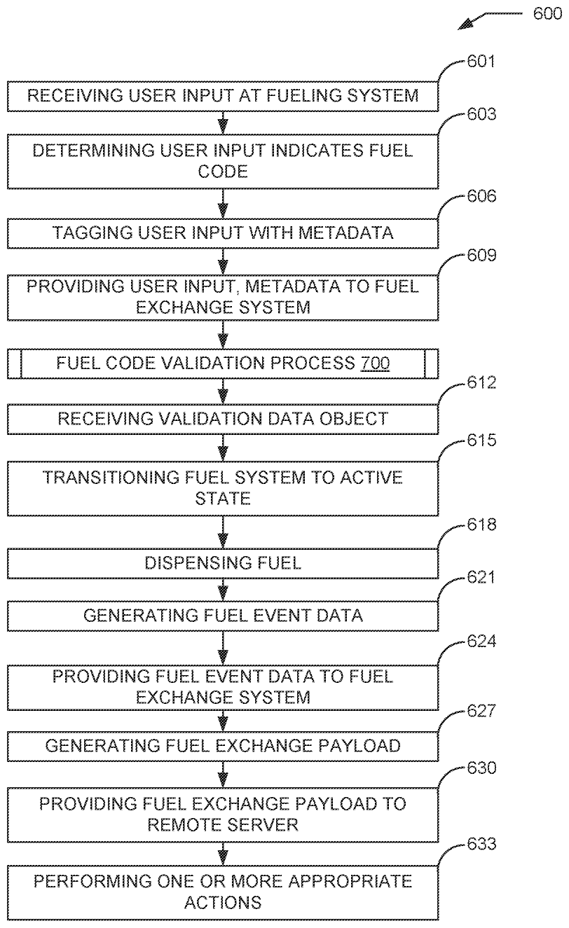

FIG. 6 provides an example flowchart of an example process 600 for authorizing a fuel exchange according to certain embodiments.

In some embodiments, prior to step/operation 601, the process 600 includes receiving a request to generate a fuel code from a user computing entity and, in response to the request, generating the fuel code, storing the fuel code, and providing the fuel code to the user computing entity. For example, the remote server 200 may receive from a user computing entity 111 a request to generate a fuel code 106. The remote server 200 may authenticate the request based on determining whether the user computing entity 111 is associated with a user account 104. In some embodiments, prior to receiving the request, the remote server 200 performs a registration process to enroll a user entity, the user entity's user computing entity 111, and the user entity's instrument of exchange, which may include generating a user account 104 and storing data indicative of the instrument of exchange in association with the user account 104. In some embodiments, in response to the request, the remote server 200 generates a fuel code 106. In some embodiments, the request indicates one or more products for a fuel exchange, such as via a product name, product code, and/or the like. Non-limiting examples of the products include fuel additives, fuel types, vehicle parts, vehicle fluids (e.g., brake fluid, transmission fluid, anti-freeze), maintenance services, and/or the like. The remote server 200 may store the indicated products in association with the fuel code 106 generated in response to the request. In various embodiment, the fuel code 106 may be used to initiate exchanges of value for multiple products, even in instances where a fuel exchange system does not differentiate between products when processing and transmitting fuel exchange-related data.

The remote server 200 may store the fuel code 106 at the data store 102 in association with an identifier for the user computing entity 111, an identifier for the user account 104, and/or an identifier associated with a fuel entity, which may be indicated in the request to generate to generate the fuel code. The remote server 200 may provide the fuel code to the user computing entity 111 via a network 150.

At step/operation 601, the process 600 includes receiving a user input at a fueling system, the user input being indicative of the fuel code. In some embodiments, receiving the user input includes receiving a user input to a graphical user interface (GUI) generated by and rendered on a display of a fueling system. For example, the fueling system 112 may include a GUI including a user input field traditionally configured for receiving payment instrument or other credential data and modified, as described herein, to receive a user input indicative of a fuel code. In some embodiments, the fueling system receives an input indicative of a fuel code via wireless communication with a user computing entity. For example, a fueling system 112 may include a scanning device, such as a near field communication circuitry, Bluetooth antennae, and/or the like, configured to wirelessly communicate with a user computing entity 111 (e.g., or application 122 associated therewith) to obtain a fuel code 106. In a particular example, the user computing entity 111 may be a mobile telecommunication device and the fueling system 112 may be configured to receive a wireless transmission including a fuel code 106 from the mobile telecommunication device. In another example, the user computing entity 111 may include a programmable radio frequency identification (RFID) circuit to which a fuel code 106 by the application 122. An input device 113 of the fueling system 112 may include an RFID reader circuit configured to detect and read the fuel code 106 from the RFID circuit.

Alternatively, or additionally, in some embodiments, the fueling system receives an input indicative of a fuel code by generating and processing a capture of scannable media (e.g., a linear bar code, QR code, or other matrix code, and/or the like) to extract or generate the fuel code. In one example, an application 122 on a user computing entity 111 may generate and render on the display 118 a QR code that encodes a fuel code 106. An input device 113 of the fueling system 112 may include an image capture device or other scanning device that generates a capture of the QR code. The fueling system 112, or fuel exchange system 103, may process the capture of the QR code to extract or generate the fuel code 106. In another example, an application 122 may generate and render on the display 118 a QR code that includes a network address at which a fuel code 106 may be accessed or retrieved. The fueling system 112 may extract or generate the network address based on a capture of the QR code and obtain the fuel code 106 by accessing the network address and/or providing a request to the network address. Alternatively, the fueling system 112 may provide the network address to the fuel exchange system 103, which may obtain the fuel code 106 by accessing the network address and/or providing a request to the network address.

Alternatively, or additionally, in some embodiments, the fueling system receives an input indicative of a fuel code by receiving and processing a vocal input. For example, an input device 113 of the fueling system 112 may include a microphone configured to capture utterance of a fuel code 106. The fueling system 112 may include, or communicate with a computing system that includes, a natural language processing service that processes the utterance to obtain the fuel code 106. Alternatively, the fueling system 112 may provide the utterance to the fuel exchange system 103 for processing (e.g., or for further relay to the remote server 200, which may perform the processing or communicate with an additional external system to process the utterance).

At step/operation 603, the process 600 includes determining the user input indicates or includes the fuel code. For example, the fueling system 112 may determine that the user input includes a fuel code. In some embodiments, the fueling system 112 determines that the user input was provided to a particular input field of a GUI on the fueling system 112, the particular input field being specially configured for receiving user inputs for fuel codes. For example, a GUI may include a plurality of user input fields (e.g., for traditional payment data, requesting assistance, providing user inputs indicative of fuel codes, and/or the like). In response to receiving the user input at one of the plurality of user input fields associated with fuel codes, the fueling system 112 determines that the user input includes a fuel code. In some embodiments, to determine that the user input includes a fuel code, the fueling system 112 determines that the user input includes a particular character length (e.g., 4, 6, 7, 8 or any other suitable character lengths). In some embodiments, to determine that the user input includes a fuel code, the fueling system 112 determines that the user input includes a particular pattern of characters (e.g., numeric only, only alphanumeric, first digit numeric, second digit alphabetic, etc.,). Such operations/functions may be performed by the fueling system 112 based on one or more storage instructions 116. In a particular example, based on a storage instruction 116, the fueling system 112 may determine whether the data received from the fueling system includes a particular partition or sequence of characters that embodies a fuel code. In some embodiments, the fueling system 112 determines that the data received from the fueling system is not indicative of a fuel code and, in response, the process 600 may be suspended and/or a notification of unrecognizable user input may be rendered on a display of the fueling system 112.

In some embodiments, the fueling system 112 renders a specially configured GUI for receiving user inputs including fuel codes in response to receiving a user input to a user device on the fueling system 112. For example, in response to receiving a user input to an input device, the fueling system 112 generates and renders a GUI including an instruction for the user entity to provide the fuel code via a user input (e.g., “Enter Alternate ID,” and/or the like).

In some embodiments, in response to determining the user input includes the fuel code, the fueling system 112 proceeds with, at step 609, providing the fuel code to the fuel exchange system 103 for validation of the fuel code and, thereby, approval to initiate dispensing of fuel to the user entity. Whereas traditional approaches to initiating dispensing of fuel at a fueling system require input of payment details (e.g., insertion of a credit card, depositing of currency, and/or the like), the fueling system 112 may provide the user input to the fuel exchange system 103 without receiving or requiring any payment instrument information in response to determining the user input includes a fuel code. Thus, the fueling system 112 may be specially configured to deviate from conventional computing processes for dispensing fuel such that the fueling system 112 may bypass historical workflows for obtaining payment information and, instead, receive and relay a single-use, redeemable, revocable token (e.g., fuel code) to initiate fuel events. The present techniques for providing and modifying specialized computing equipment and workflows to initiate fuel dispensing may improve efficiency of fuel events and mitigate risks of exposing sensitive payment instrument information to fueling systems, fueling stations, and operators thereof.

In some embodiments, in response to determining the user input includes the fuel code, the fueling system 112 disables information entry at the fueling system 112 to prevent the user entity from providing alternative payment instrument information to the fueling system 112 (e.g., credit card data, debit card data, digital wallet data, and/or the like). For example, in response to determining the user input includes the fuel code, the fueling system 112 may disable a locking mechanism of a card reader configured to receive, lock within, and read a payment card. In another example, the fueling system 112 may disable a keypad, button, or other input device. In another example, the fueling system 112 may execute a script or other software protocol such that the fueling system 112 ignores any further user input (e.g., potentially with exception, such as a user input to cancel the fuel exchange, request assistance, etc.,).

At step/operation 606, the process 600 includes tagging the user input with metadata that identifies the user input as including a fuel code. For example, the fueling system 112 may generate metadata and tag the user input with the metadata such that a fuel exchange system 103 may recognize the user input as a fuel code upon receiving and processing the user input and the metadata. In some embodiments, generating the metadata includes generating a metadata file or other data object to be provided to the fuel exchange system in combination with or following providing of the user input to the fuel exchange system. For example, in response to determining the user input includes the fuel code, the fueling system 112 generates a metadata file including a flag, instruction, or other indication that the user input includes or embodies the fuel code. In some embodiments, the metadata, when provided to the fuel exchange system, causes the fuel exchange system 103 to perform a modified workflow for initiating fuel dispensing such that the fuel exchange system bypasses or ignore traditional workflow requirements for intaking payment instrument information. For example, instead of requiring the user entity to insert a credit card into a reader on the fueling system 112, the modified workflow may cause the fueling system 112 and fuel exchange system 103 to initiate and control fuel dispensing and fuel exchanges solely based on the fuel code (e.g., and data associated therewith at the remote computing environment 101).

At step/operation 609, the process 600 includes providing the user input and the metadata to the fuel exchange system 103. For example, the fueling system 112 may provide the user input and the metadata identifying the user input as a fuel code to the fuel exchange system 103 via a local network connection. In some embodiments, the process 600 includes processing the user input based on a storage instruction to determine whether the user input indicates a fuel code, such as by identifying a metadata tag for the fuel code. For example, based on a storage instruction 116, the fuel exchange system 103 may determine whether a transmission of user input includes metadata of a predetermined format associated with fuel codes (e.g., a flag, numeric or alphanumeric sequence, and/or the like). In other embodiments, the fueling system 112 may, together with the fuel exchange system 103, communicate the user input to the remote computing environment to determine whether the input is a fuel code. This communication may occur separately from communications from the fuel exchange system to determine whether the fuel code remains valid.

In response to receiving the user input and the metadata, the fuel exchange system 103 may generate and provide to the remote server 200 a fuel exchange authorization data object requesting validation of the fuel code indicated by the user input. For example, the fuel exchange system 103 may generate the fuel exchange authorization data object based on the user input such that the fuel exchange authorization data object indicates a fuel code 106. In some embodiments, the fuel exchange authorization data object includes metadata including, but not limited to, a receipt timestamp of the user input, an entity identifier corresponding to a fuel entity associated with the fuel exchange system, and/or a location of the fuel exchange system, fueling system, and/or user computing entity. In one example, the fuel exchange system 103 may determine, or receive from the user computing entity 111, geolocation data indicative of a current location of the user computing entity 111. The fuel exchange system 103 may generate a fuel exchange authorization data object including or indicative of the fuel code 106 and the geolocation data. In another example, the fuel exchange system 103 may retrieve from memory 114 an identifier 108 associated with a fuel entity that operates or owns the fuel exchange system 103. The fuel exchange system 103 may generate a fuel exchange authorization object including or indicative of the fuel code 106 and the identifier 108. In another example, the fuel exchange authorization data object may include or indicate an identifier 108 associated with a product type, such as a fuel type. In still another example, the fuel exchange authorization data object may include or indicate an identifier 108 for the fueling system 112, such as a fuel pump number.

In some embodiments, the fuel exchange authorization data object includes a fuel volume provided to a user entity. For example, the fuel exchange authorization data object may include a number of gallons of fuel dispensed by a fueling system. In some embodiments, the fuel exchange authorization data object includes a timestamp corresponding to activation of a fueling system and/or a timestamp corresponding to completion of fueling via the fueling system. For example, the fuel exchange authorization data object may include a timestamp at which a fueling system was activated in response to a user entity's manipulation of a fueling system handle and/or selection of a fuel type via a graphical user interface at the fueling system. The fuel exchange authorization data object may include a timestamp at which the fueling system handle was reinserted into the fueling system. In another example, the fuel exchange authorization data object includes a timestamp at which the fuel exchange system 103 provided a fueling start code to a fueling system and/or a timestamp at which the fuel exchange system 103 provided a fueling end code to the fueling system. In some embodiments, the fuel exchange authorization data object includes an identifier for the fueling system. For example, the fuel exchange authorization data object may include a fuel pump number and/or the like.

In some embodiments, the fuel exchange authorization data object includes data defining a location at which the user input was received and/or a fueling system associated with the fuel exchange is located. For example, the fuel exchange authorization data object may include a physical address of a fueling station. In some embodiments, the fuel exchange authorization data object includes a fuel exchange amount, which may be generated based on a fuel volume and a fuel exchange ratio. In one example, the fuel exchange ratio may be a fuel price that does not include a discount (e.g., which may be later applied by the remote server 200 as described herein), such as a current advertised fuel price. In some embodiments, the fuel exchange authorization data object indicates whether the fuel exchange is authorized or in-process. For example, the fuel exchange authorization data object may indicate that a fuel exchange has not been approved by a payment instrument administrator. In another example, the fuel exchange authorization data object may indicate that the fuel exchange is preauthorized and may include a preauthorization limit. In some embodiments, the fuel exchange authorization data object includes one or more product identifiers, such as a stock keeping unit (SKU), part number, product number, universal product code (UPC), standard case code (SCC) and/or the like. In one example, the fuel exchange authorization data object includes an identifier for a type of fuel provided (or requested to be provided) for the fuel exchange, a first SKU for a fuel additive product, and a third SKU for an anti-freeze product.

In some embodiments, the fuel exchange system 103 generates the fuel exchange authorization data object via existing (e.g., native or manufacturer-installed) point of sale software that outputs the fuel exchange authorization data object in a data format usable by the fuel exchange system 103 according to existing software. For example, the fuel exchange system 103 may generate the fuel exchange authorization data object in a format that corresponds to a format for fuel exchange initiated in response to receipt of traditional payment instrument data. In some embodiments, the fuel exchange system 103 stores the fuel exchange authorization data object in memory such that the fuel exchange authorization data object is accessible by other software programs. For example, the fuel exchange system 103 may store the fuel exchange authorization data object in a tabular format, a graphical database format, and/or the like, such that the fuel exchange authorization data object may be accessed by a script that recognizes the fuel exchange authorization data object and/or fuel code 106 indicated by the fuel exchange authorization data object.

In some embodiments, the script automatically retrieves the fuel exchange authorization data object and reformats the fuel exchange authorization data object into a data format such that the reformatted fuel exchange authorization data object may be accessed by or provided to the remote server. In some embodiments, the script reformats the fuel exchange authorization data object by concatenating one or more characters, truncating one or more characters, replacing one or more characters of, and/or adding one or more characters to, the fuel exchange authorization data object. In some embodiments, the script reformats all fuel transaction authorization data objects in an identical manner. In alternate embodiments, the script reformats each fuel transaction authorization data object in a manner unique to each fuel code. In some embodiments, the script generates a format by which to reformat the fuel exchange authorization data object based on the user input indicative of the fuel code.

In some embodiments, the fuel exchange system temporarily stores the fuel exchange authorization data object for a period sufficient to allow the script to reformat the fuel exchange authorization data object and provide the fuel exchange authorization data object to the remote server. In some embodiments, following the period and/or providing of the fuel exchange authorization data object to the remote server, the fuel exchange system deletes the format-modified fuel exchange authorization data object from memory such that the modified data does not interfere with existing operations of the original software (e.g., native point of sale software) running on the fuel exchange system. In one example, temporary storage and subsequent deletion of the differently formatted fuel exchange authorization data object may prevent interference with native point of sale software that requires transaction data to be stored in an original data format. In some embodiments, the fuel exchange system 103 retains, in memory, the fuel exchange authorization data object in an unmodified format.

In other embodiments, the fuel exchange system need not reformat the fuel exchange authorization data object prior to transmission to the remote computing environment.

In some embodiments, the fuel exchange system 103 provides the fuel exchange authorization data object to a remote server 200. For example, the fuel exchange system 103 may provide the fuel exchange authorization data object to a remote server 200 of the remote computing environment 101 using one or more networks 150, and one or more application programming interfaces (APIs) 140 configured to facilitate communication between the fuel exchange system 103 and the remote server 200. In some embodiments, the fuel exchange system 103 executes a script (e.g., according to a storage instruction 116) that reformats the fuel exchange authorization data object from a legacy point-of sale format (e.g., or other original format used by the fuel exchange system 103) to a secondary format that enables the remote server to recognize the fuel exchange authorization data object as including a fuel code.

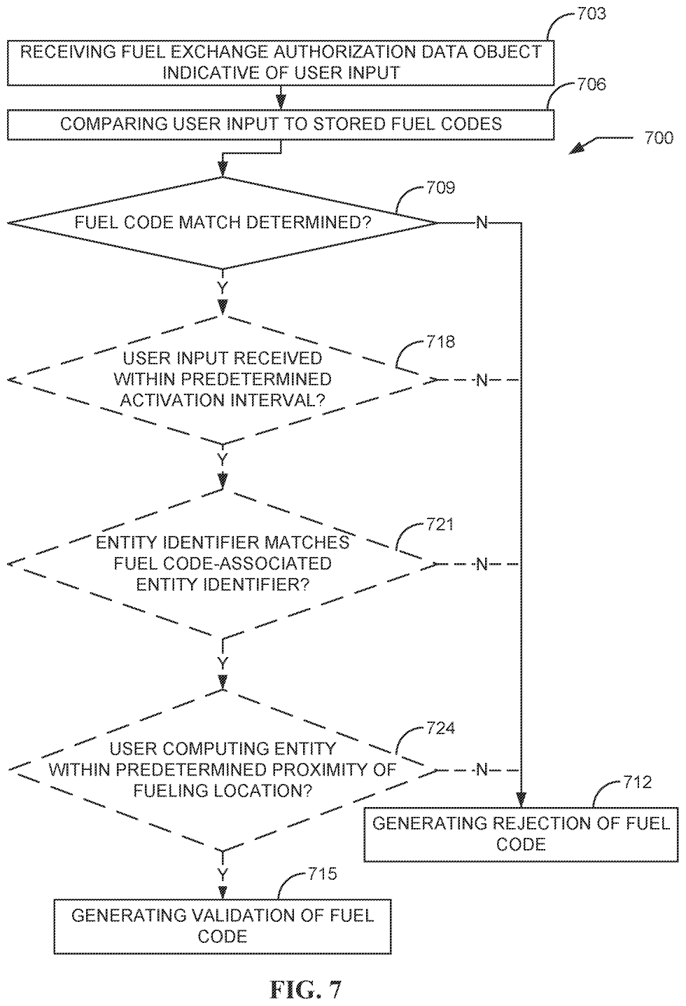

In various embodiments, in response to receiving the fuel exchange authorization data object, the remote server performs a fuel code validation process, such as the fuel code validation process 700 shown in FIG. 7 and described herein. In some embodiments, the fuel code indicated by the fuel exchange authorization data object is compared to a stored fuel code (e.g., to determine whether the fuel codes match). For example, the remote server 200 queries a plurality of stored fuel codes 106 based on the indicated fuel code to determine whether a matching fuel code 106 has been generated and stored by the remote computing environment 101. Additionally, in some embodiments, the fuel exchange authorization data object includes a receipt timestamp of the user input and, to validate the indicated fuel code, the receipt timestamp is compared to a predetermined activation interval associated with the stored fuel code. Additionally, or alternatively, in some embodiments, the fuel exchange authorization data object includes an entity identifier and, to validate the indicated fuel code, the entity identifier is compared to an identifier of a fuel entity stored in association with the stored fuel code. Additionally, or alternatively, in some embodiments, geolocation data of the user computing entity associated with the stored fuel code is obtained and compared to a fueling location associated with the fuel entity to determine whether a location of the user computing entity is within a predetermined proximity of the fueling location.

At step/operation 612, the process 600 includes receiving a validation data object reflecting validation of the fuel code. For example, the fueling system 112 receives a validation data object from the fuel exchange system 103 (e.g., the fuel exchange system 103 having received the validation data object or data indicative thereof from the remote server 200. In some embodiments, the validation data object is received at the fuel exchange system 103 from the remote server 200 using an API 140. In some embodiments, the validation data object is relayed to the fueling system 112 via a local network connection between the fuel exchange system 103 and fueling system 112. For example, the remote server 200 may provide a transmission comprising the validation data object for the fuel code 106 to the fuel exchange system using a network 150 and an API 140. In some embodiments, additional data associated with the validated fuel code is provided from the remote computing environment to the fuel exchange system. For example, the remote server 200 may provide a transmission indicative of a fuel exchange ratio to the fuel exchange system 103. In still another example, the remote server 200 may provide a transmission indicative of one or more limits (e.g., maximum fuel volume, preauthorized fuel exchange amount, and/or the like) to the fuel exchange system 103. The fueling system 112 may also receive the additional data from the fuel exchange system 103.

Alternatively, in some embodiments, the process 600 includes receiving a rejection of the fuel code. The rejection of the fuel code may be received by the fuel exchange system 103 in similar manner to receipt of the validation data object reflecting validation of the fuel code described herein. For example, the remote server 200 may provide a transmission indicative of the rejection of the fuel code the fuel exchange system 103 using an API 140.

In one example, the remote server 200 may determine that the indicated fuel code cannot be validated based on a failure to identify a matching fuel code 106 at one or more data stores 102. In another example, the remote server 200 may determine that the indicated fuel code was received outside of a predetermined activation interval (e.g., the fuel code is expired). In another example, the remote server 200 may determine that an entity identifier received in association with the indicated fuel code fails to match an identifier 108 for a fuel entity associated with the stored fuel code 106 to which the indicated fuel code was matched. In another example, the remote server 200 may determine that geolocation data of a user computing entity 111 associated with the stored fuel code 106 is not within a predetermined proximity of a fueling location associated with the stored fuel code 106. In some embodiments, receiving the rejection of the fuel code include or indicate one or more reasons for the rejection. For example, the rejection of the fuel code may indicate that the indicated fuel code could not be matched to a stored fuel code (e.g., “code not found”). In another example, the rejection of the fuel code may indicate that the indicated fuel code was received outside of a predetermined activation (e.g., “code expired”). In another example, the rejection of the fuel code may indicate that the indicated fuel code was not provided to a fuel exchange system of an associated fuel entity (e.g., “entity not authorized”). In still another example, the rejection of the fuel code may indicate and/or that the user computing entity 111 is not located within a predetermined proximity of an associated fueling location. In some embodiments, the rejection of the fuel code may be presented to a user entity and/or provided to the user computing entity associated with the fuel code. For example, the fuel exchange system 103 may provide the rejection of the fuel code to the fueling system 112. In response to receiving the rejection of the fuel code, the fueling system may update a GUI on a display of the fueling system 112 to present the rejection of the fuel code to a user entity. In another example, the remote server 200 may provide a notification indicative of the rejection of the fuel code to a user computing entity 111 associated with the fuel code.

At step/operation 615, the process 600 includes transitioning a fueling system from an inactive state to an active state. For example, in response to receiving the validation data object reflecting validation of the fuel code, the fueling system 112 automatically transitions from an inactive state to an active state in which fuel may be dispensed from the fueling system 112, such as using a handle of the fueling system 112 through which fuel may be dispensed. In another example, in response to receiving the validation data object reflecting validation of the fuel code, the fueling system 112 may automatically transition a fueling system 112 from an inactive state to an active state in which a container of fuel may be retrieved from a storage receptacle. In some embodiments, in response to receiving the validation data object reflecting validation of the fuel code, the fuel exchange system 103 may automatically (e.g., in substantial real-time to receiving the validation) transition a fueling system 112 from the inactive state to the active state. In some embodiments, the validation data object reflecting validation of the fuel code indicates one or more limits, such as a particular fuel type, a preauthorized fuel exchange amount, and/or maximum fuel volume. In some embodiments, the fueling system 112 transitions from the inactive state to the active state according to the limit such that a fuel event may be suspended in response to the limit being satisfied (e.g., a user entity being provided a volume of fuel equal to the maximum fuel volume and/or having a fuel value equal to the preauthorized fuel exchange amount). In some embodiments, step/operation 618 may be performed prior to receiving the user input indicative of the fuel code. For example, a user entity may request activation of a fueling system 112 and the fueling system 112 may automatically transition from an inactive state to an active state to allow fueling. During or following the fuel event, the user entity may provide a user input indicative of a fuel code to a graphical user interface (GUI) on the fueling system 112, and the fueling system 112 may provide the user input to the fuel exchange system 103 (e.g., potentially followed by subsequent steps/operations of the process 600 and process 700 to validate the fuel code and execute a transaction for the user entity).

In some embodiments, in the active state, the fueling system 112 enables a pump mechanism to access fuel from a fuel reservoir. For example, the transition to the active state may cause the fueling system 112 to open a valve such that fuel may be dispensed from a handle of the fueling system 112. In some embodiments, in response to transitioning to the active state, the fueling system 112 updates a GUI on the fueling system 112 to instruct a user entity to provide a user input for a fuel type. In some embodiments, the fueling system 112 enables dispensing of fuel of a particular type based on a user input. For example, in response to receiving a user input selecting biodiesel, the fueling system 112 may configure a valve and/or enable a handle such that the handle may be used to dispense biodiesel while the fueling system 112 maintains another valve in a locked state such that standard diesel fuel may not be dispensed using the handle.

At step/operation 618, the process 600 includes dispensing fuel. For example, fuel is dispensed from the fueling system 112 using a handle of the fueling system. In another example, fuel is retrieved from a storage container of the fueling system 112. In another example, an electric current is directed through a handle of the fueling system such that the handle may be inserted into an electric vehicle to charge a battery of the electric vehicle. In some embodiments, the activation of the fueling system 112 causes the fueling system 112 to initiate a fuel volume counter, fuel discharge rate monitor, or other device or software program that measures a volume of fuel provided by the fueling system 112, a value of the fuel, or a time period in which the fuel is provided to the user entity. In some embodiments, the fueling system 112 generates a start timestamp indicative of a start time of receiving the fuel start code or dispensing of fuel from the fuel system. In some embodiments, the fueling system 112 determines that a fuel event has ended. For example, the fueling system 112 determines that a fueling system handle has been reinserted into a fueling system 112 for a predetermined time period and, in response, determines that fueling has ended. In some embodiments, the fueling system 112 automatically terminates fueling (e.g., by transitioning to the inactive state) in response to determining that one or more limits are satisfies, such as that a particular volume of fuel has been provided to a user entity, that a value of fuel provided to the user entity meets a threshold fuel exchange amount, or that a container for receiving fuel has reached a maximum fill level. In some embodiments, the fueling system 11 transitions to the inactive state in response to determining that fuel has been provided to the user entity for a predetermined period (e.g., 1 hour, 30 minutes, 2 hours, or any suitable period). In some embodiments, the fueling system terminates fueling in response to receiving a fuel end code or other signal from the fuel exchange system 103.

In some embodiments, at step/operation 621, the process 600 includes generating fuel event data. For example, the fueling system 112 may generate the fuel event data based at least in part on the dispensing of fuel at step/operation 618. For example, the fueling system 112 may generate fuel event data including a total fuel volume for the amount of fuel provided to the user entity, a fuel exchange amount (e.g., generated based on the total fuel volume and a fuel exchange ratio), a fuel start timestamp, a fuel end timestamp, a product identifier for a type of fuel provided by the fueling system 112 to a user entity, a rate at which the fueling system 112 dispensed the fuel to the user entity, and/or the like. In some embodiments, prior to the fuel exchange system receiving the fuel event data, the fueling system executes a script that reformats the fuel event data from a first format, such as a raw string format, to a second format, such as a tabular or graphical database format, which may be an original format utilized by the fuel exchange system to recognize and process fuel event data. In some embodiments, the fuel exchange system updates the original-formatted fuel exchange authorization data object based on the fuel event data. In some embodiments, following updating by the fuel exchange system, a script retrieves the fuel exchange authorization data object of step/operation 609 and updates the fuel exchange authorization data object to include or indicate the fuel event data, which may include further reformatting of the fuel event data and/or fuel exchange authorization data object. In some embodiments, the script causes the temporary storage and subsequent deletion of the reformatted fuel exchange authorization data object in memory after the fuel exchange system provides the reformatted fuel exchange authorization data object to the remote server (e.g., for recordation of the fuel event data and further processing of the fuel exchange).

In some embodiments, at step/operation 624, the process 600 includes providing the fuel event data to the fuel exchange system. For example, the fueling system 112 may provide the fuel event data to the fuel exchange system 103 using a local network connection. In some embodiments, the fuel event data includes, or is provided with, metadata indicating association of the fuel code of step/operation 606 with the fuel event data. For example, the fueling system 112 may tag metadata of the fuel event data with the fuel event code.

At step/operation 627, the process 600 includes generating a fuel exchange payload, which may be indicative of a fuel exchange amount, fuel volume, and/or additional fuel event data. For example, the fuel exchange system 103 generates the fuel exchange payload based on a fuel event, such as the dispensing of fuel from a fuel system 112 to a user entity or a retrieval of a container of fuel by the user entity from a storage receptacle. In some embodiments, the fuel exchange amount is generated based on a fuel exchange ratio and a fuel volume. In some embodiments, the fuel exchange system generates the fuel exchange payload via existing (e.g., native or manufacturer-installed) point of sale software that outputs the fuel exchange payload in a data format usable by the fuel exchange system according to existing software. For example, the fuel exchange system 103 may generate the fuel exchange payload in a format that corresponds to a format for fuel exchange initiated in response to receipt of traditional payment instrument data. In some embodiments, the fuel exchange system stores the fuel exchange payload in memory such that the fuel exchange payload is accessible by other software programs. For example, the fuel exchange system 103 may store the fuel exchange payload in a tabular format, a graphical database format, and/or the like, such that the fuel exchange payload may be accessed by a script that recognizes the fuel exchange payload and/or fuel code 106 indicated by the fuel exchange payload.

In some embodiments, in response to receiving the validation data object reflecting validation of the fuel code, a fuel exchange ratio (e.g., based upon which a fuel exchange amount is determined) is reduced from a first value, such as an advertised or consumer-directed fuel exchange ratio, to a second value. In one example, the fuel exchange system 103 may determine a fuel volume associated with a fuel event that was initiated in response to the validation of the indicated fuel code. The fuel exchange system 103 may generate a fuel exchange amount by multiplying the fuel volume by a fuel exchange ratio, where the fuel exchange ratio is different (e.g., less than) a fuel exchange ratio advertised at the corresponding fueling location. In other embodiments, the discounted fuel exchange amount is generated by the remote server 200.

In some embodiments, in addition to the fuel exchange amount, the fuel exchange payload includes metadata associated with the fuel event, the fueling location, and/or the associated fuel entity. For example, the fuel exchange payload may include a fuel event initiation and/or termination timestamp. In another example, the fuel exchange payload may include a type of fuel provide to a user entity. In another example, the fuel exchange payload may include an identifier for a fuel entity associated with the fuel exchange system 103.

In one example, the fuel exchange payload may include a number of gallons of fuel dispensed by the fueling system during the fuel event. The fuel exchange payload may also include a timestamp at which a fueling system was activated in response to a user entity's manipulation of a fueling system handle and/or selection of a fuel type via a graphical user interface at the fueling system. The fuel exchange payload may include a timestamp at which the fueling system handle was reinserted into the fueling system. In another example, the fuel exchange payload includes a timestamp at which the fuel exchange system 103 provided a fueling start code to a fueling system and/or a timestamp at which the fuel exchange system 103 provided a fueling end code to the fueling system. In some embodiments, the fuel exchange payload includes an identifier for the fueling system. For example, the fuel exchange payload may include a fueling system number and/or the like.

In some embodiments, the fuel exchange payload includes data defining a location at which the user input was received and/or a fueling system associated with the fuel exchange is located. For example, the fuel exchange payload may include a physical address of a fueling station. In some embodiments, the fuel exchange payload includes a fuel exchange amount, which may be generated based on a fuel volume and a fuel exchange ratio. In one example, the fuel exchange ratio may be a fuel price that does not include a discount (e.g., which may be later applied by the remote server as described herein), such as a current advertised fuel price. In some embodiments, the fuel exchange payload indicates whether the fuel exchange is authorized or in-process. For example, the fuel exchange payload may indicate that a fuel exchange has not been approved by a payment instrument administrator. In another example, the fuel exchange payload may indicate that the fuel exchange is preauthorized and may include a preauthorization limit. In some embodiments, the fuel exchange payload includes one or more product identifiers, such as a stock keeping unit (SKU), part number, product number, universal product code (UPC), standard case code (SCC) and/or the like. In alternate embodiments, the remote server (or remote computing environment associated with the remote server) stores one or more product identifiers in association with the fuel code such that the remote server may modify the fuel exchange payload to further indicate the one or more product identifiers (e.g., even in instances where the fuel exchange system lacks software and/or hardware functionality to indicate such product information in fuel exchange payloads). Thus, in addition to the remote computing environment using the fuel exchange system to remotely initiate fueling systems on behalf of a user entity, the remote server may overcome deficiencies of software and hardware of existing fuel exchange systems that may be incapable of providing product identification-enriched fuel exchange payload data to external computing systems.

At step/operation 630, the process 600 includes providing the fuel exchange payload to the remote server 200 to execute an exchange of value (e.g., transaction) for the fuel exchange on behalf of the user entity. For example, the fuel exchange system 103 provides the fuel exchange payload to the remote server 200 using an API 140. The remote server may generate and provide to a third-party processing service a transaction request including the fuel exchange payload.

At step/operation 633, the process 600 includes performing one or more appropriate actions to perform an exchange of value (e.g., execute and close a transaction), initiate and/or end fueling, provide an outcome of a fuel exchange to one or more computing elements, initiate a payment transaction from an entity associated with the remote server to the fuel entity based on the fuel exchange, provide a notification to a user computing entity or user entity, generate and provide a fuel exchange report, and/or the like. In some embodiments, in response to receiving the fuel exchange payload, an exchange of value is processed using a user entity's instrument of exchange. For example, the remote server 200 may process an exchange of value based on the fuel exchange payload and using an instrument of exchange associated with the user entity, user computing entity 111, and/or user account 104 corresponding to the validated fuel code. In some embodiments, processing the exchange of value includes forwarding the fuel exchange payload and data indicative of the instrument of exchange to a provider of the instrument of exchange. For example, the instrument of exchange may be a credit card. The remote server 200 may provide an exchange approval request to a credit card processing partner (or other exchange instrument administrating or issuing entity) that includes the fuel exchange amount and credit card info, such as a card number, card expiration date, card verification value, cardholder name, billing address, and/or the like. The credit card processing partner may process the exchange of value for the credit card in an amount corresponding to the fuel exchange amount.

In some embodiments, the remote server 200 generates an updated fuel exchange payload based on the fuel exchange payload and/or data stored in association with the fuel code 106, such as product identifiers. For example, the remote server 200 generates an updated fuel exchange amount based on an undiscounted fuel exchange amount indicated in the fuel exchange payload and a discounted fuel exchange ratio generated by the remote server 200 when the fuel code 106 was generated (e.g., the discounted fuel exchange ratio being stored in association with the fuel code 106). In another example, the remote server 200 generates an updated fuel exchange amount based on an undiscounted fuel exchange ratio determined and stored at the time of generation of the fuel code 106.

In some embodiments, the remote server 200 generates the updated fuel exchange amount based on a retail price of the fuel, which may be indicated by the fuel exchange payload and/or determined and stored at the time of generation of the fuel code 106. For example, the remote server 200 may determine an undiscounted retail price (e.g., fuel exchange ratio) of the fuel to be $5.00 per unit volume of fuel. The remote server 200 may apply a predetermined discount value to the undiscounted retail price to generate a discounted fuel exchange ratio of $4.50 per unit volume of fuel. The remote server 200 may generate a fuel exchange amount based on the discounted fuel exchange ratio and a fuel volume indicated in the transaction payload.

In some embodiments, the remote server 200 generates the updated fuel exchange amount based on a wholesale price of the fuel, which may be indicated by the fuel exchange payload and/or determined and stored at the time of generation of the fuel code 106. For example, the remote server 200 may determine a wholesale price (e.g., fuel exchange ratio) of the fuel to be $2.50 per unit volume of fuel. The remote server 200 may apply a predetermined scaling value to the wholesale price to generate a scaled fuel exchange ratio of $3.00 per unit volume of fuel. The remote server 200 may generate a fuel exchange amount based on the scaled fuel exchange ratio and a fuel volume indicated in the transaction payload. In some embodiments, the remote server 200 further modifies the fuel exchange amount to include a service fee.

In some embodiments, the remote server 200 generates a payment amount and initiates a payment transaction to remit the payment amount to the fuel entity, where the payment amount may be a portion of the final fuel exchange amount processed in a payment transaction using the user entity's instrument of exchange. In some embodiments, the remote server 200 generates the payment amount based on a difference value between the undiscounted fuel exchange amount, the discounted fuel exchange amount by which the exchange of value for the fuel exchange was processed, and a predetermined percentage. The remote server 200 may generate the undiscounted fuel exchange amount based on a retail, wholesale, or other undiscounted fuel exchange ratio, and the fuel volume provided to the user entity. In some embodiments, the fuel exchange payload indicates the undiscounted fuel exchange amount. The remote server 200 may retrieve the predetermined percentage from a data store of the remote computing environment (e.g., where the predetermined percentage may be stored in association with the fuel code 106 and/or an identifier for the fuel entity). The remote server 200 may generate a difference value between the undiscounted fuel exchange amount and the discounted fuel exchange amount, such as by subtracting a discounted fuel exchange amount from a retail fuel exchange amount or by subtracting a wholesale fuel exchange amount from the discounted fuel exchange amount. The remote server 200 may generate the payment amount based on the difference value and the predetermined percentage. In some embodiments, the remote server aggregates payment amounts for a plurality of fuel exchanges associated with a fuel entity to generate an aggregate payment amount that is remitted to the fuel entity via a single payment transaction initiated by the remote server 200. For example, the remote server 200 may aggregate hourly, daily, weekly (e.g., or other suitable interval) fuel exchange amounts or payment amounts determined therefrom and process a corresponding hourly, daily, or weekly payment transaction to the fuel entity in the aggregated payment amount.

In some embodiments, to request approval of the fuel exchange amount, the remote server 200 generates and transmits a transaction processing request to a transaction processing server associated with a third-party payment processor. In some embodiments, the transaction processing request includes the fuel exchange amount and authorization data for the user entity's instrument of exchange, such as a credit card number, expiration date, card verification value, and/or the like, and additional information from the fuel exchange payload and/or fuel exchange authorization data object described herein. In some embodiments, the remote server provides the fuel exchange payload to the transaction processing server using one or more APIs. In some embodiments, the remote server 200 receives an outcome of the fuel exchange from the transaction processing server via an API or other network interface. The transaction processing entity may communicate with a financial institution, such as a bank, or other administrator of a user entity's instrument of exchange to obtain authorization for and process an exchange of value for the fuel exchange amount.

In some embodiments, the remote server 200 generates and provides to the fuel exchange system 103 and/or user computing entity 111 a fuel exchange outcome. The fuel exchange outcome may indicate whether the exchange of value in the fuel exchange amount was approved, partially approved, or denied. In some embodiments, if partially approved or denied, the fuel exchange outcome may indicate one or more reasons, such as insufficient funds, preauthorization limit, suspected fraud, and/or the like. In some embodiments, the fuel exchange outcome causes the fuel exchange system 103 to activate a fueling system, such as in instances where the fuel exchange payload is generated and processed prior to a fuel event. For example, in response to receiving the fuel exchange outcome, the fuel exchange system 103 may automatically transmit a fuel start code to a corresponding fueling system 112 and may configured the fueling system 112 to perform a fuel event according to a fuel amount or fuel exchange amount indicated by the fuel exchange outcome. In some embodiments, the fueling system 112 receives the fuel exchange outcome from the fuel exchange system 103 and, in response, transitions from an inactive state to an active state such that fuel may be dispensed to a user entity. For example, in response to receiving a fuel exchange outcome indicating full or partial approval a fuel exchange payload, the fueling system 112 may transition to the active state (e.g., by enabling a handle, valve, and/or the like) such that fuel may be dispensed from the fueling system 112 to a user entity, or into a vehicle thereof.

In some embodiments, the remote server 200 or fuel exchange system 103 generates a fuel exchange report based on and/or indicative of the fuel exchange outcome. The fuel exchange report may embody or include a receipt of payment for the fuel event. In some embodiments, the remote server 200 generates the fuel exchange report based on the fuel exchange amount (e.g., undiscounted or discounted), the identifier of the fuel entity, the identifier of the fueling system, an identifier for a fueling location associated with the fuel entity and/or fueling system, one or more timestamps associated with the fuel exchange, the fuel volume, and/or the like. In some embodiments, the remote server 200 generates a first fuel exchange report to provide to a fuel exchange system and a second fuel exchange report to provide to the user computing entity. In addition to any of the above-described data of the fuel exchange report, the first fuel exchange report may indicate a remittance amount to be provided to the fuel exchange system 103 by the remote server 200 (or remote computing environment 101). The second fuel exchange report may indicate the undiscounted fuel exchange amount and/or undiscounted fuel exchange ratio, the discounted fuel exchange amount and/or undiscounted fuel exchange ratio, a savings amount or savings rate based on the undiscounted and discounted fuel exchange amounts (and/or corresponding fuel exchange ratios), a fuel entity identifier, a fueling location identifier, a fueling system identifier, one or more product identifiers or types (e.g., fuel type, fuel additives, vehicle services, and/or the like), one or more timestamps associated with the fuel exchange, and/or the like.

In some embodiments, the fuel exchange system 103 receives the fuel exchange report from the remote server 200 via an API. In some embodiments, the fuel exchange system 103 may execute a script to reformat the fuel exchange report, or portion thereof, from a received format to an original format recognizable to existing point-of-sale software or other programs installed at the fuel exchange system, such as bookkeeping software. In some embodiments, the remote server provides the fuel exchange report to the fuel exchange system and/or user computing entity in the form of a digital receipt (e.g., image file, text file, document file, spreadsheet file, and/or the like). In some embodiments, the remote server 200 provides the fuel exchange report to a first user computing entity from which the request to generate the fuel code was received and a second user computing entity, which may be associated with an administrator, employer, and/or the like, for the user entity associated with the first computing entity.

In some embodiments, the fueling system 112 receives the fuel exchange report from the fuel exchange system 103. In some embodiments, the fueling system 112 updates a GUI or other graphic on a display of the fueling system 112 to present the fuel exchange report to a user entity. In some embodiments, the fueling system 112 prints the fuel exchange report using a printing device such that the user entity may obtain, from the printing device, a physical copy of the fuel exchange report. In some embodiments, the fueling system 112 receives a network address at which the fuel exchange report may be accessed or viewed (e.g., or receives scannable media from which the network address may be obtained). In some embodiments, the fueling system updates a GUI to include the network address for observation and access by the user entity.

FIG. 7 provides an example flowchart of an example process 700 for validating a fuel code according to certain embodiments. In some embodiments, the process 700 is performed in response to receipt of a fuel exchange authorization data object at the remote computing environment. For example, the remote server 200 performs the process 700 in response to receiving a fuel exchange authorization data object.

At step/operation 703, the process 700 includes receiving a fuel exchange authorization data object that identifies a fuel code (e.g., together with metadata identifying the code as a fuel code, wherein the metadata causes the fuel exchange system to execute the process for communicating with the remote computing environment to receive authorization to dispense fuel in response to receipt of the fuel code). For example, the remote server 200 receives a fuel exchange authorization data object from via a network 150 and one or more APIs 140. The fuel exchange authorization data object may be originally generated at a fuel exchange system 103 in response to the fuel exchange system 103 receiving a fuel code 106 via a graphical user interface (GUI) of a fueling system 112.

In some embodiments, in addition to indicating the user input indicative of the fuel code, the fuel exchange authorization data object includes or indicates additional data by which the fuel code may be validated and/or other aspects of a fuel exchange determined and recorded by the remote server 200. Non-limiting examples of such data include a fuel volume provided to a user entity, a timestamp corresponding to activation of a fueling system, a timestamp corresponding to completion of fueling via the fueling system, an identifier for the fueling system, data defining a location at which the user input 405 was received and/or a fueling system associated with the fuel exchange is located, an undiscounted fuel exchange amount, an undiscounted fuel exchange ratio (e.g., wholesale price, retail price, and/or the like), an indication of whether the fuel exchange is authorized or in-process, a preauthorization limit, one or more product identifiers for a fuel type and potentially other vehicle-related products (e.g., a stock keeping unit (SKU), part number, product number, universal product code (UPC), standard case code (SCC)), and/or the like.

At step/operation 706, the process 700 includes comparing the user input to one or more stored fuel codes. In some embodiments, the remote server 200 queries one or more data stores 102 to compare the received fuel code 106 to one or more stored fuel codes 106. In some embodiments, the remote server 200 queries or retrieves one or more stored fuel codes for comparison based on additional data from the fuel exchange authorization data object (e.g., or otherwise determined by the remote server based on the fuel exchange authorization data object). For example, the remote server 200 may query a particular set of stored fuel codes or retrieve one or more fuel codes for comparison based on a fuel entity identifier. In another example the remote server 200 may query a particular set of stored fuel codes or retrieve one or more fuel codes for comparison based on a fuel exchange system identifier. In another example, the remote server 200 may query a particular set of stored fuel codes or retrieve one or more fuel codes for comparison based on a fueling location identifier. In another example, the remote server 200 may query a particular set of stored fuel codes or retrieve one or more fuel codes for comparison based on a current or historical location of one or more user computing entities 111 and a fueling location identifier. In another example, the remote server 200 may query a particular set of stored fuel codes or retrieve one or more fuel codes for comparison based on one or more product identifiers, such as an identifier for a particular fuel type, fuel additive, or vehicle fluid. The remote server 200 may query a particular set of stored fuel codes or retrieve one or more fuel codes for comparison based on multiple identifiers and/or other data.

At step/operation 709, the process 700 includes determining whether the fuel code indicated by the fuel exchange authorization data object matches a stored fuel code. For example, the remote server 200 may include determining that the stored fuel code to which the user input-indicated fuel code was matched has not been previously used in a fuel exchange. The stored fuel code may be associated with a utilization indicator and the remote server 200 may determine whether the utilization indicator indicates previous usage of the stored fuel code. In some embodiments, in response to determining user input matches stored fuel code, process 700 may proceed to step/operation 715 or, optionally, one or more of steps/operations 718-724. In some embodiments, in response to determining user input does not matched stored fuel code, or that a matched fuel code has previously been used, process 700 may proceed to step/operation 712.

At step/operation 712, the process 700 includes generating a rejection of the fuel code, which may be provided to a fuel exchange system via an application programming interface (API). For example, the remote server 200 may generate the rejection of the fuel code, which may include a rejection of the fuel exchange authorization data object. The remote server 200 may provide the rejection of the fuel code to the fuel exchange system 103 using a network 150 and one or more APIs 140. In some embodiments, prior to providing the rejection of the fuel code, the remote server 200 executes a script that reformats the rejection of the fuel code from a first format to a second format recognizable to the fuel exchange system 103 (e.g., an original format utilized by existing point-of-sale software). For example, the script splits one or more characters, concatenates one or more characters, truncates one or more characters, replaces one or more characters of, and/or adds one or more characters to, the rejection of the fuel code. Alternatively, in some embodiments, upon receiving the rejection of the fuel code, the fuel exchange system 103 may execute a script to reformat the rejection of the validation code into an original format for processing and storage by original software of the fuel exchange system 103. In some embodiments, the fuel exchange system 103 updates a store fuel exchange authorization data object (e.g., formatted in the original format of the fuel exchange system 103 software) based on the rejection of the fuel code.

At step/operation 715, the process 700 includes generating a validation data object reflecting validation of the fuel code, which may be provided to a fuel exchange system via a network 150 and one or more APIs 140. In some embodiments, the remote server 200 retrieves a fuel exchange ratio, maximum fuel volume, and/or preauthorization limit stored in association with the fuel code. The validation data object reflecting validation of the fuel code may indicate or include the fuel exchange ratio, maximum fuel volume, and/or preauthorization limit.

At step/operation 718, the process 700 optionally includes determining whether the user input indicative of the fuel code was received with a predetermined activation interval. In some embodiments, the remote server 200 retrieves an activation interval associated with stored fuel code and/or a creation or request timestamp of the stored fuel code. In some embodiments, the remote server 200 compares a receipt timestamp of the user input to the activation interval and/or to the creation timestamp. In some embodiments, in response to the remote server 200 determining the user input was received within the activation interval of the fuel code, the process 700 proceeds to step/operation 715, or, optionally, step/operations 721 and/or 724. In some embodiments, in response to determining the user input was received outside of the activation interval, the process 700 proceeds to step 712.

At step/operation 721, the process 700 optionally includes determining whether an entity identifier indicated by the fuel exchange authorization data object matches an identifier of a fuel entity associated with the matched fuel code. In some embodiments, the remote server 200 compare the entity identifier from the fuel exchange authorization data object to identifier of a fuel entity stored in association with the matched fuel code. In some embodiments, in response to the remote server 200 determining the entity identifier matches the stored fuel entity identifier, the process 700 proceeds to step/operation 715, or optionally steps/operations 718 and/or 724. In some embodiments, in response to the remote server 200 determining the entity identifier does not match the stored fuel entity identifier, the process 700 proceeds to step/operation 712.

At step/operation 724, the process 700 optionally includes determining whether a user computing entity 111 associated with the user input is within a predetermined proximity of a fueling location associated with the fuel entity. In some embodiments, the remote server 200 requests and receives geolocation data associated with user computing entity 111. In some embodiments, the remote server 200 determines a current location of user computing entity 111 based on the geolocation data. In some embodiments, the remote server 200 determines, or receives from a data store 102, a fueling location associated with the stored fuel code and/or associated fuel entity identifier. In some embodiments, the remote server 200 compares the current location of the user computing entity 111 to the fueling location to generate a proximity of the current location to the fueling location. In some embodiments, the remote server 200 determines whether the generated proximity is within a predetermined proximity threshold, which may be a physical distance or travel time (e.g., 200 miles, 100 miles, 50 miles, 12 hours, 6 hours, 30 minutes, or any suitable distance or travel time). In some embodiments, in response to the remote server 200 determining that the location of the user computing entity 111 is within the predetermined proximity to the fueling location, the process 700 proceeds to step/operation 715, or, optionally, steps/operations 718 and/or 724. In some embodiments, in response to the remote server 200 determining that the location of the user computing entity 111 is outside of the predetermined proximity to the fueling location, the process 700 proceeds to step/operation 712.

### Example User Interfaces

FIG. 8 provides an example graphical user interface (GUI) 800 for receiving a user input indicative of a fuel code at a fueling system according to certain embodiments. In various embodiments, the GUI 800 is generated and rendered on a display of a fueling system (e.g., a fuel pump, and/or the like) based on original software executed by the fueling system. In some embodiments, the GUI 800 includes a user input field 803 configured to receive user input, such as via inputs to a number pad or other input device. In some embodiments, the GUI 800 includes a selectable field 806 that, when selected via user input, causes the fueling system to process a user input to the user input field 803 as a traditional payment instrument identifier or customer identification number. For example, the user input field 803 may be rendered or enabled based on selection of the selectable field 806 and may be a legacy or existing user input field traditionally utilized for manually inputting a fueling station member number. In some embodiments, the GUI 800 is specifically configured for receipt of a fuel code (e.g., instead of traditional payment instrument data) such that a user input entered into the GUI 800 is automatically tagged with metadata indicating that the user input includes a fuel code. In one example, in response to receiving a user input at the GUI 800, the fueling system automatically identifies the user input as a fuel code and tags the user input with metadata identifying the user input as a fuel code prior to providing the user input and the metadata to a fuel exchange system. In some embodiments, the GUI 800 is rendered on a display on the fueling system that is specifically configured and/or installed for receipt of user inputs for fuel codes. In some embodiments, the fueling system includes an input device, such as a touch display, button, and/or the like, for initiating fuel code-based transactions and the fueling system renders the GUI 800 on a display of the fueling system in response to receiving a user input to the input device.

In some embodiments, a script installed at and executed by the fueling system enables the system to receive, at the user input field 803, a user input indicative of a fuel code such that the fuel code is received and processed in place of traditional payment instrument information (e.g., bypassing traditional requirements for fuel dispensing based on receiving payment instrument information). In some embodiments, selection of the selectable field 806 cause the fueling system to execute the script. For example, in response to selection of the selectable field 806, the fueling system executes a script that causes an update to the GUI 800 such that the GUI 800 instructs a user entity to input a fuel code, which may be described as a reward code in the instruction.

FIG. 9 provides an example graphical user interface (GUI) 900 for providing a fuel code to a fuel exchange system according to certain embodiments. In some embodiments, the GUI 900 is rendered on a display of the user computing entity 111 by the application 122. In some embodiments, the GUI 900 includes a fuel code 106, which may be presented to an operator of a fuel exchange system such that the operator may provide the fuel code 106 to the fuel exchange system via user input. In some embodiments, the GUI 900 includes an entity identifier 903 that includes a name of a fuel entity, an address of a fueling location, and/or a selectable link that, when selected, causes the user computing entity 111 to initiate a navigation application for navigating to the address of the fueling location. In some embodiments, the GUI 900 includes an undiscounted fuel exchange ratio associated with the fuel entity or fueling location, such as an undiscounted retail price currently advertised or otherwise utilized by the associated fuel exchange system. In some embodiments, the GUI 900 includes a discounted fuel exchange ratio 907. In some embodiments, the application 122 may receive the discounted fuel exchange ratio 907 from the remote computing environment in combination with or following receipt of the fuel code. In some embodiments, the application 122 receives one or more discounted fuel exchange ratios and renders a map interface on which locations of one or more fueling locations and corresponding discounted fuel exchange ratios are indicated. In some embodiments, the application 122 receives the discounted fuel exchange ratio 907 from the remote computing environment in response to requesting generation of a fuel code for the corresponding fueling location.

### Exemplary Fueling System

In one embodiment, the fueling system 112 may be in network communication with the fuel exchange system 103 (e.g., using a network 150, such as a local network) and one or more user computing entities 111 (e.g., using a network 150 and/or a communication interface that reads and/or transmits data from and to the user computing entity 111), and/or the like. In certain embodiments, the fueling system 112 may be operable in association with other computing devices and/or user entities (e.g., operable via the fuel exchange system 103 or user input to a GUI on the fueling system 112) to accomplish certain functions described herein, such as receiving user input, transitioning between active and inactive states, determining user input comprises a fuel code, generating or modifying metadata of user input, dispensing fuel, generating and providing fuel event data, and/or the like.

In various embodiments, the fueling system 112 includes or embodies one or more fuel pumps that dispense fuel to a user entity. In some embodiments, the fueling system 112 includes one or more pump mechanisms 1012 by which fuel is dispensed to a user entity. For example, the pump mechanism 1012 includes a handle connected to a fuel reservoir via tubing and through which fuel may be dispensed (e.g., upon manipulation of the handle when the fueling system 112 is configured to an active state). In some embodiments, the pump mechanism 1012 includes one or more valves that may be manipulated (e.g., closed, opened, rotated, translated, and/or the like) to transition the fueling system 112 between an active state and an inactive state. In some embodiments, the pump mechanism 1012 includes a handle by which electrical current is passed to a charging input of a vehicle. For example, the pump mechanism 1012 includes a plug and socket that may be inserted into a charging input of a vehicle, the plug and/or socket also being connected to a power supply.

In various embodiments, the fueling system 112 includes or embodies one or more computers, computing entities, desktop computers, mobile phones, tablets, phablets, notebooks, laptops, distributed systems, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, modifying, transitioning, operating on, processing, controlling, remotely controlling, dispensing, displaying, storing, determining, creating/generating, monitoring, evaluating, comparing, and/or similar terms used herein interchangeably. For example, the fueling system 112 may receive user inputs indicative of fuel codes. In another example, the fueling system 112 may receive validation data objects (e.g., which may cause the fueling system 112 to automatically transition to an active state in which fuel may be dispensed from the pump mechanism 1012). As another example, the fueling system 112 may generate and render graphical user interfaces (GUIs) on a display 1011. As another example, the fueling system 112 may generate fuel event data in response to dispensing fuel, or other fuel event occurrence, where the fuel event data may include data identifying the fueling system 112, a fuel code, a fuel volume, fuel type, fuel start timestamp, fuel stop timestamp, and/or the like. As another example, the fueling system 112 may automatically transition between inactive and active states based on data received from a fuel exchange system 103 via a local network. In another example, the fueling system 112 determines that a user input includes a format corresponding to a fuel code, in response to which the fueling system 112 may identify the user input as including a fuel code. In another example, in response to recognizing a user input as including a fuel code, the fueling system 112 generates metadata for the user input or modifies existing metadata of the user input to identify that the user input includes a fuel code. In one embodiment, these functions, operations, and/or processes can be performed on data, content, information, and/or similar terms used herein interchangeably.

In one embodiment, the fueling system 112 may include or be in communication with one or more processing elements 1005 (also referred to as processors, processing circuitry, processing device, and/or similar terms used herein interchangeably) that communicate with other elements within the fueling system 112 via a bus, for example. In certain embodiments, the processing element 1005 may access or receive data associated with performing functions described herein, such as user inputs, fuel codes, validations or rejections of fuel codes, fuel exchange-related data (e.g., fuel exchange ratios, fuel volumes, fuel volume limits, fuel types, and other fuel event data), and/or the like. As will be understood, the processing element 1005 may be embodied in a number of different ways. For example, the processing element 1005 may be embodied as one or more complex programmable logic devices (CPLDs), “cloud” processors, microprocessors, multi-core processors, coprocessing entities, application-specific instruction-set processors (ASIPs), microcontrollers, and/or controllers. Further, the processing element 1005 may be embodied as one or more other processing devices or circuitry. The term circuitry may refer to an entirely hardware embodiment or a combination of hardware and computer program products. Thus, the processing element 1005 may be embodied as integrated circuits, application specific integrated circuits (ASICs), field programmable gate arrays (FPGAs), programmable logic arrays (PLAs), hardware accelerators, other circuitry, and/or the like. As will therefore be understood, the processing element 1005 may be configured for a particular use or configured to execute instructions stored in memory (e.g., in volatile or non-volatile memory) or otherwise accessible to the processing element 1005. As such, whether configured by hardware or computer program products, or by a combination thereof, the processing element 1005 may be capable of performing steps or operations according to embodiments of the present techniques for fuel exchange authorization and optimization when configured accordingly. In various, functions of the processing element 1005, and/or other elements of the fueling system 112, are modified according to storage instructions. Such storage instructions, when executed by the processing element 1005, may enable the fueling system 112 to recognize user input for fuel codes and, in response, provide the user input (e.g., or reformatted version thereof) to a remote computing environment 101 for validation and completion of an exchange of value (e.g., following activation of a fueling system and a fuel event in instances of successful fuel code validation). When executed by the processing element 1005, the storage instructions may also cause the fueling system 112 to transform such user input, and potentially other fuel exchange-related data, into a format by which the user input may be provided to or collected by an external computing system, such as via one or more APIs.

In one embodiment, the fueling system 112 may further include or be in communication with non-volatile memory 1006 (also referred to as non-volatile storage, memory, memory storage, memory circuitry and/or similar terms used herein interchangeably), which may include or be embodied as memory. In one embodiment, the non-volatile storage or memory may include one or more non-volatile storage or memory media 1006, including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. As will be recognized, the non-volatile storage or memory media 1006 may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or information/data that is stored in a computer-readable storage medium using one or more database models, such as a hierarchical database model, network model, relational model, entity-relationship model, object model, document model, semantic model, graph model, and/or the like. In some embodiments, the non-volatile memory 1006 stores storage instructions 116 that cause the processing element 1005 to modify a format of user input data stored at the fueling system 112 to enable performance of functions described herein for remotely initiating and executing fuel exchanges based on user inputs indicative of fuel codes.

In one embodiment, the fueling system 112 may further include or be in communication with volatile memory 1007 (also referred to as volatile storage, memory, memory storage, memory circuitry and/or similar terms used herein interchangeably), which may include or be embodied as one or more data stores 102. In one embodiment, the volatile storage or memory may also include one or more volatile storage or memory media 1007, including but not limited to RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 1005. Thus, the databases, database instances, database management systems, data, applications, programs, program modules, scripts, source code, object code, byte code, compiled code, interpreted code, machine code, executable instructions, and/or the like may be used to control certain aspects of the operation of the fueling system 112 with the assistance of the processing element 1005 and operating system. In some embodiments, the volatile memory 1007 temporarily stores user inputs according to a storage instruction 116. For example, in response to the processing element 1005 recognizing a user input as indicating a fuel code (e.g., via execution of the storage instruction 116), the volatile memory 1007 temporarily stores the user input according to the storage instruction 116.

As indicated, in one embodiment, the fueling system 112 may also include one or more communications elements/interfaces 1008 for communicating with various computing entities, such as by communicating data, content, information, and/or similar terms used herein interchangeably that can be transmitted, received, operated on, processed, displayed, stored, and/or the like. For instance, the fueling system 112 may communicate with one or more networks 150, one or more user computing entities 111, a remote computing environment 101, one or more fuel exchange systems 103, and/or the like.

In some embodiments, the fueling system 112 includes one or more input/output elements 1009 that receive an indication of a user input and, in some embodiments, provide an output or input to one or more computing devices. In some embodiments, the input/output element 1009 embodies or communicates with the input device 1010. For example, the input/output element 1009 provides output to and receives input from one or more computing devices (e.g., user computing entities 111, input devices 1010, and/or the like). In some embodiments, the input/output element 1009 provides user inputs to the processing element 1005. The input/output element 1009 may comprise one or more software interface(s) (also referred to as graphical user interface(s)) and in some embodiments includes a display that comprises the interface(s) rendered as a web user interface, an application user interface, a user device, a backend system, or the like. In some embodiments, the input/output element 1009 also includes a keyboard, a mouse, a joystick, a touch screen, touch areas, soft keys a microphone, a speaker, a payment card reader slot, a near field communication (NFC) circuit, a keypad, and/or other input/output mechanisms. In some embodiments, the input/output element 1009 includes a printing device that prints information onto physical media, such as thermal paper. In some embodiments, the printing device prints fuel exchange reports, which may be provided to a user entity, an operator of a fueling system 112, an operator of a fuel exchange system 103, and/or the like.

In some embodiments, the processing element 1005 may disable the input/output element 1009, or a portion thereof. For example, the input/output element 1009 includes a chip-based payment card reader slot that locks a payment card into the reader slot. In response to the fueling system 112 determining that a user input to a graphical user interface (GUI) includes a fuel code, the processing element 1005 may the disable the locking mechanism of the reader slot such that the fueling system cannot accept payment information provided via the chip-based payment card reader. In another example, the processing element 1005 may disable a keypad such that a user entity is prevented from providing payment information using the keypad. In certain embodiments, using the processing element 1005, memory, communication interface 1008, and input/output element 1009, the fueling system 112 may be configured to dispense fuel based at least in part on receipt and processing of data as described herein. For example, the fueling system 112 may receive a fuel code, and tag metadata of the fuel code such that a remote computing environment 101 may recognize the fuel code. The fueling system 112 may receive, via the fuel exchange system 103, a validation data object reflecting validation of the fuel code from the remote computing environment 101. The validation data object, or additional received data, may indicate a fuel exchange ratio by which a fuel exchange amount (e.g., cost) for the fuel exchange may be determined. The validation of the fuel code may cause the fueling system 112 to automatically transition a fueling system from an inactive state to an active state (e.g., potentially based additional fuel exchange data received, such as a limit including a fuel volume limit, an activation time limit, a preauthorization limit, and/or the like). The fueling system 112 may generate fuel event data, including a fuel volume of fuel dispensed from the fueling system 112.

As indicated, in one embodiment, the fueling system 112 may also include one or more communications interfaces 1008 for communicating with various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the fueling system 112 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol. The fueling system 112 may use such protocols and standards to communicate using Border Gateway Protocol (BGP), Dynamic Host Configuration Protocol (DHCP), Domain Name System (DNS), File Transfer Protocol (FTP), Hypertext Transfer Protocol (HTTP), HTTP over TLS/SSL/Secure, Internet Message Access Protocol (IMAP), Network Time Protocol (NTP), Simple Mail Transfer Protocol (SMTP), Telnet, Transport Layer Security (TLS), Secure Sockets Layer (SSL), Internet Protocol (IP), Transmission Control Protocol (TCP), User Datagram Protocol (UDP), Datagram Congestion Control Protocol (DCCP), Stream Control Transmission Protocol (SCTP), HyperText Markup Language (HTML), and/or the like.

As will be appreciated, one or more of the components of the fueling system 112 may be located remotely from other fueling system 112 components, such as in a distributed system. Furthermore, one or more of the components may be combined and additional components performing functions described herein may be included in the fueling system 112. Thus, the fueling system 112 can be adapted to accommodate a variety of needs and circumstances. As will be recognized, these architectures and descriptions are provided for exemplary purposes only and are not limiting to the various embodiments.

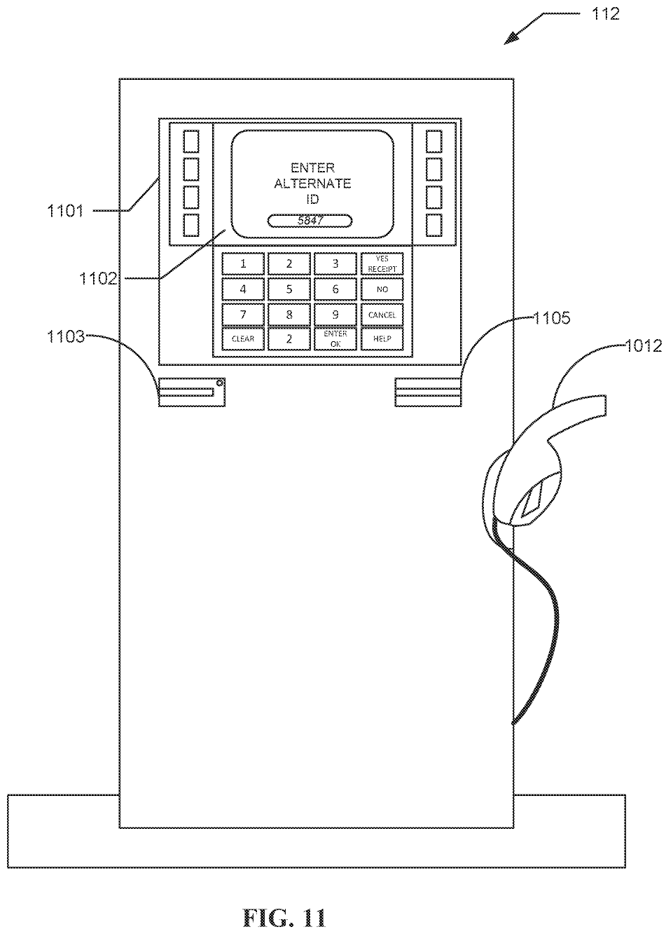

FIG. 11 provides an example illustration of a fueling system 112 according to certain embodiments. In some embodiments, the fueling system 112 includes a display 1101 on which a graphical user interface (GUI) 1102 may be rendered. In some embodiments, the display 1101 includes one or more input devices and/or selectable fields for receiving user input to initiate operations at the fueling system 112 as described herein. For example, the display 1101 includes a GUI including a selectable field for causing the fueling system 112 to accept a fuel code in place of traditional payment information to initiate fuel dispensing. In another example, the display 1101 includes a keypad for receiving a user input for a field code. In another example, the GUI on the display 1101 includes instruction for instructing a user entity to provide a fuel code via user input.

In some embodiments, the fueling system 112 includes a card reader 1103 or other element for receiving traditional payment instrument information. The fueling system may disable the card reader 1103 in response to determining that a user input includes a fuel code or in response to receiving an input to a selectable field for causing the fueling system 112 to accept a fuel code. In some embodiments, the fueling system 112 includes a printing device 1105 that prints fuel exchange reports for a user entity. For example, the fueling system 112 may receive a fuel exchange outcome and/or fuel exchange payload from a fuel exchange system, generate a fuel exchange report based thereon, and print the fuel exchange report using the printing device. In another example, the fueling system 112 may receive a fuel exchange report from the fuel exchange system and print the fuel exchange report using the printing device. In various embodiments, the fueling system 112 includes a pump mechanism 1012. In some embodiments, the pump mechanism 1012 includes a handle through which fuel may be dispensed from the fueling system 112. In some embodiments, the handle includes a trigger or other mechanism through which fuel dispensing may be controlled. In some embodiments, in the inactive state, the fueling system 112 disables the handle (or trigger of the handle) such that fuel may not be dispensed using the pump mechanism 1012. In some embodiments, in the active state, the fueling system 112 enables the handle such that the handle may be used by a user entity to dispense fuel.

### CONCLUSION

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A computer-implemented method for fuel dispensing, comprising:
receiving user input via a graphical user interface of a fueling system configured to dispense fuel, wherein the fueling system is in communication with a fuel exchange system via a network;
determining the user input comprises a fuel code, wherein the fuel code is generated by a remote computing environment that (a) stores a record of the fuel code with an identifier of the fuel exchange system within a listing of records of valid fuel codes and (b) provides the fuel code to a user computing entity for presentation via a user interface of the user computing entity;
in response to determining the user input comprises the fuel code:
tagging the user input with metadata designating the fuel code; and
transmitting the fuel code and the metadata to a fuel exchange system using the network, wherein the fuel exchange system transmits the fuel code to the remote computing environment using an application programming interface (API) upon receipt of the fuel code from the fueling system;
receiving, from the fuel exchange system, a validation data object, wherein:
the validation data object is generated by the remote computing environment at least in part based on a comparison of the fuel code to the listing of records of valid fuel codes; and
the fuel exchange system receives the validation data object from the remote computing environment via the API and transmits the validation data object to the fueling system via the network;
in response to receiving the validation data object, automatically transitioning the fueling system from an inactive state to an active state to enable fuel dispensing from the fueling system;
dispensing fuel from a handle of the fuel system in the active state;
generating fuel event data based at least in part on the dispensing of the fuel to identify a fuel volume; and
transmitting the fuel event data to the fuel exchange system using the network, wherein the fuel event data causes the fuel exchange system to:
generate, based on the fuel event data, a fuel exchange payload comprising data identifying a fuel exchange amount, the identifier of the fuel entity associated with the fuel exchange system, and the fuel code; and
transmit, using the API, the fuel exchange payload to the remote computing environment to execute a transaction for the user.

2. The computer-implemented method of claim 1, further comprising:
in response to determining the user input comprises the fuel code, disabling information entry at the fueling system to prevent users from providing alternative payment information to the fueling system.

3. The computer-implemented method of claim 1, wherein:
the fuel event data further comprises data identifying a fuel type.

4. The computer-implemented method of claim 1, wherein the fuel code causes the remote computing environment to:
provide a transaction request comprising the fuel exchange payload to a third-party processing service to execute a transaction.

5. The computer-implemented method of claim 4, wherein:
the method further comprises:
providing a fuel exchange report to the user using a printing device of the fueling system.

6. The computer-implemented method of claim 1, further comprising:
in response to determining the user input comprises the fuel code, disabling at least a portion of user input devices of the fueling system.

7. The computer-implemented method of claim 1, wherein the validation data object identifies at least one limit on a fueling transaction; and
wherein the method further comprises transitioning the fueling system to the inactive state upon satisfying the at least one limit.

8. The computer-implemented method of claim 1, wherein the remote computing environment transmits an input instruction to the user computing entity based on the identifier of the fuel entity, wherein the input instruction indicates to input the fuel code using the GUI on the fueling system.

9. A system for fuel dispensing, the system comprising at least one memory and one or more processors in communication with the at least one memory, wherein the one or more processors are configured to:
receive user input via a graphical user interface of a fueling system configured to dispense fuel, wherein the fueling system is in communication with a fuel exchange system via a network;
determine the user input comprises a fuel code, wherein the fuel code is generated by a remote computing environment that (a) stores a record of the fuel code with an identifier of the fuel exchange system within a listing of records of valid fuel codes and (b) provides the fuel code to a user computing entity for presentation via a user interface of the user computing entity;
in response to determining the user input comprises the fuel code:
tag the user input with metadata designating the fuel code; and
transmit the fuel code and the metadata to a fuel exchange system using the network, wherein the fuel exchange system transmits the fuel code to the remote computing environment using an application programming interface (API) upon receipt of the fuel code from the fueling system;
receive, from the fuel exchange system, a validation data object, wherein:
the validation data object is generated by the remote computing environment at least in part based on a comparison of the fuel code to the listing of records of valid fuel codes; and
the fuel exchange system receives the validation data object from the remote computing environment via the API and transmits the validation data object to the fueling system via the network;
in response to receiving the validation data object, automatically transition the fueling system from an inactive state to an active state to enable fuel dispensing from the fueling system;
dispense fuel from a handle of the fuel system in the active state;
generate fuel event data based at least in part on the dispensing of the fuel to identify a fuel volume; and
transmit the fuel event data to the fuel exchange system using the network, wherein the fuel event data causes the fuel exchange system to:
generate, based on the fuel event data, a fuel exchange payload comprising data identifying a fuel exchange amount, the identifier of the fuel entity associated with the fuel exchange system, and the fuel code; and
transmit, using the API, the fuel exchange payload to the remote computing environment to execute a transaction for the user.

10. The system of claim 9, wherein the one or more processors are further configured to:
in response to determining the user input comprises the fuel code, disabling information entry at the fueling system to prevent users from providing alternative payment information to the fueling system.

11. The system of claim 9, wherein:
the fuel event data further comprises data identifying a fuel type.

12. The system of claim 9, wherein the fuel code causes the remote computing environment to:
provide a transaction request comprising the fuel exchange payload to a third-party processing service to execute a transaction.

13. The system of claim 12, wherein the one or more processors are further configured to:
provide a fuel exchange report to the user using a printing device of the fueling system.

14. The system of claim 9, wherein the one or more processors are further configured to:
in response to determining the user input comprises the fuel code, disable at least a portion of user input devices of the fueling system.

15. The system of claim 9, wherein the validation data object identifies at least one limit on a fueling transaction; and
wherein the one or more processors are further configured to transition the fueling system to the inactive state upon satisfying the at least one limit.

16. The system of claim 9, wherein the remote computing environment transmits an input instruction to the user computing entity based on the identifier of the fuel entity, wherein the input instruction indicates to input the fuel code using the GUI on the fueling system.

17. A computer program product comprising a non-transitory computer readable medium having computer program instructions stored therein, the computer program instructions, when executed by a processor, cause the processor to:
receive user input via a graphical user interface of a fueling system configured to dispense fuel, wherein the fueling system is in communication with a fuel exchange system via a network;
determine the user input comprises a fuel code, wherein the fuel code is generated by a remote computing environment that (a) stores a record of the fuel code with an identifier of the fuel exchange system within a listing of records of valid fuel codes and (b) provides the fuel code to a user computing entity for presentation via a user interface of the user computing entity;
in response to determining the user input comprises the fuel code:
tag the user input with metadata designating the fuel code; and
transmit the fuel code and the metadata to a fuel exchange system using the network, wherein the fuel exchange system transmits the fuel code to the remote computing environment using an application programming interface (API) upon receipt of the fuel code from the fueling system;
receive, from the fuel exchange system, a validation data object, wherein:
the validation data object is generated by the remote computing environment at least in part based on a comparison of the fuel code to the listing of records of valid fuel codes; and
the fuel exchange system receives the validation data object from the remote computing environment via the API and transmits the validation data object to the fueling system via the network;
in response to receiving the validation data object, automatically transition the fueling system from an inactive state to an active state to enable fuel dispensing from the fueling system;
dispense fuel from a handle of the fuel system in the active state;
generate fuel event data based at least in part on the dispensing of the fuel to identify a fuel volume; and
transmit the fuel event data to the fuel exchange system using the network, wherein the fuel event data causes the fuel exchange system to:
generate, based on the fuel event data, a fuel exchange payload comprising data identifying a fuel exchange amount, the identifier of the fuel entity associated with the fuel exchange system, and the fuel code; and
transmit, using the API, the fuel exchange payload to the remote computing environment to execute a transaction for the user.

18. The computer program product of claim 17, wherein the computer program instructions, when executed by the processor, further cause the processor to:
in response to determining the user input comprises the fuel code, disabling information entry at the fueling system to prevent users from providing alternative payment information to the fueling system.

19. The computer program product of claim 17, wherein:
the fuel event data further comprises data identifying a fuel type.

20. The computer program product of claim 17, wherein the computer program instructions, when executed by the processor, further cause the processor to:
in response to determining the user input comprises the fuel code, disabling at least a portion of user input devices of the fueling system.
